(19) United States
(12) Patent Application Publication
(10) Pub. No.: US 2005/0026093 A1
(43) Pub. Date: Feb. 3, 2005

(54) Photothermographic material and image forming method

(76) Inventor: Tomoyuki Ohzeki, Kanagawa (JP)

Correspondence Address: TAIYO CORPORATION, 2111 JEFFERSON DAVIS HIGHWAY, #412, NORTH, ARLINGTON, VA, 22202, US

(21) Appl. No.: 10/898,387

(22) Filed: Jul. 26, 2004

(30) Foreign Application Priority Data
Jul. 29, 2003 (JP) 2003-281805
Jul. 29, 2003 (JP) 2003-281806
Apr. 30, 2004 (JP) 2004-136052
Apr. 30, 2004 (JP) 2004-136053

(51) Int. Cl. G03C 1/00

(52) U.S. Cl. 430/617

(57) ABSTRACT

The present invention provides a photothermographic material including, on at least one surface of a support, an image forming layer comprising at least a photosensitive silver halide, a non-photosensitive organic silver salt, a reducing agent for silver ions and a binder, wherein (1) the photothermographic material has means for nucleation, and (2) an average gradient of a photographic characteristic curve thereof is from 1.8 to 4.3. Furthermore, the invention provides an image forming method for carrying out X-ray exposure using the photothermographic material and an X-ray intensifying screen. The present invention gives a high-sensitivity and clear image that has a low degree of haze of the film after a thermal developing process.

### CROSS-REFERENCE TO RELATED APPLICATION

This application claims priority under 35 USC 119 from Japanese Patent Application Nos. 2003-281805, 2003-281806, 2004-136052 and 2004-136053, the disclosures of which are incorporated by reference herein.

### BACKGROUND OF THE INVENTION

1. Field of the Invention

The present invention relates to a photothermographic material and an image forming method. More particularly, the invention relates to a photothermographic material and an image forming method which exhibit high image quality with high sensitivity and low degree of haze.

2. Description of the Related Art

In the medical imaging field and the graphic arts field, there has been, in recent years, a strong desire for a dry photographic process from the viewpoints of environmental conservation and space saving. Further, the development of digitization in these fields has resulted in the rapid development of systems in which image information is captured and stored in a computer, whereafter the image information is processed, if necessary, by the computer which outputs the image information through communication to a desired location, and the image information is further output, at the site, onto a photosensitive material using a laser image setter or a laser imager, followed by development thereof to form an image on the photosensitive material. It is required that the photosensitive material be able to record an image under exposure to a laser with a high intensity and that a clear black-tone image with a high resolution and sharpness can be formed. While various kinds of hard copy systems using a pigment or a dye such as an ink-jet printer or an electrophotographic system have been distributed as a general image forming system using such a digital imaging recording material, images in the digital imaging recording material obtained by such a general image forming system are insufficient in terms of image qualities required for medical images. To facilitate diagnosis, image qualities such as sharpness, granularity, gradation, tone and high recording speed (sensitivity) are required. However, digital imaging recording materials have not reached a level at which they can replace medical silver halide film processed by conventional wet development.

A thermographic system using an organic silver salt is already known. Generally, a photothermographic material, in particular, has an image forming layer including a photosensitive silver halide, a reducing agent, a reducible silver salt (for example, an organic silver salt) and if necessary, a toner, controlling a color tone of silver, dispersed in a binder matrix.

A photothermographic material forms a black silver image by being heated to a high temperature (for example, 80° C. or higher) after imagewise exposure to cause an oxidation-reduction reaction between a silver halide or a reducible silver salt (functioning as an oxidizing agent) and a reducing agent. The oxidation-reduction reaction is accelerated by a catalytic action of a latent image on the silver halide generated by exposure. As a result, a black silver image is formed on an exposed region. Photothermographic materials are described in many documents, and Fuji Medical Dry Imager FM-DP L is an example of a practical medical image forming system using a photothermographic material that has been marketed.

Since the image forming system utilizing an organic silver salt has no fixing step, undeveloped silver halides remain inside the film after thermal development. Thus, there have intrinsically been two serious problems in the system.

One of them is image instability after a thermal developing process, particularly fogging due to print-out when the material is exposed to light. As a means to improve print-out, a method of using silver iodide is known. Silver iodide has the characteristic of causing less print-out than silver bromide or silver iodobromide having an iodide content of 5 mol % or less, and has a potential for fundamentally solving the problem. However, the sensitivity of silver iodide grains known until now is extremely low, and the silver iodide grains do not achieve a level of sensitivity that is applicable for an actual system. When the means of preventing recombination between photoelectrons and holes is performed to improve the sensitivity, it is an inherent problem that the characteristic of being excellent in the print-out property will be lost.

As means of increasing the sensitivity of a silver iodide photographic emulsion, academic literature discloses addition of a halogen receptor such as sodium nitrite, pyrogallol, hydroquinone or the like, immersion in an aqueous silver nitrate solution, sulfur sensitization at a pAg of 7.5, and the like. However, the sensitization effect of these halogen acceptors is very small and extremely insufficient for use in photothermographic materials.

Another problem is that light scattering due to the remaining silver halide grains may cause cloudiness, whereby the film turns translucent or opaque, and therefore the image quality is degraded. In order to solve this problem, means by which the grain size of photosensitive silver halide grain is made fine (to within a practically used degree of 0.08 μm to 0.15 μm), and the coating amount is reduced as much as possible are practically employed to suppress the cloudiness caused by the silver halides. However, the above compromises result in decreasing the sensitivity further, whereby the problem of cloudiness is not solved completely, and a dark milky color still generates haze in the film.

In the case of a conventional wet developing process, the remaining silver halide is removed by processing with a fixing solution containing silver halide solvents after the developing process. As for the silver halide solvent, many kinds of inorganic and organic compounds, which can form complexes with silver ions, are known.

Even in the case of a dry thermal developing process, many attempts to introduce similar fixing means in the material have been made. For example, a method of solubilizing silver halides (usually referred to as fixing) during thermal development by incorporating a compound forming complexes with silver ions in the film has been proposed. However, the above proposal only applies to silver bromide and silver chlorobromide, and the aforesaid process also requires an additional heat treatment step for fixing, and the heating conditions are such that a high temperature such as 155° C. to 160° C. is required. Thus, the system is one in which fixing is difficult to achieve. Moreover, in the case of another proposal, a separate sheet (referred to as a fixing sheet) that includes compounds forming complexes with silver ions is prepared, and, after thermally developing the photothermographic material to form an image, the fixing sheet is overlaid on the developed photothermographic material, and the remaining silver halides are dissolved and removed. Since the above proposal requires two sheets, it become an obstacle from a practical viewpoint that the processing step is so complicated and the operational stability of the process is hard to maintain, and that the necessity to discard the fixing sheets after processing results in generation of waste.

As another fixing means in thermal development, a method of containing a fixing agent for the silver halide in microcapsules and releasing of the fixing agent by thermal development to cause it act, is proposed. However, it is difficult to achieve a design that effectively releases the fixing agent. Moreover, a means of fixing using a fixing solution after thermal development is proposed, but the process requires a wet process and therefore is not adequate for a completely dry process.

As described above, each known method to improve the turbidity of film has negative effects, and difficulties in practical application has been great.

On the other hand, attempts to apply the above-mentioned photothermographic material to a photosensitive material for photographing have been proposed. The “photosensitive material for photographing” as used herein means a photosensitive material which records images by one-shot exposure through a lense, rather than by writing the image information by scanning exposure with a laser beam or the like. Conventionally, photosensitive materials for photographing are generally known in the field of wet developing photosensitive materials, and include films for medical use such as direct or indirect radiography films and mammography films, many kinds of photomechanical films for printing use, industrial recording films, films for photographing with general cameras, and the like. For example, a double-sided coated X-ray photothermographic material comprising tabular silver iodobromide grains using a blue fluorescent intensifying screen is described in JP-A No. 59-142539, and a photothermographic material for medical use comprising tabular grains, having a high content of silver chloride and having (100) major faces, coated on both sides of the support is described in JP-A No. 10-282606. Moreover, the double-sided coated photothermographic materials are also disclosed in other patent documents. However, according to these disclosed examples, although fine particle silver halide grains having a grain size of 0.1 μm or less do not cause haze, the sensitivity is very low. Therefore, the grains are not applicable for practical use for photographing. Besides, in the case of using silver halide grains having a grain size of 0.5 μm or more, because the remaining silver halide may increase the degree of haze and worsen the print-out, deterioration of the image quality is severe, and the grains are not appicable for practical use.

Photosensitive materials comprising tabular silver iodide grains as silver halide grains are well known in the wet developing field, but there have been no examples of the application of the silver iodide grains in a photothermographic material. The reasons are because, as mentioned above, the sensitivity is very low, and there are no effective sensitization means, and the technical barriers become even higher in thermal development.

In order to be used as this kind of photosensitive material for photographing, the photothermographic material needs higher sensitivity as well as an even higher level of image quality such as the degree of haze of the obtained image.

### SUMMARY OF THE INVENTION

A first aspect of the invention is to provide a photothermographic material comprising, on at least one surface of a support, an image forming layer including at least a photosensitive silver halide, a non-photosensitive organic silver salt, a reducing agent for silver ions and a binder, wherein the photothermographic material has means for nucleation, and an average gradient of a photographic characteristic curve thereof is from 1.8 to 4.3.

A second aspect of the invention is to provide an image forming method comprising the steps of: (a) providing an assembly for forming an image by placing the photothermographic material according to the first aspect between a pair of X-ray intensifying screens, (b) putting an analyte between the assembly and an X-ray source, (c) applying an X-ray, (d) taking the photothermographic material out of the assembly, and (e) heating the thus taken out photothermographic material in a temperature range of 90° C. to 180° C.

### BRIEF DESCRIPTION OF THE DRAWINGS

FIG. 1 is a diagram of light emission spectrum of a fluorescent intensifying screen A.

FIG. 2 is a conceptual view of a heating means comprising 6 sets of plate heaters.

### DETAILED DESCRIPTION OF THE INVENTION

The present invention will be described in detail below.

1. Photothermographic Material

In the present invention, a photographic characteristic curve is a D-log E curve representing a relationship between the common logarithm (log E) of a light exposure, i.e., the exposure energy, and the optical density (D), i.e., a scattered light photographic density, by plotting the former on the abscissa and the latter on the ordinate. In the present invention, fog is expressed in terms of the density of the unexposed part. An average gradient according to the invention represents a gradient of a line joining the points fog+0.25 and fog+2.0 on the photographic characteristic curve (i.e., the value equals to tan when the angle between the line and the abscissa is).

An average gradient according to the invention is in a range of 1.8 to 4.3, and preferably is in a range of 2.0 to 4.0.

In the invention, it is preferred that the coating amount of silver is 2.0 g/m² or less, and the optical density after thermal development is 2.5 or more. And more preferably, the coating amount of silver is 1.8 g/m² or less, and the optical density after thermal development is 2.7 or more.

The photothermographic material of the invention has an image forming layer comprising at least a photosensitive silver halide, a non-photosensitive organic silver salt, a reducing agent and a binder on at least one surface of a support. Further preferably, the image forming layer may have disposed thereon a surface protective layer, or a back layer, a back protective layer or the like may be disposed on the opposite surface of the image forming layer toward the support. The image forming layer may be disposed on both sides of the support. The photothermographic material of the invention comprises means for nucleation.

The constitutions and preferable components of these layers will be explained in detail below.

(Photosensitive Silver Halide)

1) Halogen Composition

For the photosensitive silver halide used in the invention, there is no particular restriction on the halogen composition and silver chloride, silver bromochloride, silver bromide, silver iodobromide, silver iodochlorobromide and silver iodide can be used. Among them, silver bromide, silver iodobromide and silver iodide are preferred. More preferable is silver iodobromide having a silver iodide content of 40% or higher, or silver iodide. Further preferable is silver iodobromide having a silver iodide content of 80 mol % or higher or silver iodide, and most preferable is silver iodobromide having a silver iodide content of 90 mol % or higher or silver iodide.

Other components are not particularly limited and can be selected from silver halides such as silver chloride and silver bromide, and organic silver salts such as silver thiocyanate, silver phosphate and the like, but it is preferred that a silver chloride content is less than 60 mol %.

The distribution of the halogen composition in a grain may be uniform or the halogen composition may be changed stepwise, or it may be changed continuously. Further, a silver halide grain having a core/shell structure can be preferably used. Preferred structure is a twofold to fivefold structure and, more preferably, core/shell grain having a twofold to fourfold structure can be used. A core-high-silver iodide-structure which has a high content of silver iodide in the core part, and a shell-high-silver iodide-structure which has a high content of silver iodide in the shell part can also be preferably used. Further, a technique of localizing silver bromide or silver iodide on the surface of a grain as form epitaxial parts can also be preferably used.

Silver halide having a high silver iodide content of the invention can assume any of a β phase or a γ phase. The term “β phase” described above means a high silver iodide structure having a wurtzite structure of a hexagonal system and the term “γ phase” means a high silver iodide structure having a zinc blend structure of a cubic crystal system. An average content of γ phase in the present invention is determined by a method presented by C. R. Berry. In the method, a content of γ phase is calculated from the peak ratio of the intensity owing to γ phase (111) to that owing to β phase (100), (101), (002) in powder X-ray diffracting method. Detail description, for example, is described in Physical Review, volume 161, (No.3), pages 848 to 851 (1967).

2) Grain Size

As for the photosensitive silver halide grains used in the present invention, any grain size enough to reach the required high sensitivity can be selected. In the present invention, preferred silver halide grains are those having a mean sphere equivalent diameter of 0.3 μm to 5.0 μm, and more preferred are those having a mean sphere equivalent diameter of 0.35 μm to 3.0 μm. The term “mean sphere equivalent diameter” used here means a diameter of a sphere having the same volume as the volume of a silver halide grain. As for measuring method, the volume of a grain is calculated from projection area and thickness by observation through electron microscope, and thereafter the mean sphere equivalent diameter is determined by converting the volume to a sphere having the volume equivalent to the obtained volume.

3) Coating Amount

In the present invention, a value obtained by dividing a total coating amount of silver contained in the non-photosensitive organic silver salt and the photosensitive silver halide per unit of area by a number of photosensitive silver halide grains per unit of area, preferably is 5×10⁻¹⁴ g/grain or more. It is more preferably 8×10⁻¹⁴ g/grain or more, and further preferably 1×10⁻¹³ g/grain or more. Namely, it is a preferable embodiment in the present invention that the number of photosensitive silver halide grains with respect to the total silver coating amount is extremely small.

The above upper limit deeply depend on various factors such as the kind and the addition amount of means for nucleation used, the properties of non-photosensitive organic silver salts, and the grain size and shape of photosensitive silver halide grains. It is preferably 1×10⁻⁹ g/grain or less, and more preferably 1×10⁻¹⁰ g/grain or less.

Conventionally, reducing the number of photosensitive silver halide grains results in decreasing the sensitivity and the blackening density of the image. Therefore it was impossible to reduce the number of photosensitive silver halide grains. However, with the composition of the photothermographic material according to the present invention, it becomes possible to reduce the number of photosensitive silver halide grains, so that the value obtained by dividing a total coating amount of silver contained in the non-photosensitive organic silver salt and the photosensitive silver halide per unit of area by a number of photosensitive silver halide grains per unit of area, is set to be 5×10⁻¹⁴ g/grain or more.

The mean occupied volume of the aforementioned photosensitive silver halide grains in the image forming layer is expressed by a volume of the image forming layer divided by a number of the photosensitive silver halide grains, and is preferably 0.5 μm³/grain or more, and more preferably, 1.0 μm³/grain or more.

The number of the aforementioned photosensitive silver halide grains per unit of area (in the case of double-sided coated material, the sum of the both sides) is preferably 4×10¹³ grains/m² or less, and more preferably 1×10¹³ grains/m² or less.

Further, in the invention, a value obtained by dividing the number of developed silver grains per unit of area in a maximum density part by a number of the aforementioned photosensitive silver halide grains per unit of area, after thermal development, is preferably more than 1.0 and, more preferably more than 10.

4) Method of Grain Formation

The method of forming photosensitive silver halide is well-known in the relevant art and, for example, methods described in Research Disclosure No. 10729, June 1978, and U.S. Pat. No. 3,700,458 can be used. Specifically, a method of preparing a photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferred.

As for the method of forming tabular grains of silver iodide, the method described in JP-A Nos. 59-119350 and 59-119344 are preferably used.

5) Grain Form

While examples of forms of silver halide grains in the invention can include cubic grains, octahedral grains, tetradecahedral grains, dodecahedral grains, tabular grains, spherical grains, rod shape grains, potato-like grains and the like, preferable in the invention are dodecahedral grains, tetradecahedral grains and tabular grains. The term “dodecahedral grain” means a grain having faces of (001), {1(−1)0} and {101} the term “tetradecahedral grain” means a grain having faces of (001), {100} and {101}. Herein, the {100} face and {101} face express a family of crystallographic faces equivalent to (100) face and (101) face, respectively.

According to the method of forming dodecahedral grains, tetradecahedral grains and octahedral grains, the methods described in JP-A Nos. 2003-287835 and 2003-287836 can be used for reference.

As for tabular grains, in the invention, the projection area equivalent diameter of the silver halide grain is preferably 0.4 μm to 8.0 μm, and more preferably, 0.5 μm to 3.0 μm. The projection area equivalent diameter as used herein means a diameter of a circle converted such that it has a same area as a projection area of a silver halide grain. The projection area equivalent diameter can be determined by measuring the grain area from each projection area using an electron microscope and converting the area to a circle such that it has the same area.

Thickness of the silver halide grain used in the invention is preferably 0.3 μm or less, more preferably 0.2 μm or less, and further preferably 0.15 μm or less. Aspect ratio is preferably 2 to 100, and more preferably 5 to 50.

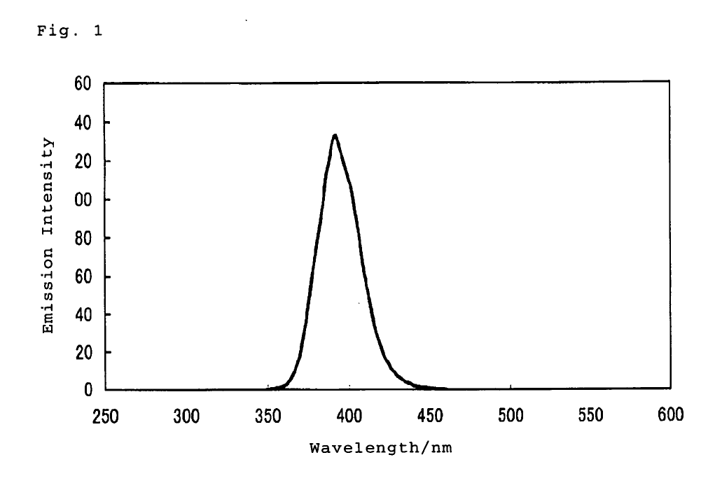

The silver halide having a high silver iodide content of the invention can take a complicated form, and as the preferable form, there are listed, for example, connecting particles as shown in R. L. JENKINS et al., J. of Phot. Sci., vol. 28 (1980), page 164, FIG. 1. Tabular grains as shown in FIG. 1 of the same literature can also be preferably used. Grains obtained by rounding corners of silver halide grains can also be preferably used. The surface index (Mirror index) of the outer surface of a photosensitive silver halide grain is not particularly restricted, and it is preferable that the ratio occupied by the {100} face is rich, because of showing high spectral sensitization efficiency when a spectral sensitizing dye is adsorbed. The ratio is preferably 50% or more, more preferably 65% or more, further preferably 80% or more. The ratio of the {100} face, Mirror index, can be determined by a method described in T. Tani; J. Imaging Sci., vol. 29, page 165 (1985) utilizing adsorption dependency of the {111} face and {100} face in adsorption of a sensitizing dye.

6) Heavy Metal

The photosensitive silver halide grain of the invention can contain metals or complexes of metals belonging to groups 8 to 13 of the periodic table (showing groups 1 to 18). More preferably, the photosensitive silver halide grain of the invention can contain metals or complexes of metals belonging to groups 8 to 10. The metal or the center metal of the metal complex from groups 8 to 10 of the periodic table is preferably rhodium, ruthenium or iridium. The metal complex may be used alone, or two or more kinds of complexes comprising identical or different species of metals may be used together. A preferred content is in the range from 1×10⁻⁹ mol to 1×10⁻³ mol per 1 mol of silver. The heavy metals, metal complexes and the adding method thereof are described in JP-A No. 7-225449, in paragraph Nos. 0018 to 0024 of JP-A No.11-65021 and in paragraph Nos. 0227 to 0240 of JP-A No. 11-119374.

In the present invention, a silver halide grain comprising a hexacyano metal complex is preferred. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]⁴⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano metal complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl) ammonium ion), which are easily misible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

The addition amount of the hexacyano metal complex is preferably from 1×10⁻⁵ mol to 1×10⁻² mol per 1 mol of silver.

The hexacyano metal complex is preferably added in a stage after completion of addition of an aqueous solution of silver nitrate used for grain formation, before completion of emulsion forming step prior to a chemical sensitization step, of conducting chalcogen sensitization such as sulfur sensitization, selenium sensitization and tellurium sensitization or noble metal sensitization such as gold sensitization.

Metal atoms that can be contained in the silver halide grain used in the invention (for example, [Fe(CN)₆]⁴⁻), desalting method of a silver halide emulsion and chemical sensitizing method are described in paragraph Nos. 0046 to 0050 of JP-A No.11-84574, in paragraph Nos. 0025 to 0031 of JP-A No.11-65021, and paragraph Nos. 0242 to 0250 of JP-A No.11-119374.

7) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating solution, and low molecular weight gelatin having a molecular weight of 500 to 60,000 is preferably used. These low molecular weight gelatins may be used at grain formation or at the time of dispersion after desalting treatment and it is preferably used at the time of dispersion after desalting treatment.

8) Chemical Sensitization

The photosensitive silver halide in the present invention can be used without chemical sensitization, but is preferably chemically sensitized by at least one of chalcogen sensitizing method, gold sensitizing method and reduction sensitizing method. The chalcogen sensitizing method includes sulfur sensitizing method, selenium sensitizing method and tellurium sensitizing method.

In sulfur sensitization, unstable sulfur compounds can be used. Such unstable sulfur compounds are described in Chemie et Pysique Photographique, written by P. Grafkides, (Paul Momtel, 5th ed., 1987) and Research Disclosure (vol. 307, Item 307105), and the like.

As typical examples of sulfur sensitizer, known sulfur compounds such as thiosulfates (e.g., hypo), thioureas (e.g., diphenylthiourea, triethylthiourea, N-ethyl-N′-(4-methyl-2-thiazolyl)thiourea and carboxymethyltrimethylthiourea), thioamides (e.g., thioacetamide), rhodanines (e.g., diethylrhodanine, 5-benzylydene-N-ethylrhodanine), phosphinesulfides (e.g., trimethylphosphinesulfide), thiohydantoins, 4-oxo-oxazolidin-2-thione derivatives, disulfides or polysulfides (e.g., dimorphorinedisulfide, cystine, hexathiocan-thione), polythionates, sulfur element and active gelatin can be used. Specifically, thiosulfates, thioureas and rhodanines are preferred.

In selenium sensitization, unstable selenium compounds can be used. These unstable selenium compounds are described in JP-B Nos. 43-13489 and 44-15748, JP-A Nos. 4-25832, 4-109340, 4-271341, 5-40324, 5-11385, 6-51415, 6-175258, 6-180478, 6-208186, 6-208184, 6-317867, 7-92599, 7-98483, and 7-140579, and the like.

As typical examples of selenium sensitizer, colloidal metal selenide, selenoureas (e.g., N,N-dimethylselenourea, trifluoromethylcarbonyl-trimethylselenourea and acetyltrimethylselemourea), selenamides (e.g., selenamide and N,N-diethylphenylselenamide), phosphineselenides (e.g., triphenylphosphineselenide and pentafluorophenyl-triphenylphosphineselenide), selenophosphates (e.g., tri-p-tolylselenophosphate and tri-n-butylselenophosphate), selenoketones (e.g., selenobenzophenone), isoselenocyanates, selenocarbonic acids, selenoesters, diacylselenides can be used. Furthermore, non-unstable selenium compounds such as selenius acid, selenocyanic acid, selenazoles and selenides described in JP-B Nos. 46-4553 and 52-34492 can also be used. Specifically, phosphineselenides, selenoureas and salts of selenocyanic acids are preferred.

In the tellurium sensitization, unstable tellurium compounds are used. Unstable tellurium compounds described in JP-A Nos.4-224595, 4-271341, 4-333043, 5-303157, 6-27573, 6-175258, 6-180478, 6-208186, 6-208184, 6-317867, 7-140579, 7-301879, 7-301880 and the like, can be used as tellurium sensitizer.

As typical examples of tellurium sensitizer, phosphinetellurides (e.g., butyl-diisopropylphosphinetelluride, tributylphosphinetelluride, tributoxyphosphinetelluride and ethoxy-diphenylphosphinetellride), diacyl(di)tellurides (e.g., bis(diphenylcarbamoyl)ditelluride, bis(N-phenyl-N-methylcarbamoyl)ditelluride, bis(N-phenyl-N-methylcarbamoyl)ditelluride, bis(N-phenyl-N-benzylcarbamoyl)telluride and bis(ethoxycarmonyl)telluride), telluroureas (e.g., N,N′-dimethylethylenetellurourea and N,N′-diphenylethylenetellurourea), telluramides, telluroesters are used. Specifically, diacyl(di)tellurides and phosphinetellurides are preferred. Especially, the compounds described in paragraph No. 0030 of JP-A No.11-65021 and compounds represented by formula (II), (III) and (IV) in JP-A No.5-313284 are more preferred.

Specifically, as for the chalcogen sensitization of the invention, selenium sensitization and tellurium sensitization are preferred, and tellurium sensitization is particularly preferred.

In gold sensitization, gold sensitizer described in Chemie et Physique Photographique, written by P. Grafkides, (Paul Momtel, 5th ed., 1987) and Research Disclosure (vol. 307, Item 307105) can be used. To speak concretely, chloroauric acid, potassium chloroaurate, potassium aurithiocyanate, gold sulfide, gold selenide and the like can be used. In addition to these, the gold compounds described in U.S. Pat. Nos. 2,642,361, 5,049,484, 5,049,485, 5,169,751, and 5,252,455, Belg. Patent No. 691857, and the like can also be used. And another novel metal salts except gold such as platinum, palladium, iridium and so on described in Chemie et Pysique Photographique, written by P. Grafkides, (Paul Momtel, 5th ed., 1987) and Research Disclosure (vol. 307, Item 307105) can be used.

The gold sensitization can be used independently, but it is preferably used in combination with the above chalcogen sensitization. Specifically, these sensitizations are gold-sulfur sensitization (gold-plus-sulfur sensitization), gold-selenium sensitization, gold-tellurium sensitization, gold-sulfur-selenium sensitization, gold-sulfur-tellurium sensitization, gold-selenium-tellurium sensitization and gold-sulfur-selenium-tellurium sensitization.

In the invention, chemical sensitization can be applied at any time so long as it is after grain formation and before coating, and it can be applied, after desalting, (1) before spectral sensitization, (2) simultaneously with spectral sensitization, (3) after spectral sensitization and (4) just before coating.

The addition amount of chalcogen sensitizer used in the invention may vary depending on the silver halide grain used, the chemical ripening condition and the like, and it is about 10⁻⁸ mol to 10⁻¹ mol, and preferably, about 10⁻⁷ mol to 10⁻² mol, per 1 mol of silver halide.

Similarly, the addition amount of the gold sensitizer used in the invention may vary depending on various conditions and it is generally about 10⁻⁷ mol to 10⁻² mol and, more preferably, 10⁻⁶ mol to 5×10⁻³ mol per 1 mol of silver halide. There is no particular restriction on the condition for the chemical sensitization in the invention and, appropriately, pAg is 8 or lower, preferably, 7.0 or lower, more preferably, 6.5 or lower and, particularly preferably, 6.0 or lower, and pAg is 1.5 or higher, preferably, 2.0 or higher and, particularly preferably, 2.5 or higher; pH is 3 to 10, preferably, 4 to 9; and temperature is at 20° C. to 95° C., preferably, 25° C. to 80° C.

In the invention, reduction sensitization can also be used in combination with the chalcogen sensitization or the gold sensitization. It is specifically preferred to use in combination with the chalcogen sensitization.

As the specific compound for the reduction sensitization, ascorbic acid, thiourea dioxide or dimethylamine borane is preferred, as well as use of stannous chloride, aminoimino methane sulfonic acid, hydrazine derivatives, borane compounds, silane compounds and polyamine compounds are preferred. The reduction sensitizer may be added at any stage in the photosensitive emulsion production process from crystal growth to the preparation step just before coating. Further, it is preferred to apply reduction sensitization by ripening while keeping pH to 8 or higher and pAg to 4 or lower for the emulsion, and it is also preferred to apply reduction sensitization by introducing a single addition portion of silver ions during grain formation.

The addition amount of the reduction sensitizer may also vary depending on various conditions and it is generally about 10⁻⁷ mol to 10⁻¹ mol and, more preferably, 10⁻⁶ mol to 5×10⁻² mol per 1 mol of silver halide.

In the silver halide emulsion used in the invention, a thiosulfonate compound may be added by the method shown in EP-A No. 293917.

The photosensitive silver halide grain in the invention can be chemically unsensitized, but is preferably chemically sensitized by at least one method of gold sensitizing method and chalcogen sensitizing method for the purpose of designing a high-sensitivity photothermographic material.

9) Compound That can be One-electron-oxidized to Provide a One-electron Oxidation Product which Releases One or More Electrons

The photothermographic material of the invention preferably contains a compound that can be one-electron-oxidized to provide a one-electron oxidation product which releases one or more electrons. The said compound can be used alone or in combination with various chemical sensitizers described above to increase the sensitivity of silver halide.

As the compound that can be one-electron-oxidized to provide a one-electron oxidation product which releases one or more electrons is a compound selected from the following Groups 1 and 2.
(Group 1) a compound that can be one-electron-oxidized to provide a one-electron oxidation product which further releases one or more electrons, due to being subjected to a subsequent bond cleavage reaction;
(Group 2) a compound that can be one-electron-oxidized to provide a one-electron oxidation product, which further releases one or more electrons after being subjected to a subsequent bond formation.

The compound of Group 1 will be explained below.

In the compound of Group 1, as for a compound that can be one-electron-oxidized to provide a one-electron oxidation product which further releases one electron, due to being subjected to a subsequent bond cleavage reaction, specific examples include examples of compound referred to as “one photon two electrons sensitizer” or “deprotonating electron-donating sensitizer” described in JP-A No. 9-211769 (Compound PMT-1 to S-37 in Tables E and F, pages 28 to 32); JP-A No. 9-211774; JP-A No. 11-95355 (Compound INV1 to 36); JP-W No. 2001-500996 (Compound 1 to 74, 80 to 87, and 92 to 122); U.S. Pat. Nos. 5,747,235 and 5,747,236; EP No. 786692A1 (Compound INV 1 to 35); EP No. 893732A1; U.S. Pat. Nos. 6,054,260 and 5,994,051; etc. Preferred ranges of these compounds are the same as the preferred ranges described in the quoted specifications.

In the compound of Group 1, as for a compound that can be one-electron-oxidized to provide a one-electron oxidation product which further releases one or more electrons, due to being subjected to a subsequent bond cleavage reaction, specific examples include the compounds represented by formula (1) (same as formula (1) described in JP-A No. 2003-114487), formula (2) (same as formula (2) described in JP-A No. 2003-114487), formula (3) (same as formula (1) described in JP-A No. 2003-114488), formula (4) (same as formula (2) described in JP-A No. 2003-114488), formula (5) (same as formula (3) described in JP-A No. 2003-114488), formula (6) (same as formula (1) described in JP-A No. 2003-75950), formula (7) (same as formula (2) described in JP-A No. 2003-75950), and formula (8), and the compound represented by formula (9) among the compounds which can undergo the chemical reaction represented by reaction formula (1). And the preferable range of these compounds is the same as the preferable range described in the quoted specification.

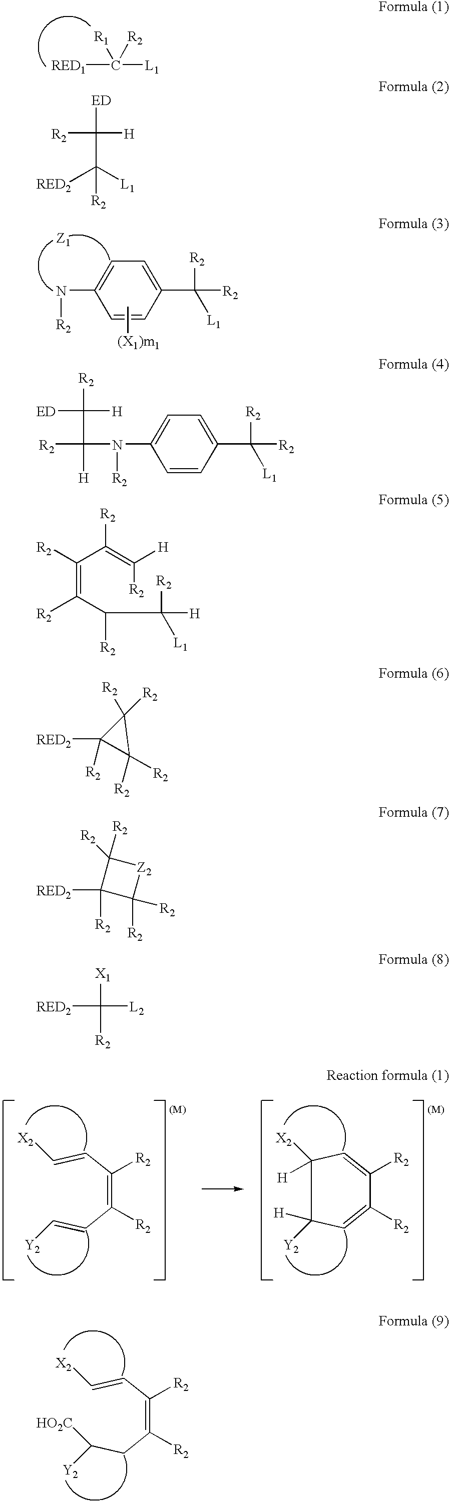

In the formulae, RED₁ and RED₂ represent a reducible group. R₁ represents a nonmetallic atomic group forming a cyclic structure equivalent to a tetrahydro derivative or an octahydro derivative of a 5 or 6 membered aromatic ring (including a hetero aromatic ring) with a carbon atom (C) and RED₁. R₂ represents a hydrogen atom or a substituent. In the case where plural R₂ exist in a same molecule, these may be the same or different. L₁ represents a leaving group. ED represents an electron-donating group. Z₁ represents an atomic group capable to form a 6 membered ring with a nitrogen atom and two carbon atoms of a benzene ring. X₁ represents a substituent, and m₁ represents an integral number of 0 to 3. Z₂ represents —CR₁₁R₁₂—, —NR₁₃—, or —O—. R₁₁ and R₁₂ each independently represent a hydrogen atom or a substituent. R₁₃ represents a hydrogen atom, an alkyl group, an aryl group or a heterocyclic group. X₁ represents an alkoxy group, an aryloxy group, a heterocyclic oxy group, an alkylthio group, an arylthio group, a heterocyclic thio group, an alkylamino group, an arylamino group or a heterocyclic amino group. L₂ represents a carboxy group or a salt thereof, or a hydrogen atom. X₂ represents a group to form a 5 membered heterocycle with C═C. M represents a radical, a radical cation or a cation.

Next, the compound of Group 2 is explained.

In the compound of Group 2, as for a compound that can be one-electron-oxidized to provide a one-electron oxidation product which further releases one or more electrons, after being subjected to a subsequent bond cleavage reaction, specific examples can include the compound represented by formula (10) (same as formula (1) described in JP-A No.2003-140287), and the compound represented by formula (11) which can undergo the chemical reaction represented by reaction formula (1). The preferable range of these compounds is the same as the preferable range described in the quoted specification.

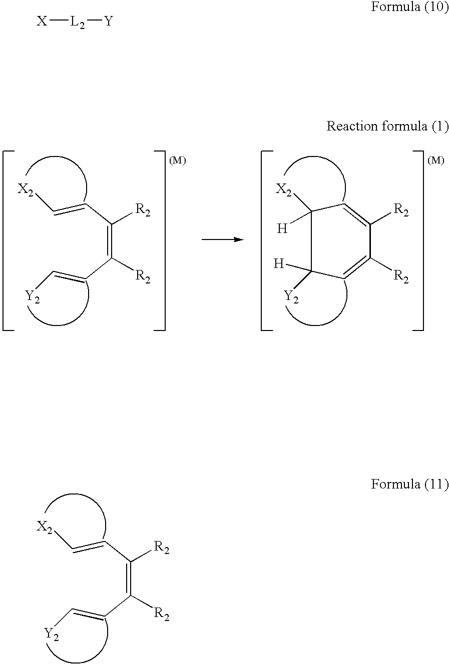

In the formula described above, X represents a reducible group which can be one-electron-oxidized. Y represents a reactive group containing a carbon-carbon double bond part, a carbon-carbon triple bond part, an aromatic group part or benzo-condensed nonaromatic heterocyclic group which can react with one-electron-oxidized product formed by one-electron-oxidation of X to form a new bond. L₂ represents a connecting group to bind X and Y. R₂ represents a hydrogen atom or a substituent. In the case where plural R₂ exist in a same molecule, these may be the same or different. X₂ represents a group to form a 5 membered heterocycle with C═C. Y₂ represents a group to form a 5 or 6 membered aryl group or heterocyclic group with C═C. M represents a radical, a radical cation or a cation.

The compounds of Groups 1 and 2 preferably are “the compound having an adsorptive group to silver halide in a molecule” or “the compound having a partial structure of a spectral sensitizing dye in a molecule”. The representative adsorptive group to silver halide is the group described in JP-A No. 2003-156823, page 16 right, line 1 to page 17 right, line 12. A partial structure of a spectral sensitizing dye is the structure described in JP-A No. 2003-156823, page 17 right, line 34 to page 18 right, line 6.

As the compound of Groups 1 and 2, “the compound having at least one adsorptive group to silver halide in a molecule” is more preferred, and “the compound having two or more adsorptive groups to silver halide in a molecule” is further preferred. In the case where two or more adsorptive groups exist in a single molecule, those adsorptive groups may be identical or different with each other.

As preferable adsorptive group, a nitrogen containing heterocyclic group substituted by a mercapto group (e.g., a 2-mercaptothiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, a 1,5-dimethyl-1,2,4-triazolium-3-thiolate group and the like) or a nitrogen containing heterocyclic group having —NH— group as a partial structure of heterocycle capable to form a silver imidate (>NAg) (e.g., a benzotriazole group, a benzimidazole group, an indazole group and the like) are described. A 5-mercaptotetrazole group, a 3-mercapto-1,2,4-triazole group and a benzotriazole group are particularly preferable and a 3-mercapto-1,2,4-triazole group and a 5-mercaptotetrazole group are most preferable.

As an adsorptive group, the group which has two or more mercapto groups as a partial structure in a molecule is also particularly preferable. Herein, a mercapto group (—SH) may become a thione group in the case where it can tautomerize. As preferred examples of adsorptive group having two or more mercapto groups as a partial structure (dimercapto-substituted nitrogen containing heterocyclic group and the like), a 2,4-dimercaptopyrimidine group, a 2,4-dimercaptotriazine group and a 3,5-dimercapto1,2,4-triazole group are described.

Further, a quaternary salt structure of nitrogen or phosphor is also preferably used as an adsorptive group. As typical quaternary salt structure of nitrogen, an ammonio group (a trialkylammonio group, a dialkylarylammonio group, a dialkylheteroarylammonio group, an alkyldiarylammonio group, an alkyldiheteroarylammonio group and the like) and a nitrogen containing heterocyclic group including quaternary nitrogen atom are described. As a quaternary salt structure of phosphor, a phosphonio group (a trialkylphosphonio group, a dialkylarylphosphonio group, a dialkylheteroarylphosphonio group, an alkyldiarylphosphonio group, an alkyldiheteroarylphosphonio group, a triarylphosphonio group, a triheteroarylphosphonio group and the like) are described. A quaternary salt structure of nitrogen is more preferably used and a 5 or 6 membered aromatic heterocyclic group containing a quaternary nitrogen atom is further preferably used. Particularly preferably, a pyrydinio group, a quinolinio group and an isoquinolinio group are used. These nitrogen containing heterocyclic groups including a quaternary nitrogen atom may have any substituent.

As examples of counter anion of quaternary salt, halogen ion, carboxylate ion, sulfonate ion, sulfate ion, perchlorate ion, carbonate ion, nitrate ion, BF₄⁻, PF₆⁻, Ph₄B⁻ and the like are described. In the case where the group having negative charge at carboxylate group and the like exists in a molecule, an inner salt may be formed with it. As a counter ion outside of a molecule, chloro ion, bromo ion and methanesulfonate ion are particularly preferable.

The preferred structure of the compound represented by Group 1 and 2 compound having a quaternary salt of nitrogen or phosphor as an adsorptive group is represented by formula (X).
(P—Q₁—)ᵢ—R(—Q₂—S)ⱼ Formula (X)

In formula (X), P and R each independently represent a quaternary salt structure of nitrogen or phosphor, which is not a partial structure of a spectral sensitizing dye. Q₁ and Q₂ each independently represent a connecting group and typically represent a single bond, an alkylene group, an arylene group, a heterocyclic group, —O—, —S—, —NR_{N}, —C(═O)—, —SO₂—, —SO—, —P(═O)— and the group which consists of combination of these groups. Herein, R_{N} represents a hydrogen atom, an alkyl group, an aryl group or a heterocyclic group. S represents a residue which is obtained by removing one atom from the compound represented by Group 1 or 2. i and j are an integral number of one or more, and are selected in a range of i+j=2 to 6. It is preferred that i is 1, 2 or 3 and j is 1 or 2. It is more preferred that i is 1 or 2 and j is 1. And, it is particularly preferred that i is 1 and j is 1. The compound represented by formula (X) preferably has 10 to 100 carbon atoms in total, more preferably 10 to 70 carbon atoms, further preferably 11 to 60 carbon atoms, and particularly preferably 12 to 50 carbon atoms.

The compounds of Groups 1 and 2 may be used at any time during preparation of the photosensitive silver halide emulsion and production of the photothermographic material. For example, the compound may be used in a photosensitive silver halide grain formation step, in a desalting step, in a chemical sensitization step, and before coating, etc. The compound may be added in several times, during these steps. The compound is preferably added, after the photosensitive silver halide grain formation step and before the desalting step; in the chemical sensitization step (just before the chemical sensitization to immediately after the chemical sensitization); or before coating. The compound is more preferably added, just before the chemical sensitization step to before mixing with the non-photosensitive organic silver salt.

It is preferred that the compound of Groups 1 and 2 used in the invention is dissolved in water, a water-soluble solvent such as methanol and ethanol, or a mixed solvent thereof, to be added. In the case where the compound is dissolved in water and solubility of the compound is increased by increasing or decreasing a pH value of the solvent, the pH value may be increased or decreased to dissolve and add the compound.

The compound of Groups 1 and 2 used in the invention is preferably added to the image forming layer comprising the photosensitive silver halide and the non-photosensitive organic silver salt. The compound may be added to a surface protective layer, or an intermediate layer, as well as the image forming layer comprising the photosensitive silver halide and the non-photosensitive organic silver salt, to be diffused to the image forming layer in the coating step. The compound may be added before or after addition of a sensitizing dye. Each compound is contained in the image forming layer preferably in an amount of 1×10⁻⁹ mol to 5×10⁻¹ mol, more preferably 1×10⁻⁸ mol to 5×10⁻² mol, per 1 mol of silver halide.

10) Compound having Adsorptive Group and Reducible Group.

The photothermographic material of the present invention preferably comprises a compound having an adsorptive group and a reducible group in a molecule.

It is preferred that the compound having an adsorptive group and a reducible group used in the invention is represented by the following formula (I).
A—(W)n-B Formula (I)

In formula (I), A represents a group capable of adsorption to a silver halide (hereafter, it is called an adsorptive group), W represents a divalent connecting group, n represents 0 or 1, and B represents a reducible group.

In formula (I), the adsorptive group represented by A is a group to adsorb directly to a silver halide or a group to promote adsorption to a silver halide. As typical examples, a mercapto group (or a salt thereof), a thione group (—C(═S)—), a nitrogen atom, a heterocyclic group containing at least one atom selected from a nitrogen atom, a sulfur atom, a selenium atom and a tellurium atom, a sulfide group, a disulfide group, a cationic group, an ethynyl group and the like are described.

The mercapto group as an adsorptive group means a mercapto group (and a salt thereof) itself and simultaneously more preferably represents a heterocyclic group or an aryl group or an alkyl group substituted by at least one mercapto group (or a salt thereof). Herein, as the heterocyclic group, a monocyclic or a condensed aromatic or nonaromatic heterocyclic group having at least a 5 to 7 membered ring, e.g., an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group and the like are described. A heterocyclic group having a quaternary nitrogen atom may also be adopted, wherein a mercapto group as a substituent may dissociate to form a mesoion. As a counter ion, whereby a mercapto group forms a salt thereof, a cation such as an alkali metal, an alkali earth metal, a heavy metal and the like (Li⁺, Na⁺, K⁺, Mg²⁺, Ag⁺, Zn²⁺ and the like), an ammonium ion, a heterocyclic group comprising a quaternary nitrogen atom, a phosphonium ion and the like are described.

Further, the mercapto group as an adsorptive group may become a thione group by a tautomerization.

The thione group as an adsorptive group may also contain a chain or a cyclic thioamide group, a thioureido group, a thiouretane group or a dithiocarbamic acid ester group.

The heterocyclic group containing at least one atom selected from a nitrogen atom, a sulfur atom, a selenium atom and a tellurium atom represents a nitrogen atom containing heterocyclic group having —NH— group, as a partial structure of heterocycle, capable to form a silver iminate (>NAg) or a heterocyclic group, having —S— group, —Se— group, —Te— group or ═N— group as a partial structure of heterocycle, and capable to coordinate to a silver ion by a chelate bonding. As the former examples, a benzotriazole group, a triazole group, an indazole group, a pyrazole group, a tetrazole group, a benzimidazole group, a purine group and the like are described. As the latter examples, a thiophene group, a thiazole group, a benzoxazole group, a thiadiazole group, an oxadiazole group, a triazine group, a selenoazole group, a benzoselenazole group, a tellurazole group, a benzotellurazole group and the like are described.

The sulfide group or disulfide group as an adsorptive group contains all groups having “—S—” or “—S—S—” as a partial structure.

The cationic group as an adsorptive group means the group containing a quaternary nitrogen atom, such as an ammonio group or a nitrogen containing heterocyclic group including a quaternary nitrogen atom. As examples of the heterocyclic group containing a quaternary nitrogen atom, a pyridinio group, a quinolinio group, an isoquinolinio group, an imidazolio group and the like are described.

The ethynyl group as an adsorptive group means —C≡CH group and the said hydrogen atom may be substituted.

The adsorptive group described above may have any substituent.

Further, as typical examples of an adsorptive group, the compounds described in pages 4 to 7 in the specification of JP-A No.11-95355 are described.

As an adsorptive group represented by A in formula (I), a heterocyclic group substituted by a mercapto group (e.g., a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazorium-3-thiolate group, a 2,4-dimercaptopyrimidine group, a 2,4-dimercaptotriazine group, a 3,5-dimercapto-1,2,4-triazole group, a 2,5-dimercapto-1,3-thiazole group and the like) or a nitrogen atom containing heterocyclic group having a —NH— group capable to form an imino-silver (>NAg) as a partial structure of heterocycle (e.g., a benzotriazole group, a benzimidazole group, an indazole group and the like) is preferable, and more preferable as an adsorptive group is a 2-mercaptobenzimidazole group or a 3,5-dimercapto-1,2,4-triazole group.

In formula (I), W represents a divalent connection group. The said connection group may be any divalent connection group, as far as it does not give a bad effect toward a photographic property. For example, a divalent connection group, which includes a carbon atom, a hydrogen atom, an oxygen atom a nitrogen atom and a sulfur atom, can be used. As typical examples, an alkylene group having 1 to 20 carbon atoms (e.g., a methylene group, an ethylene group, a trimethylene group, a tetramethylene group, a hexamethylene group and the like), an arylene group having 6 to 20 carbon atoms (e.g., a phenylene group, a nephthylene group and the like), —CONR₁—, —SO₂NR₂—, —O—, —S—, —NR₃—, —NR₄CO—, —NR₅SO₂—, —NR₆CONR₇—, —COO—, —OCO—and the combination of these connecting groups are described. Herein, R₁ represents a hydrogen atom, an alkyl group, a heterocyclic group, or an aryl group.

The divalent connection group represented by W may have any substituent.

In formula (I), a reducible group represented by B represents the group capable to reduce a silver ion. As the examples, a formyl group, an amino group, a triple bond group such as an acetylene group, a propargyl group and the like, a mercapto group, hydroxylamines, hydroxamic acids, hydroxyureas, hydroxyurethanes, hydroxysemicarbazides, reductones (reductone derivatives are contained), anilines, phenols (chroman-6-ols, 2,3-dihydrobenzofuran-5-ols, aminophenols, sulfonamidophenols and polyphenols such as hydroquinones, catechols, resorcinols, benzenetriols, bisphenols are contained), aclhydrazines, carbamoylhydrazides and a residue which is obtained by removing one hydrogen atom from 3-pyrazolidones and the like can be described. They may have any substituent.

The oxidation potential of a reducible group represented by B in formula (I), can be measured by using the measuring method described in Akira Fujishima, “DENKIKAGAKU SOKUTEIHO”, pages 150 to 208, GIHODO SHUPPAN and NIHON KAGAKUKAI, “ZIKKEN KAGAKUKOUZA”, 4th ed., vol. 9, pages 282 to 344, MARUZEN. For example, the method of rotating disc voltammetry can be used; namely the sample is dissolved in the solution (methanol:pH 6.5 Britton-Robinson buffer=10% : 90% (% by volume)) and after bubbling with nitrogen gas during 10 minutes the voltamograph can be measured under the condition of 1000 rotations/minute, the sweep rate 20 mV/second, at 25° C. by using a rotating disc electrode (RDE) made by glassy carbon as a working electrode, a platinum electrode as a counter electrode and a saturated calomel electrode as a reference electrode. The half wave potential (E1/2) can be calculated by that obtained voltamograph.

When a reducible group represented by B in the present invention is measured by the method described above, an oxidation potential preferably is in the range of about −0.3 V to about 1.0 V, more preferably about −0.1 V to about 0.8 V, and most preferably about 0 V to about 0.7 V.

In formula (I), a reducible group represented by B preferably is hydroxylamines, hydroxamic acids, hydroxyureas, hydroxysemicarbazides, reductones, phenols, acylhydrazines, carbamoylhydrazides, or a residue which is obtained by removing one hydrogen atom from 3-pyrazolidones and the like.

The compound of formula (I) in the present invention may have the ballasted group or polymer chain in it generally used in the non-moving photographic additives as a coupler. And as a polymer, for example, the polymer described in JP-A No. 1-100530 can be described.

The compound of formula (I) in the present invention may be bis or tris type of compound. The molecular weight of the compound represented by formula (I) in the present invention is preferably 100 to 10000 and more preferably 120 to 1000 and particularly preferably 150 to 500.

The examples of the compound represented by formula (I) in the present invention are shown below, but the present invention is not limited in these.

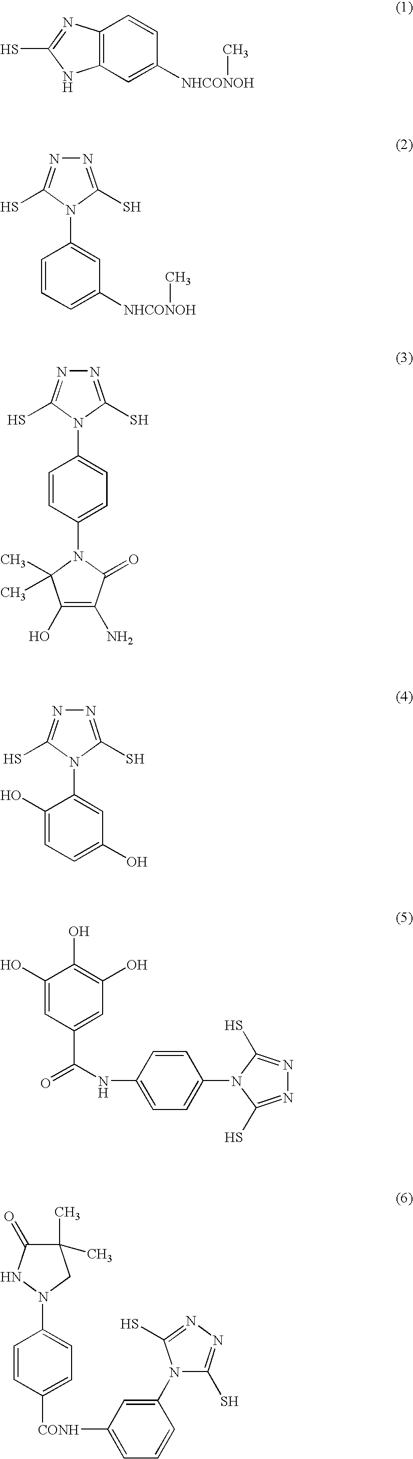

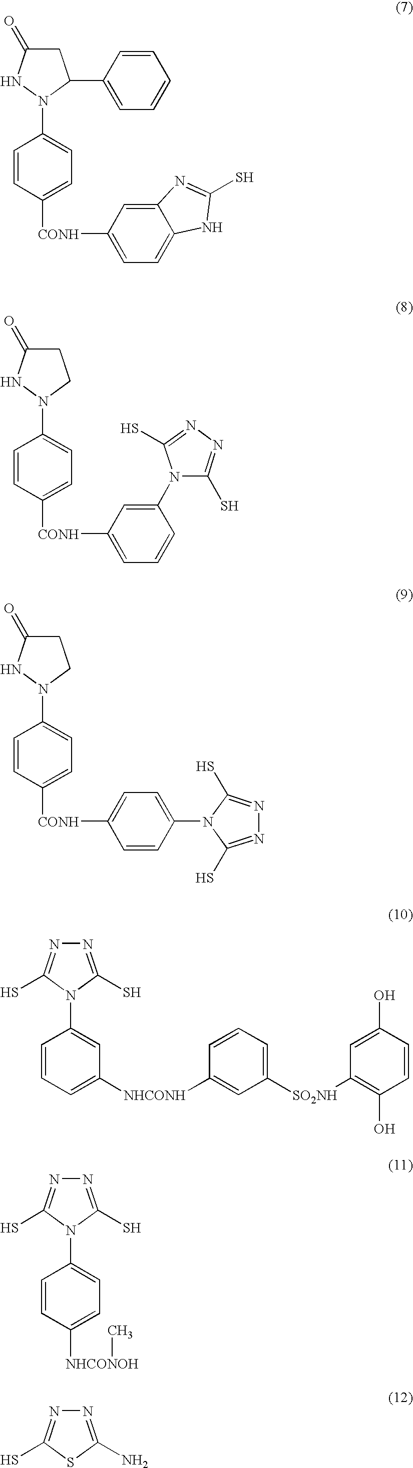

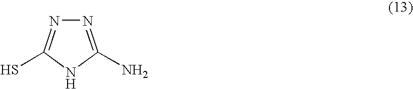

Further, example compounds 1 to 30 and 1″-1 to 1″-77 shown in EP No. 1308776A2, pages 73 to 87 are also described as preferable examples of the compound having an adsorptive group and a reducible group according to the invention.

These compounds can be easily synthesized by the known method. The compound of formula (I) in the present invention can be used independently as only one compound, but it is preferred to use two compounds or more in combination. When two or more kinds of compounds are used in combination, those may be added to the same layer or the different layers, whereby adding methods may be different from each other.

The compound represented by formula (I) in the present invention preferably is added to a image forming layer and more preferably is to be added at an emulsion preparing process. In the case, wherein these compounds are added at an emulsion preparing process, these compounds may be added at any step in the process. For example, the silver halide grain forming step, a step before starting of salt washing-out step, the salt washing-out step, the step before chemical ripening, the chemical ripening step, the step before preparing a final emulsion and the like are described. Also, the addition can be performed in the plural divided steps during the process. It is preferred to be added in an image forming layer, but also to be diffused at a coating step from a protective layer or an intermediate layer adjacent to the image forming layer, wherein these compounds are added in the protective layer or the intermediate layer in combination with their addition to the image forming layer.

The preferred addition amount is largely depend on the adding method described above or the kind of the compound, but generally 1×10⁻⁶ mol to 1 mol per 1 mol of photosensitive silver halide, preferably 1×10⁻⁵ mol to 5×10⁻¹ mol, and more preferably 1×10⁻⁴ mol to 1×10⁻¹ mol.

The compound represented by formula (I) in the present invention can be added by dissolving in water or water-soluble solvent such as methanol, ethanol and the like or a mixed solution thereof. At this time, pH may be arranged suitably by an acid or an alkaline and a surfactant can be coexisted. Further, these compounds may be added as an emulsified dispersion by dissolving them in an organic solvent having a high boiling point and also may be added as a solid dispersion.

11) Sensitizing Dye

As the sensitizing dye applicable in the invention, those capable of spectrally sensitizing silver halide grains in a desired wavelength region upon adsorption to silver halide grains having spectral sensitivity suitable to spectral characteristic of an exposure light source can be selected advantageously. Particularly, the photothermographic material of the invention is preferably spectral sensitized to have a spectral sensitive peak in a range of 600 nm to 900 nm, or in a range of 300 nm to 500 nm. The sensitizing dyes and the adding method are disclosed, for example, JP-A No. 11-65021 (paragraph Nos. 0103 to 0109), as a compound represented by the formula (II) in JP-A No. 10-186572, dyes represented by the formula (I) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP-A No. 0803764A1, and in JP-A Nos. 2001-272747, 2001-290238 and 2002-23306. The sensitizing dyes described above may be used alone or, two or more kinds of them may be used in combination.

In the invention, the sensitizing dye may be added at any amount according to the properties of sensitivity and fog, but it is preferably added from 10⁻⁶ mol to 1 mol, and more preferably from 10⁻⁴ mol to 10⁻¹ mol, per 1 mol of silver halide in the image forming layer.

The photothermographic material of the invention may also contain super sensitizers in order to improve spectral sensitizing effect. The super sensitizers usable in the invention can include those compounds described in EP-A No. 587338, U.S. Pat. Nos. 3,877,943 and 4,873,184, JP-A Nos. 5-341432, 11-109547 and 10-111543, and the like.

12) Combined Use of a Plurality of Silver Halides

The photosensitive silver halide emulsion in the photothermographic material used in the invention may be used alone, or two or more kinds of them (for example, those of different average particle sizes, different halogen compositions, of different crystal habits and of different conditions for chemical sensitization) may be used together. Gradation can be controlled by using plural kinds of photosensitive silver halide of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

13) Mixing Silver Halide and Organic Silver Salt

The photosensitive silver halide in the invention is particularly preferably formed under the absence of the non-photosensitive organic silver salt and chemically sensitized. This is because a sufficient sensitivity can not sometimes be attained by the method of forming the silver halide by adding a halogenating agent to the organic silver salt.

The method of mixing the silver halide and the organic silver salt can include a method of mixing a separately prepared photosensitive silver halide and an organic silver salt by a high speed stirrer, ball mill, sand mill, colloid mill, vibration mill, or homogenizer, or a method of mixing a photosensitive silver halide completed for preparation at any timing in the preparation of an organic silver salt and preparing the organic silver salt. The effect of the invention can be obtained preferably by any of the methods described above.

14) Mixing Silver Halide into Coating Solution

In the invention, the time of adding silver halide to the coating solution for the image forming layer is preferably in the range from 180 minutes before to just prior to the coating, more preferably, 60 minutes before to 10 seconds before coating. But there is no restriction for mixing method and mixing condition as far as the effect of the invention appears sufficient. As an embodiment of a mixing method, there is a method of mixing in the tank controlling the average residence time to be desired. The average residence time herein is calculated from addition flux and the amount of solution transferred to the coater. And another embodiment of mixing method is a method using a static mixer, which is described in 8th edition of “Ekitai Kongou Gijutu” by N. Harnby and M. F. Edwards, translated by Kouji Takahashi (Nikkan Kougyou Shinbunsha, 1989).

(Organic Silver Salt)

The organic silver salt according to the invention is relatively stable to light but serves as to supply silver ions and forms silver images when heated to 80° C. or higher under the presence of an exposed photosensitive silver halide and a reducing agent. The organic silver salt may be any organic material containing a source capable of reducing silver ions. Such non-photosensitive organic silver salt is disclosed, for example, in JP-A No. 10-62899 (paragraph Nos. 0048 to 0049), EP-A No. 0803764A1 (page 18, line 24 to page 19, line 37), EP-A No. 0962812A1, JP-A Nos. 11-349591, 2000-7683, and 2000-72711, and the like. A silver salt of organic acid, particularly, a silver salt of long chained fatty acid carboxylic acid (having 10 to 30 carbon atoms, preferably, having 15 to 28 carbon atoms) is preferable. Preferred examples of the organic silver salt can include, for example, silver behenate, silver arachidinate, silver stearate, silver oleate, silver laurate, silver capronate, silver myristate, silver palmitate and mixtures thereof. In the present invention, among the organic silver salts, it is preferred to use an organic silver salt with the silver behenate content of 50 mol % or more, and particularly preferably, 75 mol % to 98 mol %.

There is no particular restriction on the shape of the organic silver salt usable in the invention and it may needle-like, bar-like, tabular or flaky shape.

In the invention, a flaky shaped organic silver salt is preferred. In the present specification, the flaky shaped organic silver salt is defined as described below. When an organic acid silver salt is observed under an electron microscope, calculation is made while approximating the shape of an organic acid silver salt particle to a rectangular body and assuming each side of the rectangular body as a, b, c from the shorter side (c may be identical with b) and determining x based on numerical values a, b for the shorter side as below.
x=b/a

As described above, x is determined for the particles by the number of about 200 and those capable of satisfying the relation: x (average)≧1.5 as an average value x is defined as a flaky shape. The relation is preferably: 30≧x (average)≧1.5 and, more preferably, 15≧x (average)≧1.5. By the way, needle-like is expressed as 1≦x (average)<1.5.

In the flaky shaped particle, a can be regarded as a thickness of a tabular particle having a main plate with b and c being as the sides. a in average is preferably 0.01 μm to 0.3 μm and, more preferably, 0.1 μm to 0.23 μm. c/b in average preferably 1 to 6, more preferably, 1 to 4 and, further preferably, 1 to 3 and, particularly preferably, 1 to 2.

As the particle size distribution of the organic silver salt, mono-dispersion is preferred. In the mono-dispersion, the percentage for the value obtained by dividing the standard deviation for the length of minor axis and major axis by the minor axis and the major axis respectively is, preferably, 100% or less, more preferably, 80% or less and, further preferably, 50% or less. The shape of the organic silver salt can be measured by determining dispersion of an organic silver salt as transmission type electron microscopic images. Another method of measuring the mono-dispersion is a method of determining of the standard deviation of the volume weighted mean diameter of the organic silver salt in which the percentage for the value defined by the volume weight mean diameter (variation coefficient), is preferably, 100% or less, more preferably, 80% or less and, further preferably, 50% or less. The mono-dispersion can be determined from particle size (volume weighted mean diameter) obtained, for example, by a measuring method of irradiating a laser beam to an organic silver salt dispersed in a liquid, and determining a self correlation function of the fluctuation of scattered light to the change of time.

Methods known in the art may be applied to the method for producing the organic silver salt used in the invention and to the dispersing method thereof. For example, reference can be made to JP-A No. 10-62899, EP-A Nos. 0803763A1 and 0962812A1, JP-A Nos. 11-349591, 2000-7683, 2000-72711, 2001-163827, 2001-163889, 2001-163890, 11-203413, 2001-188313, 2001-83652, 2002-6442, 2002-31870, and the like.

In the invention, the photothermographic material can be prepared by mixing an aqueous dispersion of an organic silver salt and an aqueous dispersion of a photosensitive silver salt. A method of mixing two or more kinds of aqueous dispersions of organic silver salts and two or more kinds of aqueous dispersions of photosensitive silver salts upon mixing are used preferably for controlling the photographic properties.

While an organic silver salt in the invention can be used in a desired amount, an amount of an organic silver salt is preferably in the range from 0.1 g/m² to 5.0 g/m², more preferably 0.5 g/m² to 3.0 g/m², and particularly preferably 0.8 g/m² to 2.0 g/m², with respect to the amount of silver.

(Means for Nucleation)

The means for nucleation which can be used in the present invention is the means which can induce a new development in the neighborhood of the initial developing part as a result of initial development. As the means for nucleation which can be used in the present invention, the compound conventionally known as a nucleator and an infectious reducing agent can be used, however the compound having the function described above can be used in the present invention without limitation of these.

1) Nucleator

The nucleator used in the present invention is explained below.

The nucleator according to the invention is the compound, which can form a compound that can newly induce a development by the reaction with developing product in consequence of an initial development. It was conventionally known to use a nucleator for the ultra-high contrast photosensitive materials suitable for the use for graphic arts. The ultra-high contrast photosensitive materials had an average gradient of ten or more and were unsuitable for conventional photographic materials, and especially unsuitable for the medical use where high diagnostic ability was required. And because the ultra-high contrast photosensitive material had rough graininess and did not have enough sharpness, there was no aptitude in a medical diagnostic use. The nucleator in the present invention completely differs from the nucleator in the conventional ultra-high contrast photosensitive material as regards the effect. The nucleator in the present invention does not make a gradation hard. The nucleator in the present invention is the compound can cause development sufficiently, even if the number of photosensitive silver halide grain with respect to non-photosensitive silver salt of organic acid is extremely lessened. Although that mechanism is not clear, when thermal development is performed using the nucleator according to the present invention, it becomes clear that the number of developed silver grain exists larger than the number of photosensitive silver halide grain in the maximum density part, and it is presumed that the nucleator according to the present invention has the action to form the new development point (development nuclei) in the part where a silver halide grain does not exist.

As the nucleator, hydrazine derivative compounds represented by the following formula (V), vinyl compounds represented by the following formula (VI), and quaternary onium compounds represented by the following formula (P) are preferable. Among the vinyl compounds, cyclic olefine compounds represented by formulae (A), (B) and (C) are particularly preferable.

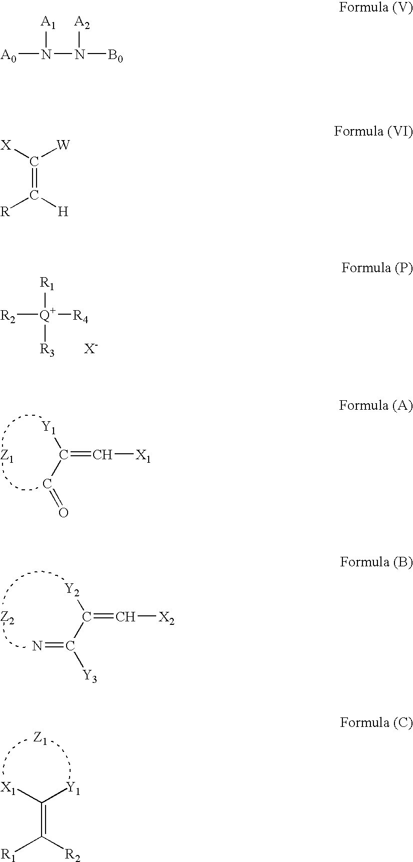

In formula (V), A₀ represents each substitutable aliphatic group, aromatic group, heterocyclic group or a —G₀—D₀ group, and B₀ represents a blocking group. A₁ and A₂ both represent a hydrogen atom, or one represents a hydrogen atom and the other represents an acyl group, a sulfonyl group or an oxalyl group. Herein, G₀ represents a —CO— group, a —COCO— group, a —CS— group, a —C(═NG₁D₁)— group, a —SO— group, a —SO₂— group or a —P(O) (G₁D₁)— group and G₁ represents a mere bonding hand, a —O— group, a —S— group or a —N(D₁) group. D₁ represents an aliphatic group, an aromatic group, a heterocyclic group or a hydrogen atom. In the case where a plurality of D₁s exist in the molecule, those may be the same or different. Do represents a hydrogen atom, an aliphatic group, an aromatic group, a heterocyclic group, an amino group, an alkoxy group, an aryloxy group, an alkylthio group or an arylthio group. As preferable D₀, a hydrogen atom, an alkyl group, an alkoxy group, an amino group and the like are described.

In formula (V), the aliphatic group represented by A, preferably has 1 to 30 carbon atoms, and particularly preferably is a normal, blanched or cyclic alkyl group having 1 to 20 carbon atoms. For example, a methyl group, an ethyl group, a t-butyl group, an octyl group, a cyclohexyl group, a benzyl group are described. These may be further substituted by a suitable substituent (e.g., an aryl group, an alkoxy group, an aryloxy group, an alkylthio group, an arylthio group, a sulfoxy group, a sulfonamido group, a sulfamoyl group, an acylamino group, an ureido group and the like).

In formula (V), the aryl group represented by A₀, preferably is an aryl group of a single or condensed ring. For example, a benzene ring or a naphthalene ring is described. As a heterocyclic ring represented by A₀, the heterocyclic ring of a single or condensed ring containing at least one hetero atom selected from a nitrogen atom, a sulfur atom and an oxygen atom is preferable. For example, a pyrrolidine ring, an imidazole ring, a tetrahydrofuran ring, a morpholine ring, a pyridine ring, a pyrimidine ring, a quinoline ring, a thiazole ring, a benzothiazole ring, a thiophene ring and a furan ring are described. In A₀, an aryl group, a heterocyclic group and a —G₀—D₀ group may have a substituent. As A₀, an aryl group and a —G₀—D₀ group are particularly preferable.

And, in formula (V), A₀ preferably contains at least one of a diffusion-resistant group or an adsorptive group to silver halide. As a diffusion-resistant group, a ballast group usually used as non-moving photographic additive is preferable. As a ballast group, a photochemically inactive alkyl group, alkenyl group, alkynyl group, alkoxy group, phenyl group, phenoxy group, alkylphenoxy group and the like are described and it is preferred that the substituent part has 8 or more carbon atoms is total.

In formula (V), as an adsorption promoting group to silver halide, thiourea, a thiourethane group, a mercapto group, a thioether group, a thione group, a heterocyclic group, a thioamido heterocyclic group, a mercapto heterocyclic group or an adsorptive group described in JP-A No. 64-90439 and the like are described.

In formula (V), B₀ represents a blocking group and preferably a —G₀—D₀ group. G₀ represents a —CO— group, a —COCO— group, a —CS— group, a —C(═NG₁D₁) group, a —SO— group, a —SO₂— group or a —P(O) (G₁D₁)— group. As preferable G₀, a —CO— group and a —COCO— group are described. G₁ represents a mere bonding hand, a —O—group, a —S— group or a —N(D₁)— group, and D₁ represents an aliphatic group, an aromatic group, a heterocyclic group or a hydrogen atom. In the case where plural D₁ exist in a molecule, they may be the same or different. D₀ represents a hydrogen atom, an aliphatic group, an aromatic group, a heterocyclic group, an amino group, an alkoxy group, an aryloxy group, an alkylthio group or an arylthio group. As preferable D₀, a hydrogen atom, an alkyl group, an alkoxy group, an amino group and the like are described. A₁ and A₂ both represent a hydrogen atom, or one represents a hydrogen atom and the other represents an acyl group (an acetyl group, a trifluoroacetyl group, a benzoyl group or the like), a sulfonyl group (a methanesulfonyl group, a toluenesulfonyl group or the like) or an oxalyl group (an ethoxalyl group or the like).

As specific examples of the compound represented by formula (V), the compound H-1 to H-35 of chemical formula Nos. 12 to 18 and the compound H-1-1 to H-4-5 of chemical formula Nos. 20 to 26 in JP-A No. 2002-131864 are described, however specific examples are not limited in these.

These compounds represented by formula (V) can be easily synthesized by known methods. For example, these can be synthesized by referring to U.S. Pat. Nos. 5,464,738 and 5,496,695.

In addition, hydrazine derivatives preferably used are the compound H-1 to H-29 described in U.S. Pat. No. 5,545,505, columns 11 to 20 and the compounds 1 to 12 described in U.S. Pat. No. 5464738, columns 9 to 11. These hydrazine derivatives can be synthesized by known methods.

Next, formula (VI) is explained. In formula (VI), although X and R are displayed in a cis form, a trans form for X and R is also included in formula (VI). This is also similar to the structure display of specific compounds.

In formula (VI), X represents an electron-attracting group, and W represents a hydrogen atom, an alkyl group, an alkenyl group, an alkynyl group, an aryl group, a heterocyclic group, a halogen atom, an acyl group, a thioacyl group, an oxalyl group, an oxyoxalyl group, a thiooxalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfinyl group, a thiosulfinyl group, a sulfinamoyl group, a phosphoryl group, a nitro group, an imino group, a N-carbonylimino group, a N-sulfonylimino group, a dicyanoethylene group, an ammonium group, a sulfonium group, a phosphonium group, a pyrylium group or an immonium group.

R represents a halogen atom, a hydroxyl group, an alkoxy group, an aryloxy group, a heterocyclic oxy group, an alkenyloxy group, an acyloxy group, an alkoxycarbonyloxy group, an aminocarbonyloxy group, a mercapto group, an alkylthio group, an arylthio group, a heterocyclic thio group, an alkenylthio group, an acylthio group, an alkoxycarbonylthio group, an aminocarbonylthio group, an organic or inorganic salt of hydroxy group or mercapto group (e.g., a sodium salt, a potassium salt, a silver salt and the like), an amino group, an alkylamino group, a cyclic amino group (e.g., a pyrrolidino group and the like), an acylamino group, an oxycarbonylamino group, a heterocyclic group (a 5 to 6 membered nitrogen containing heterocycle, e.g., a benzotriazolyl group, an imidazolyl group, a triazolyl group, a tetrazolyl group and the like), an ureido group and a sulfonamido group. X and W, and X and R may bind each other to form a cyclic structure. As the ring formed by X and W, for example, pyrazolone, pyrazolidinone, cyclopentanedione, β-ketolactone, β-ketolactam and the like are described.

Explaining formula (VI) further, the electron-attracting group represented by X is a substituent which can have a positive value of substitution constant σ p. Specifically, a substituted alkyl group (halogen substituted alkyl and the like), a substituted alkenyl group (cyanovinyl and the like), a substituted or unsubstituted alkynyl group (trifluoromethylacetylenyl, cyanoacetylenyl and the like), a substituted aryl group (cyanophenyl and the like), a substituted or unsubstituted heterocyclic group (pyridyl, triazinyl, benzoxazolyl and the like), a halogen atom, a cyano group, an acyl group (acetyl, trifluoroacetyl, formyl and the like), a thioacetyl group (thioacetyl, thioformyl and the like), an oxalyl group (methyloxalyl and the like), an oxyoxalyl group (ethoxalyl and the like), a thiooxalyl group (ethylthiooxalyl and the like), an oxamoyl group (methyloxamoyl and the like), an oxycarbonyl group (ethoxycarbonyl and the like), a carboxyl group, a thiocarbonyl group (ethylthiocarbonyl and the like), a carbamoyl group, a thiocarbamoyl group, a sulfonyl group, a sulfinyl group, an oxysulfonyl group (ethoxysulfonyl and the like), a thiosulfonyl group (ethylthiosulfonyl and the like), a sulfamoyl group, an oxysulfinyl group (methoxysulfinyl and the like), a thiosulfinyl group (methylthiosulfinyl and the like), a sulfinamoyl group, a phosphoryl group, a nitro group, an imino group, a N-carbonylimino group (N-acetylimino and the like), a N-sulfonylimino group (N-methanesulfonylimino and the like), a dicyanoethylene group, an ammonium group, a sulfonium group, a phosphonium group, a pyrylium group, an immonium group and the like are described, and a heterocyclic one formed by an ammonium group, a sulfonium group, a phosphonium group, an immonium group or the like is also included. The substituent having σ p value of 0.30 or more is particularly preferable.

As an alkyl group represented as W, methyl, ethyl, trifluoromethyl and the like are described and as an alkenyl group, vinyl, halogen substituted vinyl, cyanovinyl and the like are described and as an aryl group, nitrophenyl, cyanophenyl, pentafluorophenyl and the like are described and as a heterocyclic group, pyridyl, pyrimidyl, triazinyl, succinimido, tetrazolyl, triazolyl, imidazolyl, benzimidazolyl and the like are described. As W, the electron attractive group having a positive σ p value is preferable and that value preferably is 0.30 or more.

Among the substituents of R described above, a hydroxy group, a mercapto group, an alkoxy group, an alkylthio group, a halogen atom, an organic or inorganic salt of hydroxy group or mercapto group, and a heterocyclic group are preferably described, more preferably a hydroxy group, an alkoxy group, an organic or inorganic salt of hydroxyl group or mercapto group and a heterocyclic group are described, and particularly preferably a hydroxy group and an organic or inorganic salt of hydroxy group or mercapto group are described.

And among the substituents of X and W described above, the group having a thioether bond in the substituent is preferable.

As specific examples of the compound represented by formula (VI), compound 1-1 to 92-7 of chemical formula Nos. 27 to 50 described in JP-A No. 2002-131864 are described, however specific examples are not limited in these.

In formula (P), Q represents a nitrogen atom or a phosphor atom. R₁, R₂, R₃ and R₄ each represent a hydrogen atom or a substituent, and X⁻ represents an anion. And R₁ to R₄ may bind each other to form a ring.

As the substituent represented by R₁ to R₄, an alkyl group (a methyl group, an ethyl group, a propyl group, a butyl group, a hexyl group, a cyclohexyl group and the like), an alkenyl group (an allyl group, a butenyl group and the like), an alkynyl group (a propargyl group, a butynyl group and the like), an aryl group (a phenyl group, a naphthyl group and the like), a heterocyclic group (a piperidinyl group, a piperazinyl group, a morpholinyl group, a pyridyl group, a furyl group, a thienyl group, a tetrahydrofuryl group, a tetrahydrothienyl group, a sulforanyl group and the like), an amino group and the like are described.

As the ring formed by binding R₁ to R₄ each other, a piperidine ring, a morpholine ring, a piperazine ring, a quinuclidine ring, a pyridine ring, a pyrrole ring, an imidazole ring, a triazole ring, a tetrazole ring and the like are described.

The group represented by R₁ to R₄ may have a substituent such as a hydroxy group, an alkoxy group, an aryloxy group, a carboxyl group, a sulfo group, an alkyl group, an aryl group and the like. R₁, R₂, R₃ and R₄ preferably are a hydrogen atom and an alkyl group.

As the anion represented by X⁻, an organic or inorganic anion such as a halogen ion, a sulfate ion, a nitrate ion, an acetate ion, a p-toluenesulfonate ion and the like are described.

As a structure of formula (P), the structure described in paragraph Nos. 0153 to 0163 in JP-A No. 2002-131864 is still more preferable.

As the specific compounds of formula (P), P-1 to P-52 and T-1 to T-18 of chemical formula Nos. 53 to 62 in JP-A No. 2002-131864 can be described, however the specific compound is not limited in these.

The quaternary onium compound described above can be synthesized by referring to known methods. For example, the tetrazolium compound described above can be synthesized by referring to the method described in Chemical Reviews, vol. 55, pages 335 to 483.

Next, the compounds represented by formulae (A) and (B) are explained in detail. In formula (A), Z₁ represents a nonmetallic atomic group capable to form a 5 to 7 membered ring structure with —Y₁—C(═CH—X₁)—C(═O)—. Z₁, preferably is an atomic group selected from a carbon atom, an oxygen atom, a sulfur atom, a nitrogen atom and a hydrogen atom, and several atoms selected from these are bound each other by single bond or double bond to form a 5 to 7 membered ring structure with —Y₁—C(═CH—X₁)—C(═O)—. Z₁ may have a substituent, and Z₁ itself may be an aromatic or a non-aromatic carbon ring, or Z₁ may be a part of an aromatic or a non-aromatic heterocycle, and in this case, a 5 to γ membered ring structure formed by Z₁ with —Y₁—C(═CH—X₁)—C(═O)— forms a condensed ring structure.

In formula (B), Z₂ represents a nonmetallic atomic group capable to form a 5 to 7 membered ring structure with —Y₂—C(═CH—X₂)—C(Y₃)═N—. Z₂ preferably is an atomic group selected from a carbon atom, an oxygen atom, a sulfur atom, a nitrogen atom and a hydrogen atom, and several atoms selected from these are bound each other by single bond or double bond to form a 5 to 7 membered ring structure with —Y₂—C(═CH—X₂)—C(Y₃)═N—. Z₂ may have a substituent, and Z₂ itself may be an aromatic or a non-aromatic carbon ring, or Z₂ may be a part of an aromatic or a non-aromatic heterocycle and in this case, a 5 to 7 membered ring structure formed by Z₂ with —Y₂—C(═CH—X₂)—C(Y₃)═N— forms a condensed ring structure.

In the case where Z1 and Z₂ have a substituent, examples of substituent are selected from the compounds described below. Namely, as typical substituent, for example, a halogen atom (fluorine atom, chlorine atom, bromine atom or iodine atom), an alkyl group (includes an aralkyl group, a cycloalkyl group and an active methylene group), an alkenyl group, an alkynyl group, an aryl group, a heterocyclic group, a heterocyclic group containing a quaternary nitrogen (e.g., a pyridinio group), an acyl group, an alkoxycarbonyl group, an aryloxycarbonyl group, a carbamoyl group, a carboxy group or a salt thereof, a sulfonylcarbamoyl group, an acylcarbamoyl groyp, a sulfamoylcarbamoyl group, a carbazoyl group, an oxalyl group, an oxamoyl group, a cyano group, a thiocarbamoyl group, a hydroxy group, an alkoxy group (includes the group in which an ethylene oxy group or a propylene oxy group unit are repeated), an aryloxy group, a heterocyclic oxy group, an acyloxy group, an alkoxy carbonyloxy group, an aryloxy carbonyloxy group, a carbamoyloxy group, a sulfonyloxy group, an amino group, an alkylamino group, an arylamino group, a heterocyclic amino group, a N-substituted nitrogen containing heterocyclic group, an acylamino group, a sulfonamido group, an ureido group, a thioureido group, an imido group, an alkoxycarbonylamino group, an aryloxycarbonylamino group, a sulfamoylamino group, a semicarbazide group, a thiosemicarbazide group, a hydrazino group, a quaternary ammonio group, an oxamoylamino group, an alkylsulfonylureido group, an arylsulfonylureido group, an acylureido group, an acylsulfamoylamino group, a nitro group, a mercapto group, an alkylthio group, an arylthio group, a heterocyclic thio group, an alkylsulfonyl group, an arylsulfonyl group, a sulfo group or a salt thereof, a sulfamoyl group, an acylsulfamoyl group, a sulfonylsulfamoyl group or a salt thereof, a group containing phosphoric amido or phosphoric ester structure, a silyl group, a stannyl group and the like are described. These substituents may be further substituted by these substituents.

Next, Y₃ is explained. In formula (B), Y₃ represents a hydrogen atom or a substituent, and when Y₃ represents a substituent, following group is specifically described as that substituent. Namely, an alkyl group, an aryl group, a heterocyclic group, a cyano group, an acyl group, an alkoxycarbonyl group, an aryloxycarbonyl group, a carbamoyl group, an amino group, an alkylamino group, an arylamino group, a heterocyclic amino group, an acylamino group, a sulfonamido group, an ureido group, a thioureido group, an imido group, an alkoxy group, an aryloxy group, an alkylthio group, an arylthio group, a heterocyclic thio group and the like are described. These substituents may be substituted by any substituents, and specifically, examples of the substituents which Z₁ or Z₂ may have, are described.

In formulae (A) and (B), X₁ and X₂ each represent a hydroxy group (or a salt thereof), an alkoxy group (e.g., a methoxy group, an ethoxy group, a propoxy group, an isopropoxy group, an octyloxy group, a dodecyloxy group, a cetyloxy group, a t-buthoxy group and the like), an aryloxy group (e.g., a phenoxy group, a p-t-pentylphenoxy group, a p-t-octylphenoxy group and the like), a heterocyclic oxy group (e.g., a benzotriazolyl-5-oxy group, a pyridinyl-3-oxy group and the like), a mercapto group (or a salt thereof), an alkylthio group (e.g., methylthio group, an ethlythio group, a butylthio group, a dodecylthio group and the like), an arylthio group (e.g., a phenylthio group, a p-dodecylphenylthio group and the like), a heterocyclic thio group (e.g., a 1-phenyltetrazoyl-5-thio group, a 2-methyl-1-phenyltriazolyl-5-thio group, a mercaptothiadiazolylthio group and the like), an amino group, an alkylamino group (e.g., a methylamino group, a propylamino group, an octylamino group, a dimethylamino group and the like), an arylamino group (e.g., an anilino group, a naphthylamino group, an o-methoxyanilino group and the like), a heterocyclic amino group (e.g., a pyridylamino group, a benzotriazole-5-ylamino group and the like), an acylamino group (e.g., an acetamido group, an octanoylamino group, a benzoylamino group and the like), a sulfonamido group (e.g., a methanesulfonamido group, a benzenesulfonamido group a dodecylsulfonamido group and the like) or a heterocyclic group.

Herein, a heterocyclic group is an aromatic or non-aromatic, a saturated or unsaturated, a single ring or condensed ring, or a substituted or unsubstituted heterocyclic group. For example, a N-methylhydantoyl group, a N-phenylhydantoyl group, a succinimido group, a phthalimido group, a N,N′-dimethylurazolyl group, an imidazolyl group, a benzotriazolyl group, an indazolyl group, a morpholino group, a 4,4-dimethyl-2,5-dioxo-oxazolyl group and the like are described.

And herein, a salt represents a salt of an alkali metal (sodium, potassium and lithium) or a salt of an alkali earth metal (magnesium and calcium), a silver salt or a quaternary ammonium salt (a tetraethylammonium salt, a dimethylcetylbenzylammonium salt and the like), a quaternary phosphonium salt and the like. In formulae (A) and (B), Y₁ and Y₂ represent —C(═O)— or —SO₂—.

The preferable range of the compound represented by formulae (A) and (B) is described in JP-A No. 11-231459, paragraph Nos. 0027 to 0043. As specific examples of the compound represented by formulae (A) and (B), compound 1 to 110 of Table 1 to 8 in JP-A No. 11-231459 are described, however the invention is not limited in these.

Next, the compound represented by formula (C) is explained in detail. In formula (C), X₁ represents an oxygen atom, a sulfur atom and a nitrogen atom. In the case where X₁ is a nitrogen atom, the bond of X₁ and Z₁ may be either a single bond or a double bond, and in the case of a single bond, a nitrogen atom may have a hydrogen atom or any substituent. As this substituent, for example, an alkyl group (includes an aralkyl group, a cycloalkyl group, an active methylene group and the like), an alkenyl group, an alkynyl group, an aryl group, a heterocyclic group, an acyl group, an alkoxycarbonyl group, an aryloxycarbonyl group, a carbamoyl group, an alkylsulfonyl group, an arylsulfonyl group, a heterocyclic sulfonyl group and the like are described. Y. represents the group represented by —C(═O)—, —C(═S)—, —SO—, —SO₂—, —C(═NR₃)— and —(R₄)C═N—. Z₁ represents a nonmetallic atomic group capable to form a 5 to 7 membered ring containing X₁ and Y₁. The atomic group to form that ring is an atomic group which consists of 2 to 4 atoms that are other than metal atoms, and these atoms may be combined by single bond or double bond, and these may have a hydrogen atom or any subsituent (e.g., an alkyl group, an aryl group, a heterocyclic group, an alkoxy group, an alkylthio group, an acyl group, an amino group or an alkenyl group). When Z₁ forms a 5 to 7 membered ring containing X₁ and Y₁, the ring is a saturated or unsaturated heterocyclic ring, and may be a single ring or may have a condensed ring. When Y₁ is the group represented by C(═NR₃), (R₄)C═N, the condensed ring of this case may be formed by binding R₃ or R₄ with the substituent of Z₁.

In formula (C), R₁, R₂, R₃ and R₄ each represent a hydrogen atom or a substituent. However, R₁ and R₂ do not bind each other to form a ring structure.

When R₁ and R₂ represent a monovalent substituent, the following groups are described as a monovalent substituent.

For example, a halogen atom (fluorine atom, chlorine atom, bromine atom or iodine atom), an alkyl group (an aralkyl group, a cycloalkyl group, an active methylene group and the like), an alkenyl group, an alkynyl group, an aryl group, a heterocyclic group, a heterocyclic group containing a quaternary nitrogen (e.g., a pyridinio group), an acyl group, an alkoxycarbonyl group, an aryloxycarbonyl group, a carbamoyl group, a carboxy group and a salt thereof, a sulfonylcarbamoyl group, an acylcarbamoyl group, a sulfamoylcarbamoyl group, a carbazoyl group, an oxalyl group, an oxamoyl group, a cyano group, a thiocarbamoyl group, a hydroxy group and a salt thereof, an alkoxy group (includes the group in which an ethylene oxy group or a propylene oxy group unit are repeated), an aryloxy group, a heterocyclic oxy group, an acyloxy group, an alkoxy carbonyloxy group, an aryloxycarbonyloxy group, a carbamoyloxy group, a sulfonyloxy group, an amino group, an alkylamino group, an arylamino group, an heterocyclic amino group, a N-substituted nitrogen containing heterocyclic group, an acylamino group, a sulfonamido group, an ureido group, a thioureido group, an imido group, an alkoxycarbonylamino group, an aryloxycarbonylamino group, a sulfamoylamino group, a semicarbazide group, a thiosemicarbazide group, a hydrazino group, a quaternary ammonio group, an oxamoylamino group, an alkylsulfonylureido group, an arylsulfonylureido group, an acylureido group, an acylsulfamoylamino group, a nitro group, a mercapto group and a salt thereof, an alkylthio group, an arylthio group, an heterocyclic thio group, an alkylsulfonyl group, an arylsulfonyl group, an alkylsulfinyl group, an arylsulfinyl group, a sulfo group and a salt thereof, a sulfamoyl group, an acylsulfamoyl group, a sulfonylsulfamoyl group and a salt thereof, a phosphoryl group, a group containing phosphoric amido or phosphoric ester structure, a silyl group, a stannyl group and the like are described. These substituents may be further substituted by these monovalent substituents.

When R₃ and R₄ represent a substituent, the same substituent as what R₁ and R₂ may have except the halogen atom can be described as a substituent. Furthermore, R₃ and R₄ may connect to Z₁ to form a condensed ring.

Next, among the compounds represented by formula (C), preferable compounds are described. In formula (C), Z₁ preferably is an atomic group which forms a 5 to 7 membered ring with X₁ and Y₁, and consists of the atoms selected from 2 to 4 carbon atoms, a nitrogen atom, a sulfur atom and an oxygen atom. A heterocycle which Z₁ forms with X₁ and Y₁ preferably contains 3 to 40 carbon atoms in total, more preferably 3 to 25 carbon atoms in total, and most preferably 3 to 20 carbon atoms in total. Z₁ preferably comprises at least one carbon atom.

In formula (C), Y₁ is preferably —C(═O)—, —C(═S)—, —SO₂— or —(R₄)C═N—, particularly preferably —C(═O)—, —C(═S)— or —SO₂—, and most preferably —C(═O)—.

In formula (C), in the case where R₁ and R₂ represent a monovalent substituent, the monovalent substituent represented by R₁ and R₂ preferably is the following group having 0 to 25 carbon atoms in total, namely, that is an alkyl group, an aryl group, a heterocyclic group, an alkoxy group, an aryloxy group, a heterocyclic oxy group, an alkylthio group, an arylthio group, a heterocyclic thio group, an amino group, an alkylamino group, an arylamino group, a heterocyclic amino group, an ureido group, an imido group, an acylamino group, a hydroxy group or a salt thereof, a mercapto group or a salt thereof, or an electron-attracting group. Herein, an electron-attracting group means the substituent capable to have a positive value of Hammett substituent constant σp, and specifically a cyano group, a sulfamoyl group, an alkylsulfonyl group, an arylsulfonyl group, a sulfonamido group, an imino group, a nitro group, a halogen atom, an acyl group, a formyl group, a phosphoryl group, a carboxy group (or a salt thereof), a sulfo group (or a salt thereof), a saturated or unsaturated heterocyclic group, an alkenyl group, an alkynyl group, an acyloxy group, an acylthio group, a sulfonyloxy group or an aryl group substituted by these electron-attracting group are described. These substituents may have any substituents.

In formula (C), when R₁ and R₂ represent a monovalent substituent, more preferable are an alkoxy group, an aryloxy group, a heterocyclic oxy group, an alkylthio group, an arylthio group, a heterocyclic thio group, an amino group, an alkylamino group, an arylamino group, a heterocyclic amino group, an ureido group, an imido group, an acylamino group, a sulfonamido group, a heterocyclic group, a hydroxy group or a salt thereof, a mercapto group or a salt thereof, or the like. In formula (C), R₁ and R₂ particularly preferably are a hydrogen atom, an alkoxy group, an aryloxy group, an alkylthio group, an arylthio group, a heterocyclic group, a hydroxy group or a salt thereof, a mercapto group or a salt thereof, or the like. In formula (C), most preferably, one of R₁ and R₂ is a hydrogen atom and another is an alkoxy group, an aryloxy group, an alkylthio group, an arylthio group, a heterocyclic group, a hydroxy group or a salt thereof, or a mercapto group or a salt thereof.

In formula (C), when R₃ represents a substituent, an alkyl group having 1 to 25 carbon atoms in total (includes an aralkyl group, a cycloalkyl group, an active methylene group and the like), an alkenyl group, aryl group, a heterocyclic group, a heterocyclic group containing a quaternary nitrogen (e.g., a pyridinio group), an acyl group, an alkoxycarbonyl group, an aryloxycarbonyl group, a carbamoyl group, an alkylsulfonyl group, an arylsulfonyl group, an alkylsulfinyl group, an arylsulfinyl group, a sulfosulfamoyl group, an alkoxy group, an aryloxy group, a heterocyclic oxy group, an alkylthio group, an arylthio group, a heterocyclic thio group, an amino group and the like can preferably be described. An alkyl group and an aryl group are particularly preferable.

In formula (C), when R₄ represents a substituent, an alkyl group having 1 to 25 carbon atoms in total (includes an aralkyl group, a cycloalkyl group, an active methylene group and the like), an aryl group, a heterocyclic group, a heterocyclic group containing a quaternary nitrogen (e.g., a pyridinio group), an acyl group, an alkoxycarbonyl group, an aryloxycarbonyl group, a carbamoyl group, an alkylsulfonyl group, an arylsulfonyl group, an alkylsulfinyl group, an arylsulfinyl group, a sulfosulfamoyl group, an alkoxy group, an aryloxy group, a heterocyclic oxy group, an alkylthio group, an arylthio group, a heterocyclic thio group and the like are preferably used. Particularly preferably, an alkyl group, an aryl group, an alkoxy group, an aryloxy group, a heterocyclic oxy group, an alkylthio group, an arylthio group, a heterocyclic thio group and the like are described. When Y₁ represents C(R₄)═N, the carbon atom in Y₁ binds with the carbon atom substituted by X₁ or Y₁.

Specific compounds represented by formula (C) are represented by A-1 to A-230 of chemical formula Nos. 6 to 18 described in JP-A No. 11-133546, however the invention is not limited in these.

The nucleator described above may be incorporated into photothermographic material by being added into the coating solution, such as in the form of a solution, an emulsion dispersion, a solid fine particle dispersion, and the like.

As well known emulsion dispersing method, there can be mentioned a method comprising dissolving the nucleator in an oil such as dibutylphthalate, tricresylphosphate, dioctylsebacate, tri(2-ethylhexyl)phosphate and the like and an auxiliary solvent such as ethyl acetate and cyclohexanone, and then adding a surfactant such as sodium dodecylbenzenesulfonate, sodium oleil-N-methyltaurinate, sodium di(2-ethylhexyl)sulfosuccinate and the like; from which an emulsion dispersion is mechanically produced. During the process, for the purpose of controlling viscosity of oil droplet and refractive index, the addition of polymer such as α-methylstyrene oligomer, poly(t-butylacrylamide) or the like is preferable.

As solid particle dispersing method, there can be mentioned a method comprising dispersing the powder of the nucleator in a proper medium such as water, by means of ball mill, colloid mill, vibrating ball mill, sand mill, jet mill, roller mill, or ultrasonics, thereby obtaining solid dispersion. In this case, there can also be used a protective colloid (such as polyvinyl alcohol), or a surfactant (for instance, an anionic surfactant such as sodium triisopropylnaphthalenesulfonate (a mixture of compounds having the isopropyl groups in different substitution sites)). In the mills enumerated above, generally used as the dispersion media are beads made of zirconia and the like, and Zr and the like eluting from the beads may be incorporated in the dispersion. Although depending on the dispersing conditions, the amount of Zr and the like generally incorporated in the dispersion is in the range of from 1 ppm to 1000 ppm. It is practically acceptable so long as Zr is incorporated in an amount of 0.5 mg or less per 1 g of silver.

Preferably, a preservative (for instance, sodium benzoisothiazolinone salt) is added in the water dispersion.

The nucleator is particularly preferably used as solid particle dispersion, and is added in the form of fine particles having average particle size from 0.01 μm to 10 μm, preferably from 0.05 μm to 5 μm and, more preferably from 0.1 μm to 2 μm.

In the photosensitive material which is subjected to a rapid development where time period for development is 20 seconds or less, the compound represented by formulae (V) and (P) is used preferably, and the compound represented by formula (V) is used particularly preferably, among the nucleators described above.

In the photosensitive material where low fog is required, the compound represented by formula (VI) is used preferably, and the compound represented by formulae (A), (B) and (C) is more preferably used, and the compound represented by formulae (A) and (B) is most preferably used. Moreover, in the photosensitive materials having a few change of photographic property against environmental conditions when used on various environmental conditions (temperature and humidity), the compound represented by formula (C) is preferably used.

Although preferred specific compounds among the above-mentioned nucleators are shown below, the invention is not limited in these.

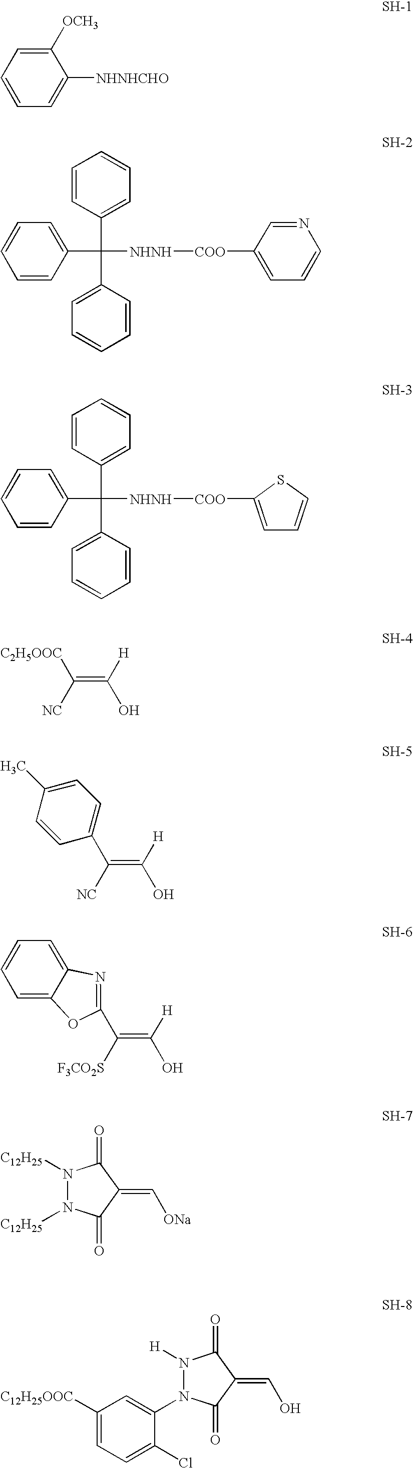

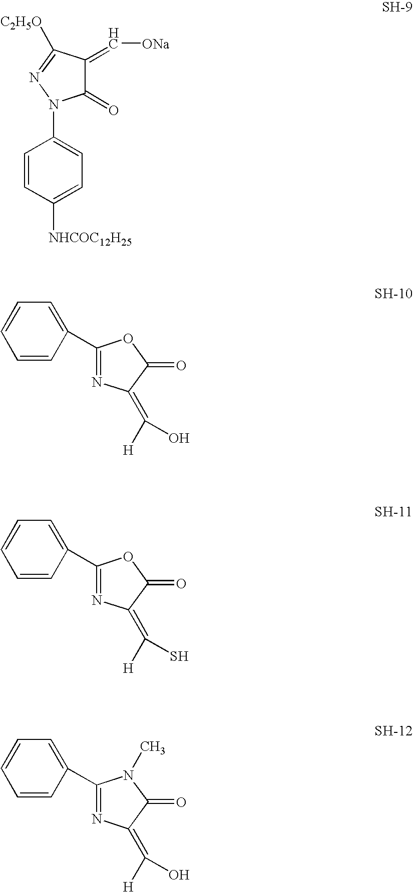

The nucleator of the present invention can be added to the image forming layer or the layer adjacent to the image forming layer, however, preferably to the image forming layer. The addition amount of nucleator is in a range of 10⁻⁵ mol to 1 mol per 1 mol of organic silver salt, and preferably, in a range of 10⁻⁴ mol to 5×10⁻¹ mol. The nucleator may be added either only one kind or, two or more kinds in combination.

In the photothermographic material of the present invention, the image forming layer containing photosensitive silver halide may be two or more layers and in the case where there are two or more layers, any image forming layer may contain the nucleator. It is preferred to have at least two image forming layers which one of them contains the nucleator and the other does not contain the nucleator.

2) Infectious Developing Reducing Agent

An infectious developing reducing agent is explained. “Infectious development” is a development mechanism generally known for wet development system, for example, is explained in “KAITEI SYASHIN KOUGAKU NO KISO— GINEN SYASHIN HEN” (NIPPON SYASHIN GAKKAI, edit, 1998, CORONA Co.), pages 339 to 341. “Infectious development” is a phenomenon which a more powerful reducing product is generated by the oxidation product of reducing agent generated by early development and accelerates a development.

The present inventors found out that in the thermal development of photothermographic material comprising, on at least one surface of a support, at least a photosensitive silver halide, a non-photosensitive organic silver salt, a reducing agent for silver ions and a binder, the photothermographic material having high sensitivity and high image quality in which the gradation of photographic characteristic curve of the image becomes two to four can be obtained by using infectious development reducing agent.

Furthermore, it is found out that the photothermographic material of the present invention having a value obtained by dividing a total coating amount of silver contained in the non-photosensitive organic silver salt and the photosensitive silver halide per unit of area by a number of the photosensitive silver halide grains per unit of area, is 5×10⁻¹⁴ g/grain or more can achieve high sensitivity and high image quality.

Furthermore, as a result of that a coating amount of silver of 2.0 g/m² or less and a maximum density of 2.5 or higher can be obtained, it is found out that higher sensitivity and high image quality can be obtained.

As the infectious development reducing agent used in the present invention, any reducing agent may be used as far as it has the ability of infectious development.

Preferable infectious development reducing agent used in the present invention is the compound represented by the following formula (R1).

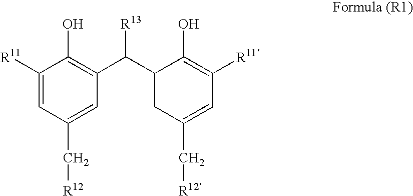

In formula (R1) described above, R¹¹ and R¹¹′ each independently represent a secondary or tertiary alkyl group having 3 to 20 carbon atoms. R¹² and R¹²′ each independently represent a hydrogen atom or the connecting group through a nitrogen, an oxygen, a phosphor or a sulfur atom. R¹³ represents a hydrogen atom or an alkyl group having 1 to 20 carbon atoms.

Formula (R1) described above is explained in detail. As R¹¹ and R¹¹′ described above, a secondary or tertiary alkyl group having 3 to 12 carbon atoms is preferable. Specifically, an isopropyl group, a tert-butyl group, a tert-amyl group, a 1,1-dimethylpropyl group, a 1,1-dimethylbutyl group, a 1,1-dimethylhexyl group, a 1,1-3,3-tetramethylbutyl group, a 1,1-dimethyldecyl group, a 1-methylcyclohexyl group, a tert-octyl group, a 1-methylcyclopropyl group and the like are preferable, and a tert-butyl group, a tert-amyl group, a tert-octyl group and a 1-methylcyclohexyl group are more preferable, and a tert-butyl group is most preferable.

In the case where R¹² and R¹²′ are an aryloxy group, an arylthio grpoup, an anilino group, a heterocyclic group and a heterocyclic thio group, these group may have a substituent. As the said substituent, although any group may be possible as far as it is capable of substituting for a hydrogen atom on a benzene ring and a heterocycle, and, an alkyl group, an aryl group, a heterocyclic group, a halogen atom, an alkoxy group, a hydroxy group, an aryloxy group, an alkylthio group, an arylthio group, an amino group, an acyl group, an acyloxy group, an acylamino group, an alkoxycarbonyl group, a carbamoyl group, a sulfonyl group, a sulfonamido group, a sulfonyloxy group, a sulfamoyl group, a sulfoxido group, an ureido group or an urethane group or the like are described. In the case where R¹² and R¹²′ are an alkoxy group, a carbonyloxy group, an acyloxy group, an alkylthio group, an amino group, an acylamino group, an ureido group or an urethane group, these groups may further have a substituent and as examples of the said substituent, an alkoxy group, an alkoxycarbonyl group, an acyloxy group, an sulfonyl group, a carbonyl group, an alkylthio group, an aryloxy group, an arylthio group, a sulfonamide group, an acylamino group and the like are described. As R¹² and R¹²′ described above, a hydrogen atom, a hydroxy group, an amino group or an anilino group is more preferable, and further, a hydrogen atom, a methoxy group or a benzyloxy group is most preferable.

As R¹³ described above, a hydrogen atom or an alkyl group having 1 to 15 carbon atoms is preferable, and an alkyl group having 1 to 8 carbon atoms is more preferable. As the said alkyl group, a methyl group, an ethyl group, a propyl group, an isopropyl group, or a 2,4,4-trimethylpenthyl group is preferable. As R¹³ described above, a hydrogen atom, a methyl group, an ethyl group, a propyl group or an isopropyl group is particularly preferable.

Typical examples of the reducing agent represented by formula (R1) of the present invention are shown below, however the present invention is not limited in these.

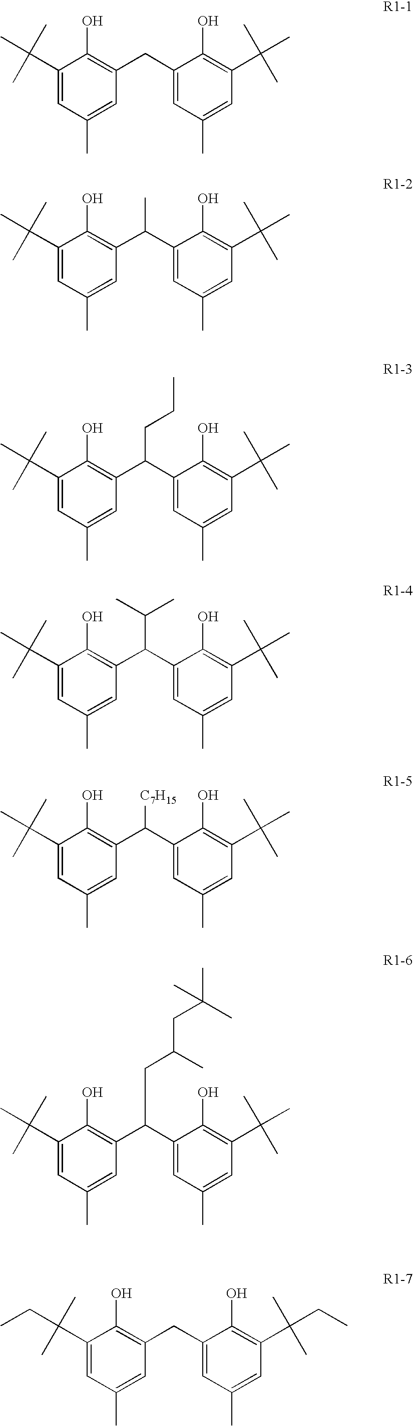

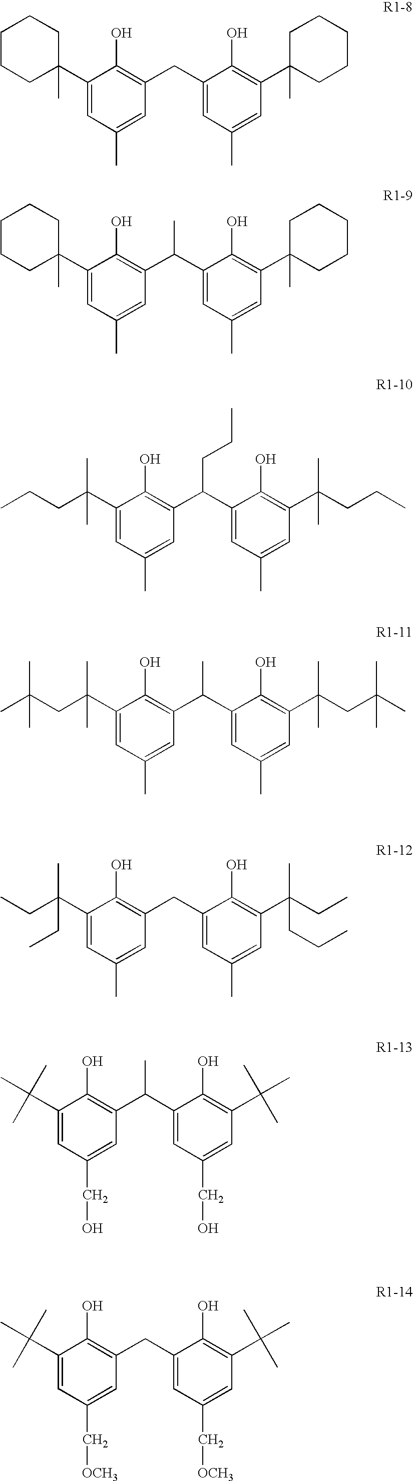

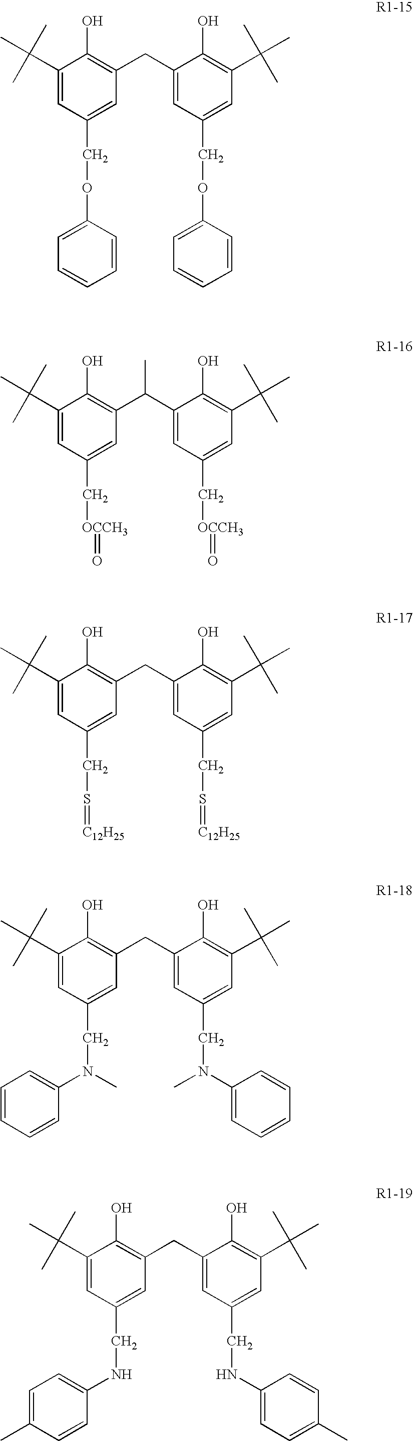

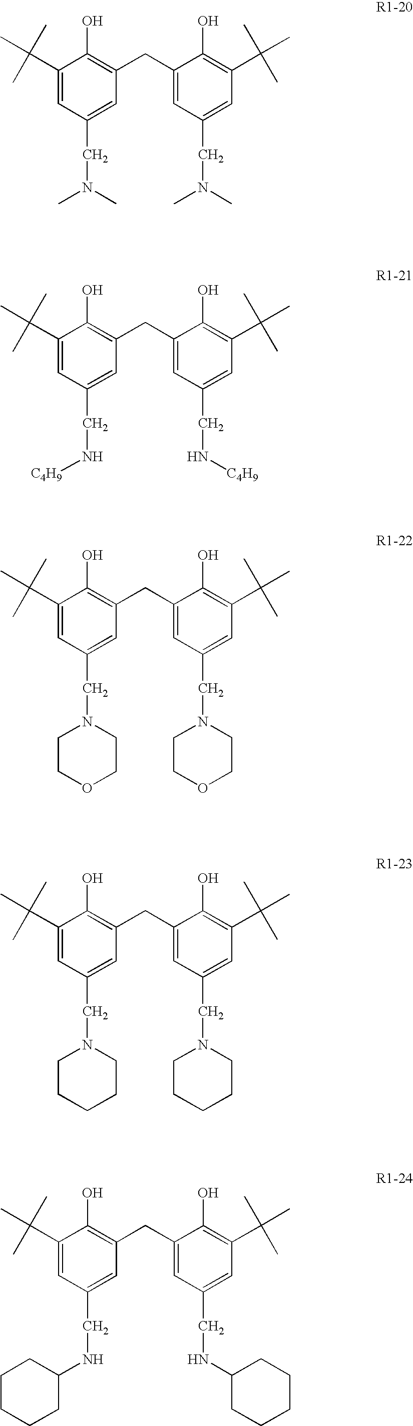

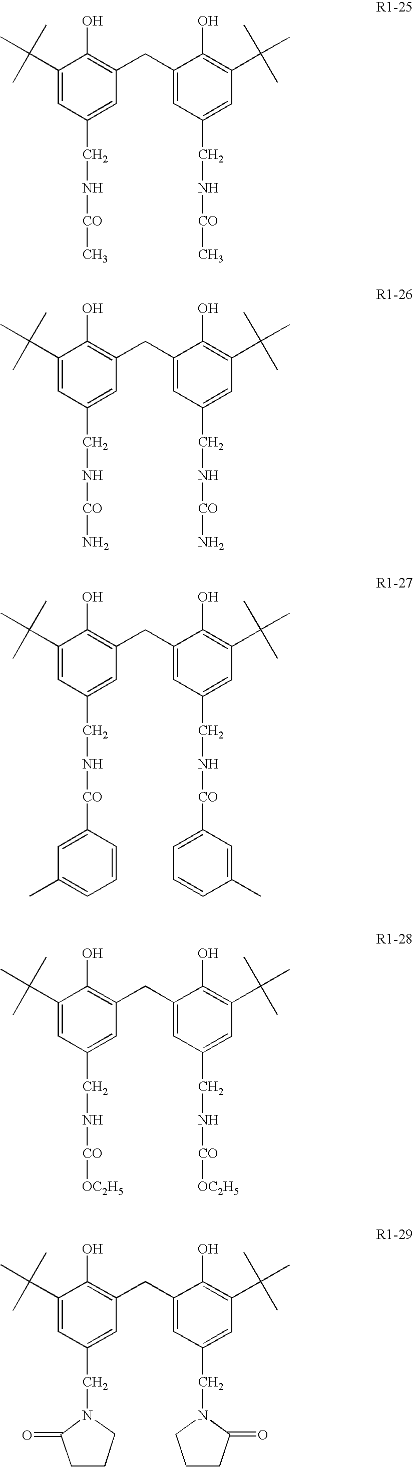

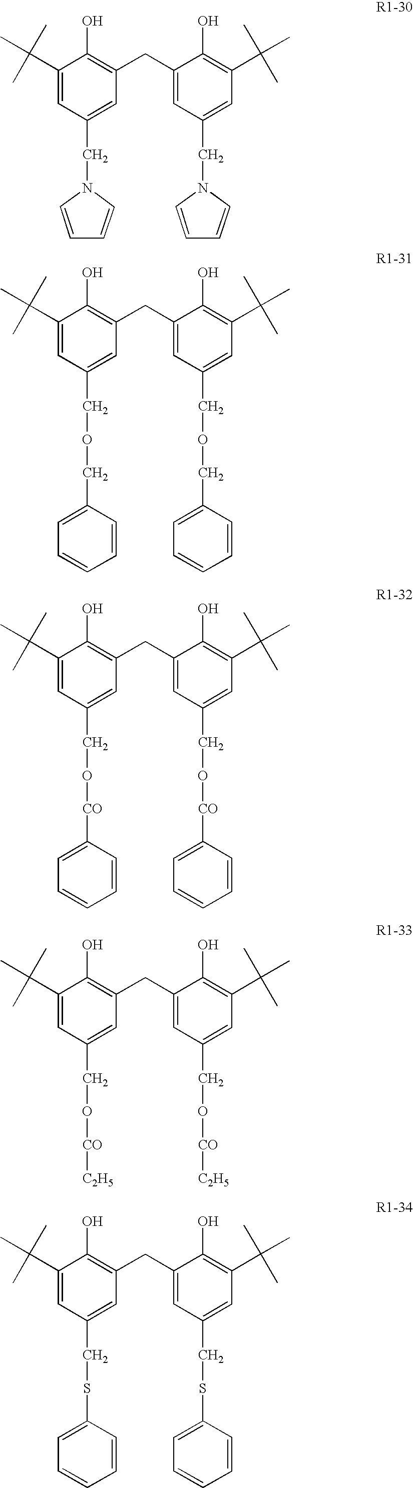

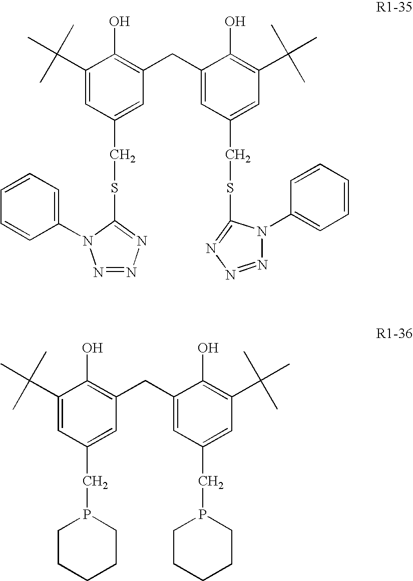

The addition amount of the reducing agent represented by the above-described formula (R1) is preferably from 0.01 g/m² to 5.0 g/m², and more preferably from 0.1 g/m² to 3.0 g/m². It is preferably contained in the range from 5 mol % to 50 mol % and, more preferably, 10 mol % to 40 mol %, per 1 mol of silver in the surface including the image forming layer. The reducing agent represented by the above-described formula (R1) is preferably contained in the image forming layer.

In the invention, other reducing agents may be used in combination with the reducing agent represented by formula (R1). The reducing agent which can be used in combination may be any substance (preferably, organic substance) capable of reducing silver ions into metallic silver. Examples of the reducing agent are described in JP-A No. 11-65021 (column Nos. 0043 to 0045) and EP No. 0803764 (p.7, line 34 to p. 18, line 12).

In the invention, the reducing agent which can be used in combination is preferably a so-called hindered phenolic reducing agent or a bisphenol agent having a substituent at the ortho-position to the phenolic hydroxy group.

In the case where plural reducing agents are used, the ratio of combination by mole is 1/99 to 99/1, and preferably 5/95 to 95/5.

The reducing agent of the invention can be added in the image forming layer which comprises an organic silver salt and a photosensitive silver halide, or in the layer adjacent to the image forming layer, but it is preferably contained in the image forming layer.

The reducing agent of the invention may be incorporated into photothermographic material by being added into the coating solution, such as in the form of a solution, an emulsion dispersion, a solid fine particle dispersion, and the like.

As a well known emulsion dispersing method, there can be mentioned a method comprising dissolving the reducing agent in an auxiliary solvent such as oil, for instance, dibutyl phthalate, tricresyl phosphate, glyceryl triacetate, diethyl phthalate, and the like, as well as ethyl acetate, cyclohexanone, and the like; from which an emulsion dispersion is mechanically produced.

As solid fine particle dispersing method, there can be mentioned a method comprising dispersing the reducing agent in a proper medium such as water, by means of ball mill, colloid mill, vibrating ball mill, sand mill, jet mill, roller mill, or ultrasonics, thereby obtaining solid dispersion. A dispersing method using a sand mill is preferable. There can also be used a protective colloid (such as polyvinyl alcohol), or a surfactant (for instance, an anionic surfactant such as sodium triisopropylnaphthalenesulfonate (a mixture of compounds having the three isopropyl groups in different substitution sites)). A preservative (for instance, sodium benzoisothiazolinone salt) can be added in the water dispersion.

In the invention, the reducing agent is particularly preferably used as a solid particle dispersion, and the reducing agent is added in the form of fine particles having average particle size from 0.01 μm to 10 μm, more preferably, from 0.05 μm to 5 μm and, further preferably, from 0.1 μm to 1 μm. In the invention, other solid dispersions are preferably used with this particle size range.

Specific examples of the reducing agent which can be used in combination in the invention are shown below, but the invention is not restricted to them.

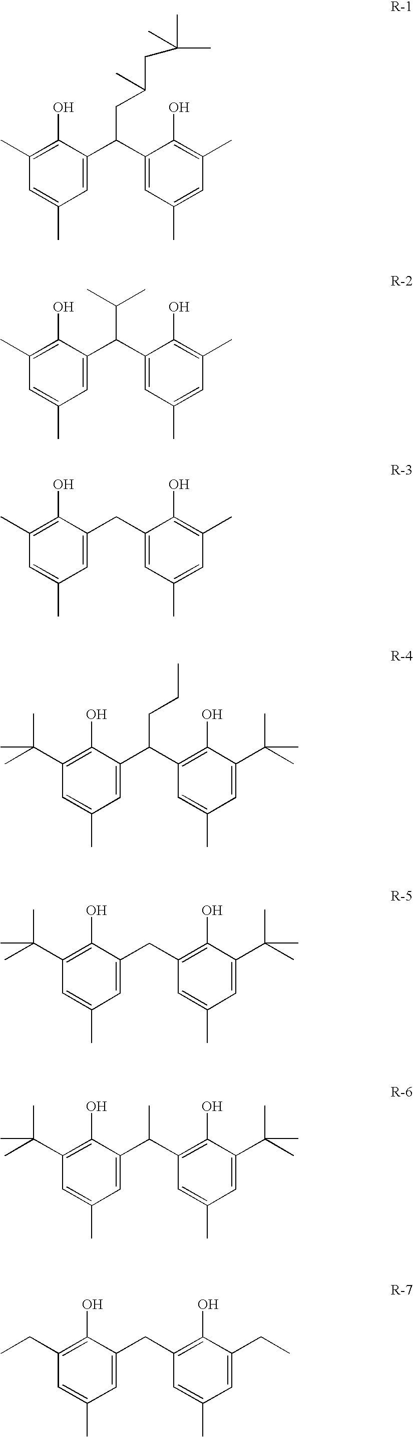

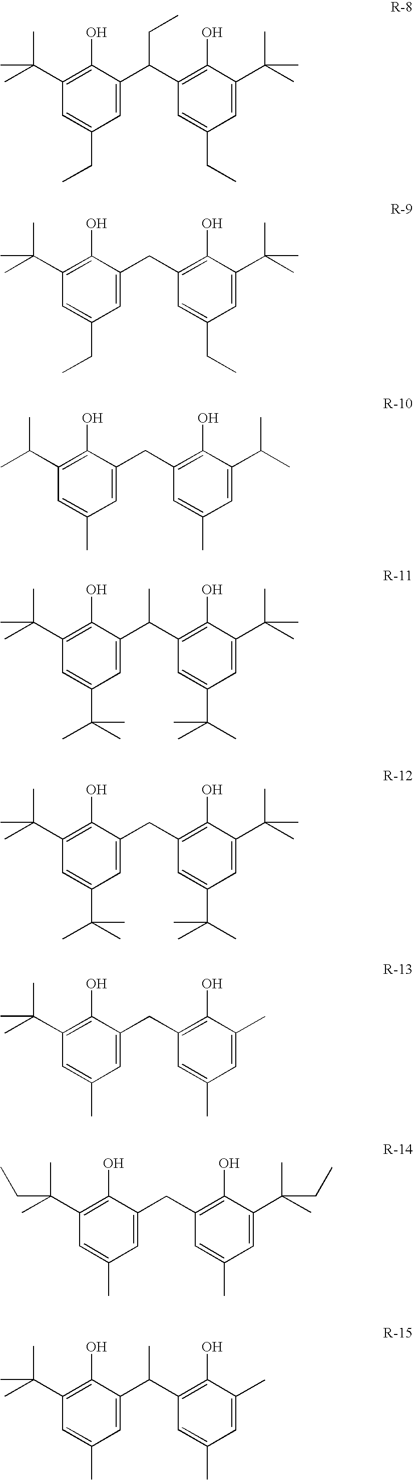

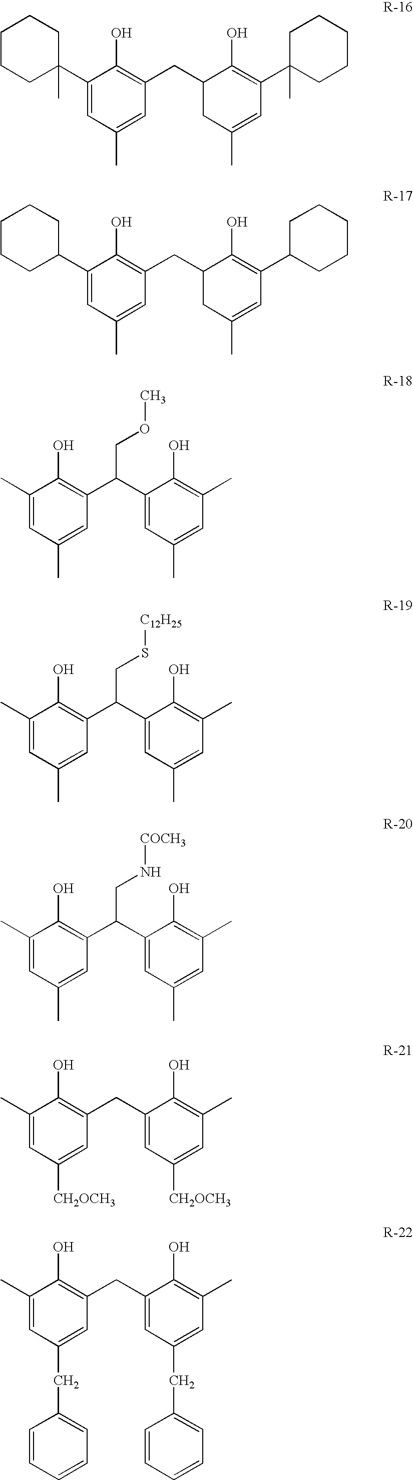

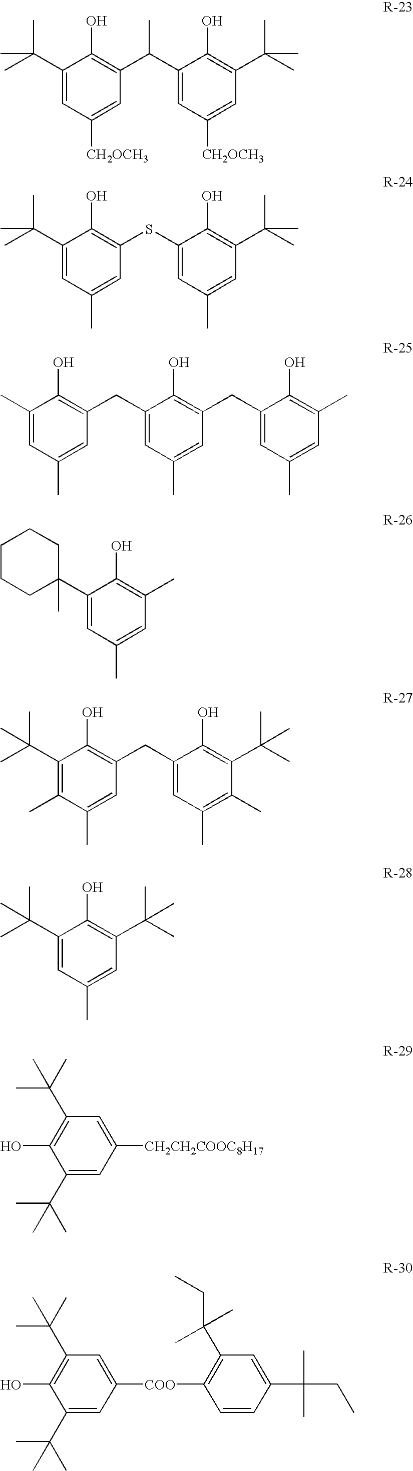

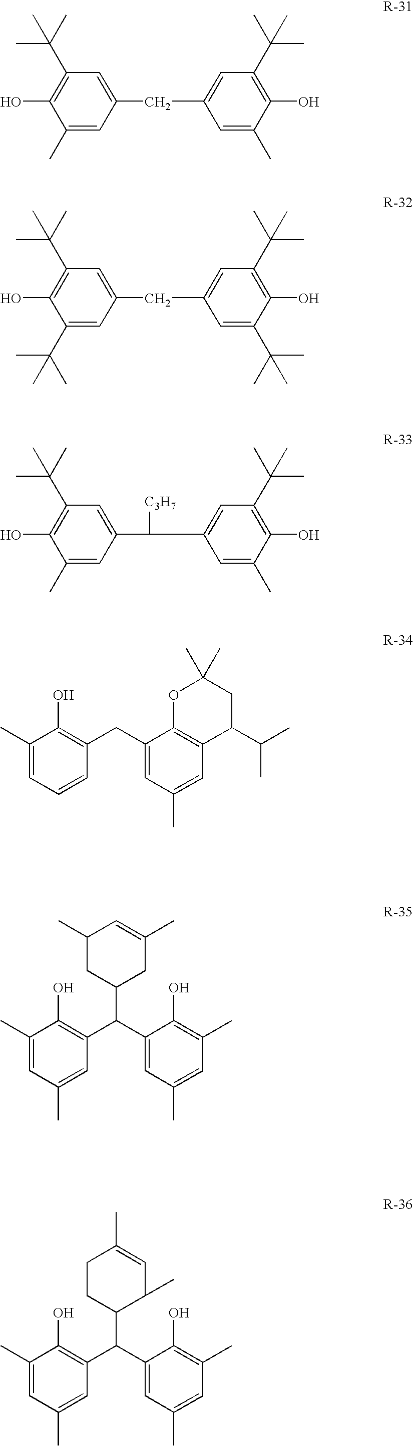

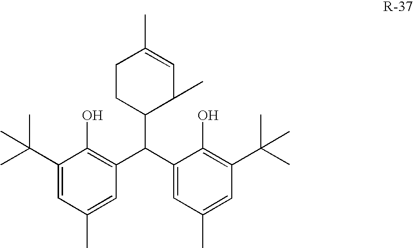

The addition amount of these reducing agents is, preferably, from 0.01 g/m² to 5.0 g/m² and, more preferably 0.1 g/m² to 3.0 g/m². It is, preferably, contained in a range of 5 mol % to 50 mol % and, more preferably, 10 mol % to 40 mol % per 1 mol of silver in the surface including the image forming layer.

These reducing agents can be added in the image forming layer which comprises an organic silver salt and a photosensitive silver halide, or in the layer adjacent to the image forming layer, but are preferably contained in the image forming layer.

These reducing agents may be incorporated into photothermographic material by being added into the coating solution, such as in the form of a solution, an emulsion dispersion, a solid fine particle dispersion, and the like, similar to the aforementioned infectious developing reducing agent. Preferable adding method and addition layer are also similar to those of the aforementioned infectious developing reducing agent.

(Silver Iodide Complex Forming Agent)

In the present invention, it is preferred that the photothermographic material contains the compound which practically reduces the visible absorption derived from photosensitive silver halide after thermal development against before thermal development.

In the present invention, it is particularly preferred that silver iodide complex forming agent is used as the compound which practically reduces visible absorption derived from photosensitive silver halide after thermal development.

As for the silver iodide complex forming agent according to the present invention, at least one of nitrogen atom or sulfur atom in the compound is possible to contribute to a Lewis acid-base reaction which gives an electron to a silver ion, as a ligand atom (electron donor: Lewis base). The stability of the complex is defined by successive stability constant or total stability constant, but it depends on the combination of silver ion, iodo ion and the silver complex forming agent. As a general guide, it is possible to obtain a big stability constant by chelate effect from intramolecular chelate ring formation, by means of increasing the acid-bace dissociation constant and the like.

The mechanism of silver iodide complex forming agent is not clearly elucidated, however it is presumed that the formation of stable complex consist of at least three-dimensional components comprising an iodide ion and a silver ion makes a silver iodide soluble. The silver iodide complex forming agent according to the present invention has poor ability to make silver bromide or silver chloride soluble, but reacts specifically to silver iodide.

The mechanism of improving the image stability by silver iodide complex forming agent according to the present invention is not clear, however it is presumed that at least a part of silver halide and silver iodide complex forming agent according to the present invention reacts during thermal development to form a complex and photosensitivity decreases or disappears, and the image stability under the light irradiation is particularly improved. Simultaneously, it is great characteristic to gain an image having a clear and high image quality as a result of decreasing turbidity of film caused by silver halide. Turbidity of film can be confirmed by a decrease of ultra violet-visible absorption in a spectral absorption spectrum.

In the present invention, ultra violet-visible absorption spectrum of photosensitive silver halide can be measured by the method of transmission or the method of reflection. When the absorption derived from other compounds added to the photothermographic material overlaps with the absorption of photosensitive silver halide, ultra violet-visible absorption spectrum of photosensitive silver halide can be observed by using, independently or in combination, the means of difference spectrum and removal of other compounds by solvent and the like.

What distinguish clearly the silver iodide complex forming agent according to the present invention from usual silver ion complex forming agent is that an iodo ion is indispensable to form a stable complex. As compared with usual silver ion complex forming agent that has a dissolution action to the salts containing silver ion such as silver bromide, silver chloride, or organic silver salt as such silver behenateand the like, the silver iodide complex forming agent according to the present invention has a big characteristic in that it does not act unless the silver iodide exists.

As a silver iodide complex forming agent according to the present invention, a 5 to 7 membered heterocyclic compound containing at least one nitrogen atom is preferable. In the case where the compound does not have a mercapto group, a sulfide group, or a thione group as a substituent, the said nitrogen containing 5 to 7 membered heterocycle may be saturated or unsaturated, and may have other substituent. The substituent on a heterocycle may bind each other to form a ring.

As preferable examples of 5 to 7 membered heterocyclic compounds, pyrrole, pyridine, oxazole, isoxazole, thiazole, isothiazole, imidazole, pyrazole, pyrazine, pyrimidine, pyridazine, indole, isoindole, indolizine, quinoline, isoquinoline, benzimidazole, 1H-imidazole, quinoxaline, quinazoline, cinnoline, phthalazine, naphthylizine, purine, pterizine, carbazole, acridine, phenanthoridine, phenanthroline, phenazine, phenoxazine, phenothiazine, benzothiazole, benzoxazole, benzimidazole, 1,2,4-triazine, 1,3,5-triazine, pyrrolidine, imidazolidine, pyrazolidine, piperidine, piperazine, morpholine, indoline, isoindoline and the like can be described. More preferably, pyridine, imidazole, pyrazole, pyrazine, pyrimidine, pyridazine, indole, isoindole, indolizine, quinoline, isoquinoline, benzimidazole, 1H-imidazole, quinoxaline, quinazoline, cinnoline, phthalazine, 1,8-naphthylizine, 1,10-phenanthroline, benzimidazole, benzotriazole, 1,2,4-triazine, 1,3,5-triazine and the like can be described. Particularly preferably, pyridine, imidazole, pyrazine, pyrimidine, pyridazine, phtharazine, triazine, 1,8-naphthylizine and 1,10-phenanthroline and the like can be described.

These rings may have a substituent and any substituent can be used as far as it does not show a bad influence to photographic property. As preferable examples, a halogen atom (fluorine atom, chlorine atom, bromine atom or iodine atom), an alkyl group (a straight, a branched, a cyclic alkyl group containing a bicycloalkyl group or an active methylene group), an alkenyl group, an alkynyl group, an aryl group, a heterocyclic group (substituted position is not asked), an acyl group, an alkoxycarbonyl group, an aryloxycarbonyl group, a heterocyclic oxycarbonyl group, a carbamoyl group, a N-acylcarbamoyl group, a N-sulfonylcarbamoyl group, a N-carbamoylcarbamoyl group, a N-sulfamoylcarbamoyl group, a carbazoyl group, a carboxy group and a salt thereof, an oxalyl group, an oxamoyl group, a cyano group, a carboimidoyl group, a formyl group, a hydroxy group, an alkoxy group (the group repeating ethylene oxy group units or propylene oxy group units is included), an aryloxy group, a heterocyclic oxy group, an acyloxy group, an alkoxycarbonyloxy group, an aryloxycarbonyloxy group, a carbamoyloxy group, a sulfonyloxy group, an amino group, an alkylamino group, an arylamino group, a heterocyclic amino group, an acylamino group, a sulfonamido group, an ureido group, a thioureido group, an imido group, an alkoxycarbonylamino group, an aryloxycarbonylamino group, a sulfamoylamino group, a semicarbazide group, an ammonio group, an oxamoylamino group, a N-alkylsulfonylureido group, a N-arylsulfonylureido group, a N-acylureido group, N-acylsulfamoylamino group, a nitro group, a heterocyclic group containing a quaternary nitrogen atom (e.g., a pyridinio group, an imidazolio group, a quinolinio group, an isoquinolinio group), an isocyano group, an imino group, an alkylsulfonyl group, an arylsulfonyl group, an alkylsulfinyl group, an arylsulfinyl group, a sulfo group and a salt thereof, a sulfamoyl group, a N-acylsulfamoyl group, a N-sulfonylsulfamoyl group and a salt thereof, a phosphino group, a phosphinyl group, a phosphinyloxy group, a phosphinylamino group, a silyl group and the like are described.

Here, an active methylene group means the methine group substituted by two electron-attracting groups, wherein the electron-attracting group means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, a carbonimidoyl group. Herein, two electron-attracting groups may bind each other to form a cyclic structure. And, the salt means a salt formed with positive ion such as an alkaline metal, an alkaline earth metal, a heavy metal or the like, or organic positive ion such as an ammonium ion, a phosphonium ion or the like. These substituents may be further substituted by these substituents.

These heterocycles may be further condensed by another ring. In the case where the substituent is an anion group (e.g., —CO₂⁻, —SO₃⁻, —S⁻ and the like), the heterocycle containing nitrogen atom of the invention may become a positive ion (e.g., pyridinium, 1,2,4-triazolium and the like) and may form an intramolecular salt.

In the case where a heterocyclic compound is pyridine, pyrazine, pyrimidine, pyridazine, phthalazine, triazine, naththilizine or phenanthroline derivative, the acid dissociation constant (pKa) of a conjugated acid of nitrogen containing heterocyclic part in acid dissociation equilibrium of the said compound preferably is 3 to 8 in the mixture solution of tetrahydrofuran/water (3/2) at 25° C., and more preferably, pKa is 4 to 7.

As the heterocyclic compound, pyridine, pyridazine or phtharazine derivative is preferable, and particularly preferable is pyridine or phthalazine derivative.

In the case where these heterocyclic compounds have a mercapto group, a sulfide group or a thione group as the substituent, pyridene, thiazole, isothiazole, oxazole, isoxazole, imidazole, pyrazole, pyrazine, pyrimidine, pyridazine, triazine, triazole, thiadiazole or oxadiazole derivatives are preferable, and thiazole, imidazole, pyrazole, pyrazine, pyrimidine, pyridazine, triazine, triazole derivatives are particularly preferable.

For example, as the said silver iodide complex forming agent, the compound represented by the following formulae (1) or (2) can be used.

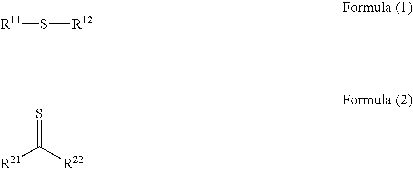

In formula (1), R¹¹ and R¹² represent a hydrogen atom or a substituent. In formula (2), R²¹ and R²² represent a hydrogen atom or a substituent. However, both of R¹¹ and R¹² are not hydrogen atoms together and both of R²¹ and R²² are not hydrogen atoms together. As the substituent herein, the substituent explained as the substituent of a 5 to 7 membered nitrogen containing heterocyclic type silver iodide complex forming agent mentioned above can be described.

Further, the compound represented by formula (3) described below can also be used preferably.

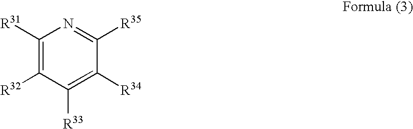

In formula (3), R³¹ to R³⁵ each independently represent a hydrogen atom or a substituent. As the substituent represented by R³¹ to R³⁵, the substituent of a 5 to 7 membered nitrogen containing heterocyclic type silver iodide complex forming agent mentioned above can be described. In the case where the compound represented by formula (3) has a substituent, preferred substituting position is R³² to R³⁴. R³¹ to R³⁵ may bind each other to form a saturated or an unsaturated ring. Preferred substituent is a halogen atom, an alkyl group, an aryl group, a carbamoyl group, a hydroxy group, an alkoxy group, an aryloxy group, a carbamoyloxy group, an amino group, an acylamino group, an ureido group, an alkoxycarbonylamino group, an aryloxycarbonylamino group and the like.

In the compound represented by formula (3), the acid dissociation constant (pKa) of conjugated acid of pyridine ring part preferably is 3 to 8 in the mixed solution of tetrahydrofuran/water (3/2) at 25° C., and particularly preferably 4 to 7.

Furthermore, the compound represented by formula (4) is also preferable.

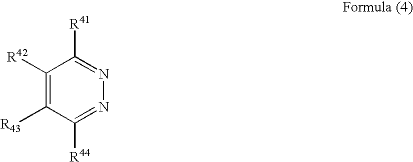

In formula (4), R⁴¹ to R⁴⁴ each independently represent a hydrogen atom or a substituent. R⁴¹ to R⁴⁴ may bind each other to form a saturated or an unsaturated ring. As the substituent represented by R⁴¹ to R⁴⁴, the substituent of a 5 to 7 membered nitrogen containing heterocyclic type silver iodide complex forming agent mentioned above can be described. As preferred group, an alkyl group, an alkenyl group, an alkynyl group, an aryl group, a hydroxy group, an alkoxy group, an aryloxy group a hetecyclic oxy group and a group which forms a phthalazine ring by benzo-condensation are described. In the case where a hydroxy group exists at the carbon atom adjacent to nitrogen atom of the compound represented by formula (4), there exists equilibrium between pyridazinone.

The compound represented by formula (4) more preferably forms a phthalazine ring represented by the following formula (5), and furthermore, this phthalazine ring particularly preferably has at least one subsutituent. As examples of R⁵¹ to R⁵⁶ in formula (5), the substituent of a 5 to 7 membered nitrogen containing heterocyclic type silver iodide complex forming agent mentioned above can be described. And as more preferable examples of the substituent, an alkyl group, an alkenyl group, an alkynyl group, an aryl group, a hydroxy group, an alkoxy group, an aryloxy group and the like are described. An alkyl group, an alkenyl group, an aryl group, an alkoxy group and an aryloxy group are preferable and an alkyl group, an alkoxy group and an aryloxy group are more preferable.

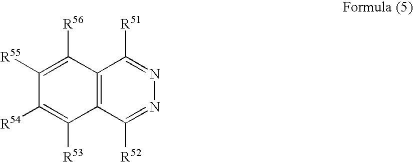

Further, the compound represented by formula (6) described below is also a preferable embodiment.

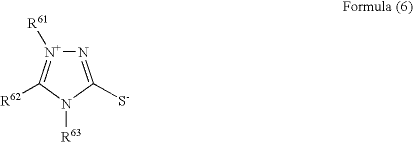

In formula (6), R⁶¹ to R⁶³ each independently represent a hydrogen atom or a substituent. As examples of the substituent represented by R⁶², the substituent of a 5 to 7 membered nitrogen containing heterocyclic type silver iodide complex forming agent mentioned above can be described.

As the compound preferably used, the compound represented by the following formula (7) is described.
R⁷¹—S—Lₙ—S—R⁷² Formula (7)

In formula (7), R⁷¹ and R⁷² each independently represent a hydrogen atom or a substituent. L represents a divalent connecting group. n represents 0 or 1. As the substituent represented by R⁷¹ and R⁷², an alkyl group (containing a cycloalkyl group), an alkenyl group (containing a cycloalkenyl group), an alkynyl group, an aryl group, a heterocyclic group, an acyl group, an aryloxycarbonyl group, an alkoxycarbonyl group, a carbamoyl group, an imido group and a complex substituent containing these groups are described as examples. A divalent group represented by L preferably has the length of 1 to 6 atoms and more preferably has the length of 1 to 3 atoms, and furthermore, may have a substituent.

One more of the compounds preferably used is a compound represented by formula (8).

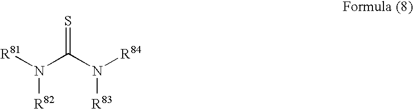

In formula (8), R⁸¹ to R⁸⁴ each independently represent a hydrogen atom or a substituent. As the substituent represented by R⁸¹ to R⁸⁴, an alkyl group (including a cycloalkyl group), an alkenyl group (including a cycloalkenyl group), an alkynyl group, an aryl group, a heterocyclic group, an acyl group, an aryloxycarbonyl group, an alkoxycarbonyl group, a carbamoyl group, an imido group and the like are described as examples.

Among the silver iodide complex forming agents described above, the compounds represented by formulae (3), (4), (5), (6) and (7) are preferable and, the compounds represented by formulae (3) and (5) are particularly preferable.

Preferable examples of silver iodide complex forming agent are described below, however the present invention is not limited in these.

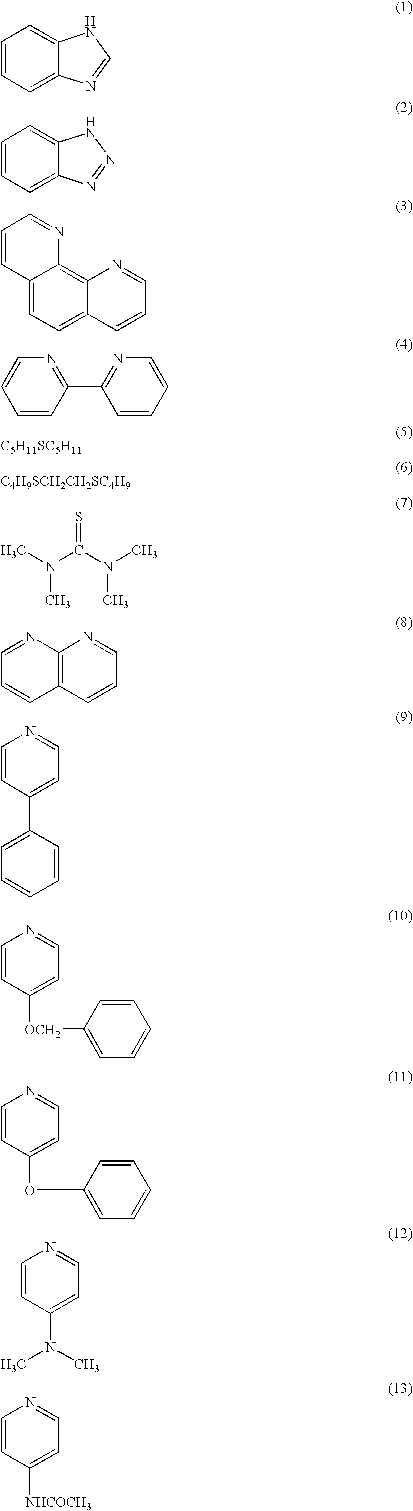

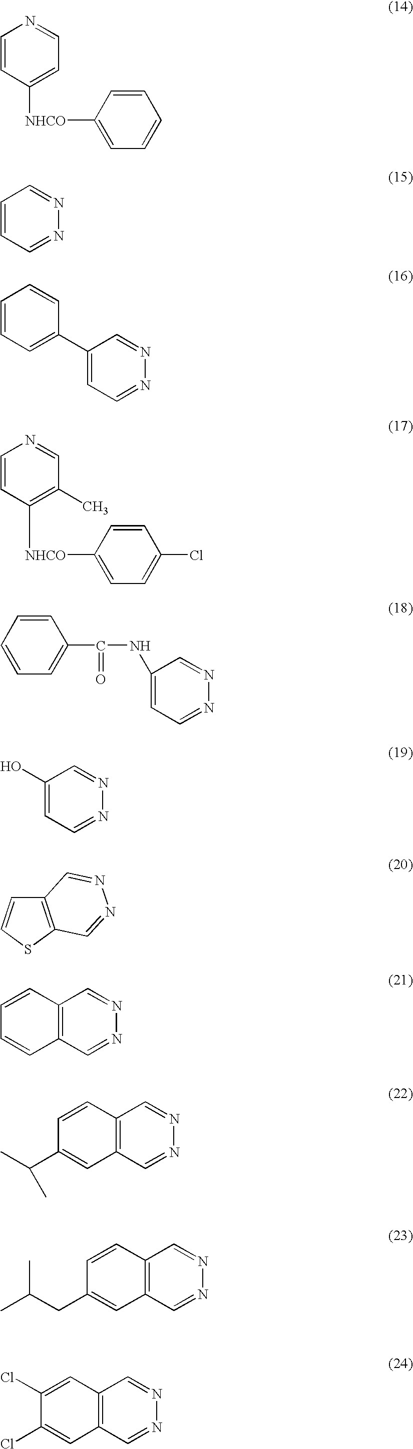

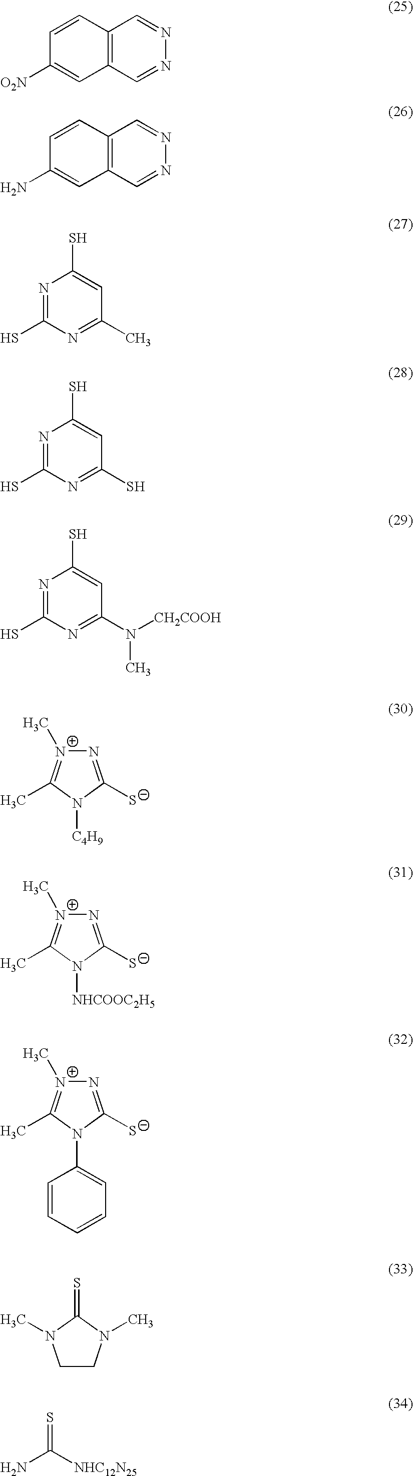

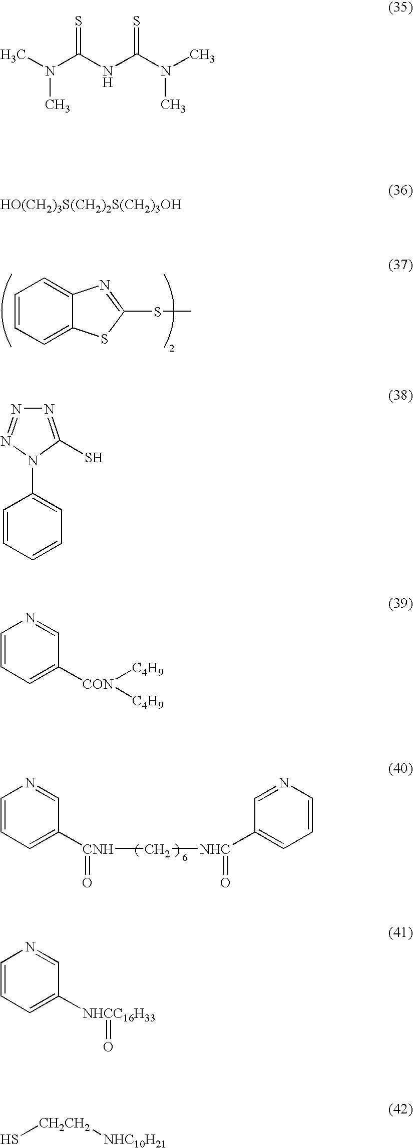

The silver iodide complex forming agent according to the present invention can also be a compound common to a toner, in the case where the agent achieves the function of conventionally known toner. The silver iodide complex forming agent according to the present invention can be used in combination with a toner. And, two or more kinds of the silver iodide complex forming agents may be used in combination.

The silver iodide complex forming agent according to the present invention preferably exists in a film under the state separated from a photosensitive silver halide, such as a solid state. It is also preferably added to the layer adjacent to the image forming layer. Concerning the silver iodide complex forming agent according to the present invention, a melting point of the compound is preferably adjusted to a suitable range so that it can be dissolved when heated at thermal developing temperature.

In the present invention, an absorption intensity of ultra violet-visible absorption spectrum of photosensitive silver halide after thermal development preferably becomes 80% or less as compared with before thermal development, more preferably 40% or less and, particularly preferably 10% or less.

The silver iodide complex forming agent according to the invention may be incorporated into photothermographic material by being added into the coating solution, such as in the form of a solution, an emulsion dispersion, a solid fine particle dispersion, and the like. As a well known emulsion dispersing method, there can be mentioned a method comprising dissolving the reducing agent in an auxiliary solvent such as oil, for instance, dibutyl phthalate, tricresyl phosphate, glyceryl triacetate, diethyl phthalate, and the like, as well as ethyl acetate, cyclohexanone, and the like; from which an emulsion dispersion is mechanically produced.

As solid fine particle dispersing method, there can be mentioned a method comprising dispersing the powder of the silver iodide complex forming agent in a proper medium such as water, by means of ball mill, colloid mill, vibrating ball mill, sand mill, jet mill, roller mill, or ultrasonics, thereby obtaining solid dispersion. In this case, there can also be used a protective colloid (such as polyvinyl alcohol), or a surfactant (for instance, an anionic surfactant such as sodium triisopropylnaphthalenesulfonate (a mixture of compounds having the isopropyl groups in different substitution sites)). In the mills enumerated above, generally used as the dispersion media are beads made of zirconia and the like, and Zr and the like eluting from the beads may be incorporated in the dispersion. Although depending on the dispersing conditions, the amount of Zr and the like generally incorporated in the dispersion is in the range of from 1 ppm to 1000 ppm. It is practically acceptable so long as Zr is incorporated in the photothermographic material in an amount of 0.5 mg or less per 1 g of silver.

Preferably, a preservative (for instance, sodium benzoisothiazolinone salt) is added in the water dispersion.

The silver iodide complex forming agent according to the invention is preferably used in the form of a solid dispersion.

The silver iodide complex forming agent according to the invention is preferably used in the range from 1 mol % to 5000 mol %, more preferably, from 10 mol % to 1000 mol % and, further preferably, from 50 mol % to 300 mol %, with respect to the photosensitive silver halide in each case.

(Phthalic Acid and Derivatives Thereof)

In the present invention, the photothermographic material preferably comprises the compound selected from phthalic acid and phthalic acid derivatives, together with the silver iodide complex forming agent. As phthalic acid and phthalic acid derivatives used in the present invention, the compound represented by the following formula (PH) is preferable.

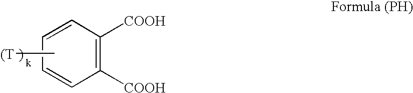

In the formula, T represents a halogen atom (fluorine, bromine and iodine atom), an alkyl group, an aryl group, an alkoxy group and a nitro group. k represents an integral number of 0 to 4, and when k is 2 or more, plural k may be the same or different from each other. k preferably is 0 to 2, and more preferably, 0 or 1.

The compound represented by formula (PH) may be used just as an acid or may be used as suitable salt from the viewpoint of easy addition to a coating solution and from the viewpoint of pH adjustment. As a salt, an alkaline metal salt, an ammonium salt, an alkaline earth metals salt, an amine salt and the like can be used. An alkaline metal salt (Li, Na, K and the like) and an ammonium salt are preferred.

Phthalic acid and the derivatives thereof used in the present invention are described below, however the present invention is not limited in these compounds.

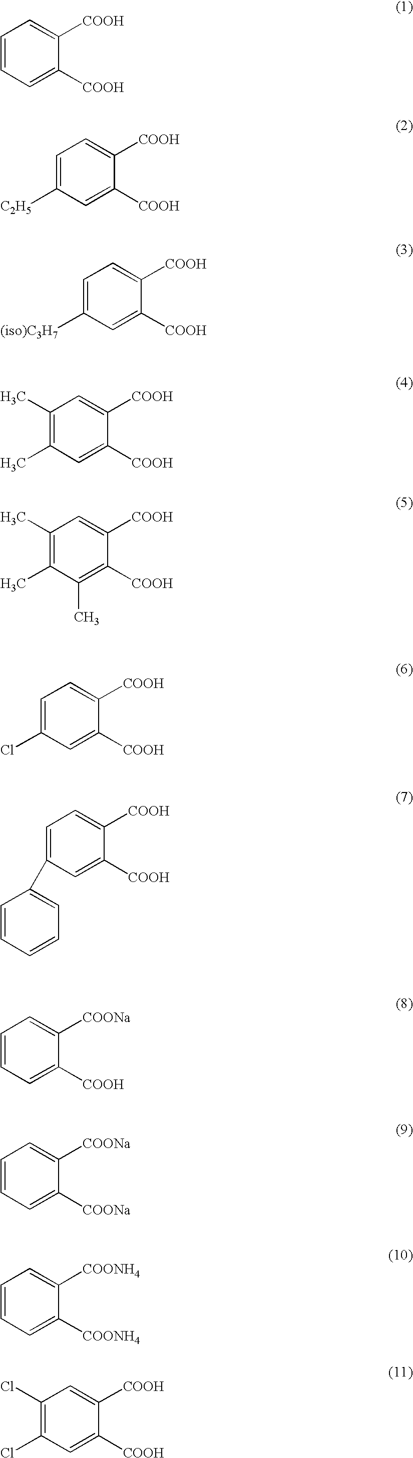

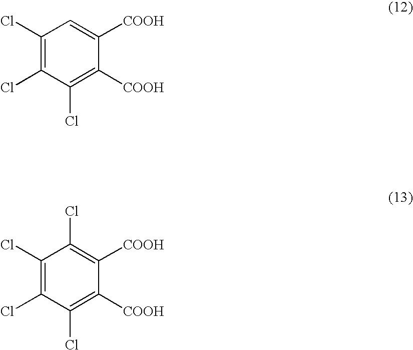

In the invention, the addition amount of phthalic acid and derivatives thereof is 1.0×10⁻⁴ mol to 1 mol, preferably 1.0×10⁻³ mol to 0.5 mol and, further preferably 2.0×10⁻³ mol to 0.2 mol, per 1 mol of coated silver.

(Development Accelerator)

In the photothermographic material of the invention, sulfoneamide phenolic compounds described in the specification of JP-A No. 2000-267222, and represented by formula (A) described in the specification of JP-A No. 2000-330234; hindered phenolic compounds represented by formula (II) described in JP-A No. 2001-92075; hydrazine compounds described in the specification of JP-A No. 10-62895, represented by formula (I) described in the specification of JP-A No. 11-15116, and represented by formula (1) described in the specification of JP-A No. 2002-278017; and phenolic or naphthalic compounds represented by formula (2) described in the specification of JP-A No. 2001-264929 are used preferably as a development accelerator. The development accelerator described above is used in the range from 0.1 mol % to 20 mol %, preferably, in the range from 0.5 mol % to 10 mol % and, more preferably, in the range from 1 mol % to 5 mol % with respect to the reducing agent. The introducing methods to the photothermographic material can include similar methods as those for the reducing agent and, it is particularly preferred to add as a solid dispersion or an emulsion dispersion. In the case of adding the development accelerator as an emulsion dispersion, it is preferred to add as an emulsion dispersion dispersed by using a high boiling solvent which is solid at a normal temperature and an auxiliary solvent at a low boiling point, or to add as a so-called oilless emulsion dispersion not using the high boiling solvent.

Among the above-described development accelerators according to the invention, particularly preferable are, hydrazine compounds represented by formula (1) described in the specification of JP-A No. 2002-278017, and phenolic or naphthalic compounds represented by formula (2) described in the specification of JP-A No. 2001-264929.

Preferred specific examples for the development accelerator of the invention are to be described below, but the invention is not restricted to them.

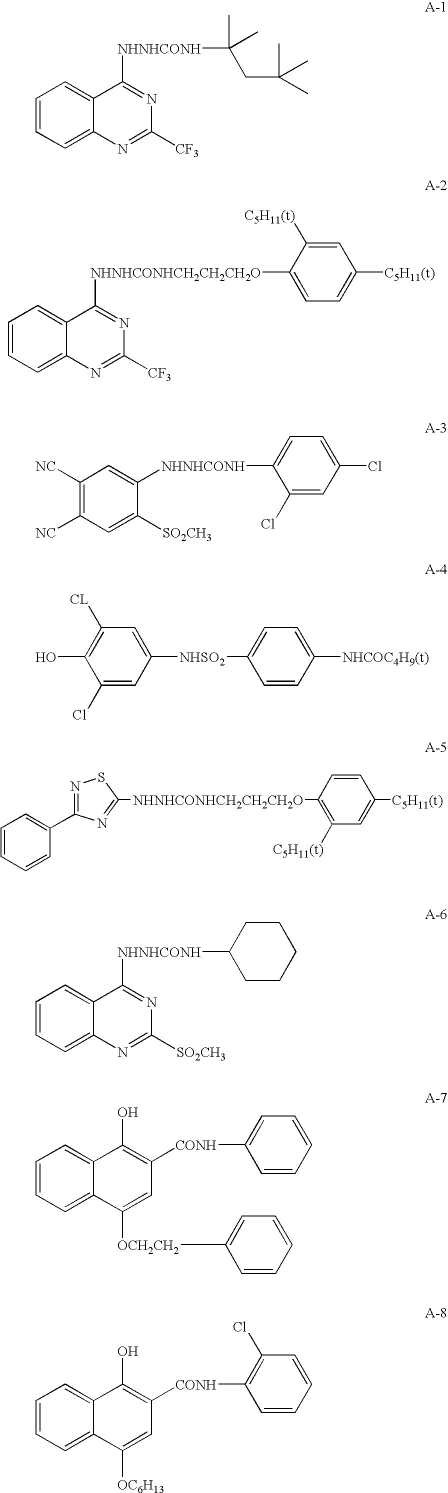

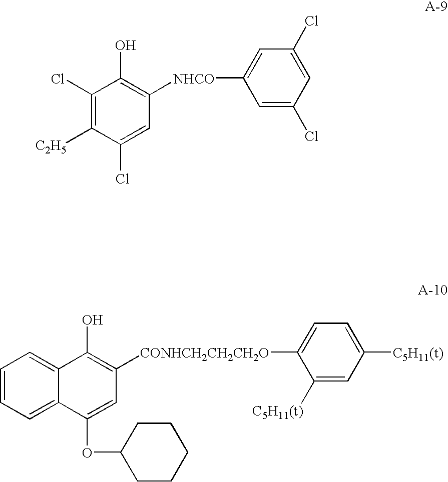

(Hydrogen Bonding Compound)

In the invention, in the case where the reducing agent has an aromatic hydroxy group (—OH) or an amino group, it is preferred to use in combination, a non-reducing compound having a group capable of reacting with these groups of the reducing agent, and that is also capable of forming a hydrogen bond therewith.

As a group forming a hydrogen bond, there can be mentioned a phosphoryl group, a sulfoxido group, a sulfonyl group, a carbonyl group, an amido group, an ester group, an urethane group, an ureido group, a tertiary amino group, a nitrogen-containing aromatic group, and the like. Particularly preferred among them is phosphoryl group, sulfoxido group, amido group (not having >N—H moiety but being blocked in the form of >N—Ra (where, Ra represents a substituent other than H)), urethane group (not having >N—H moiety but being blocked in the form of >N—Ra (where, Ra represents a substituent other than H)), and ureido group (not having >N—H moiety but being blocked in the form of >N—Ra (where, Ra represents a substituent other than H)).

In the invention, particularly preferable as the hydrogen bonding compound is the compound expressed by formula (D) shown below.

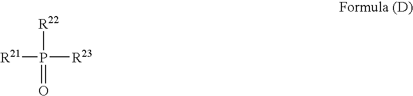

In formula (D), R²¹ to R²³ each independently represent an alkyl group, an aryl group, an alkoxy group, an aryloxy group, an amino group, or a heterocyclic group, which may be substituted or not substituted.

In the case where R²¹ to R²³ contain a substituent, examples of the substituents include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like, in which preferred as the substituents are an alkyl group or an aryl group, e.g., methyl group, ethyl group, isopropyl group, t-butyl group, t-octyl group, phenyl group, a 4-alkoxyphenyl group, a 4-acyloxyphenyl group, and the like.

Specific examples of an alkyl group expressed by R²¹ to R²³ include methyl group, ethyl group, butyl group, octyl group, dodecyl group, isopropyl group, t-butyl group, t-amyl group, t-octyl group, cyclohexyl group, 1-methylcyclohexyl group, benzyl group, phenetyl group, 2-phenoxypropyl group, and the like.

As aryl groups, there can be mentioned phenyl group, cresyl group, xylyl group, naphthyl group, 4-t-butylphenyl group, 4-t-octylphenyl group, 4-anisidyl group, 3,5-dichlorophenyl group, and the like.

As alkoxyl groups, there can be mentioned methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group, benzyloxy group, and the like.

As aryloxy groups, there can be mentioned phenoxy group, cresyloxy group, isopropylphenoxy group, 4-t-butylphenoxy group, naphthoxy group, biphenyloxy group, and the like.

As amino groups, there can be mentioned are dimethylamino group, diethylamino group, dibutylamino group, dioctylamino group, N-methyl-N-hexylamino group, dicyclohexylamino group, diphenylamino group, N-methyl-N-phenylamino, and the like.

Preferred as R²¹ to R²³ are an alkyl group, an aryl group, an alkoxy group, and an aryloxy group. Concerning the effect of the invention, it is preferred that at least one or more of R²¹ to R²³ are an alkyl group or an aryl group, and more preferably, two or more of them are an alkyl group or an aryl group. From the viewpoint of low cost availability, it is preferred that R²¹ to R²³ are of the same group.

Specific examples of hydrogen bonding compounds represented by formula (D) of the invention and others are shown below, but it should be understood that the invention is not limited thereto.

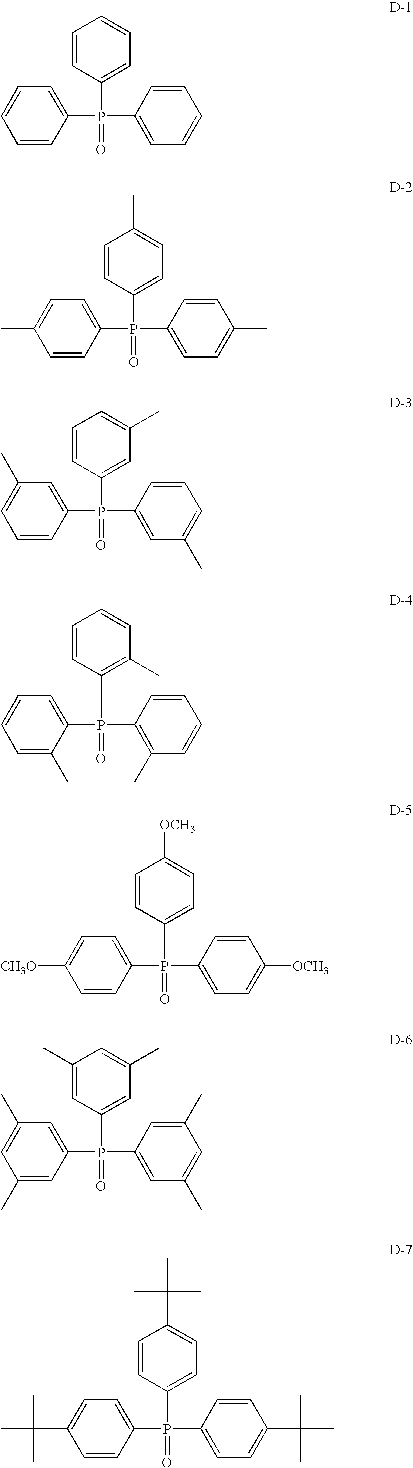

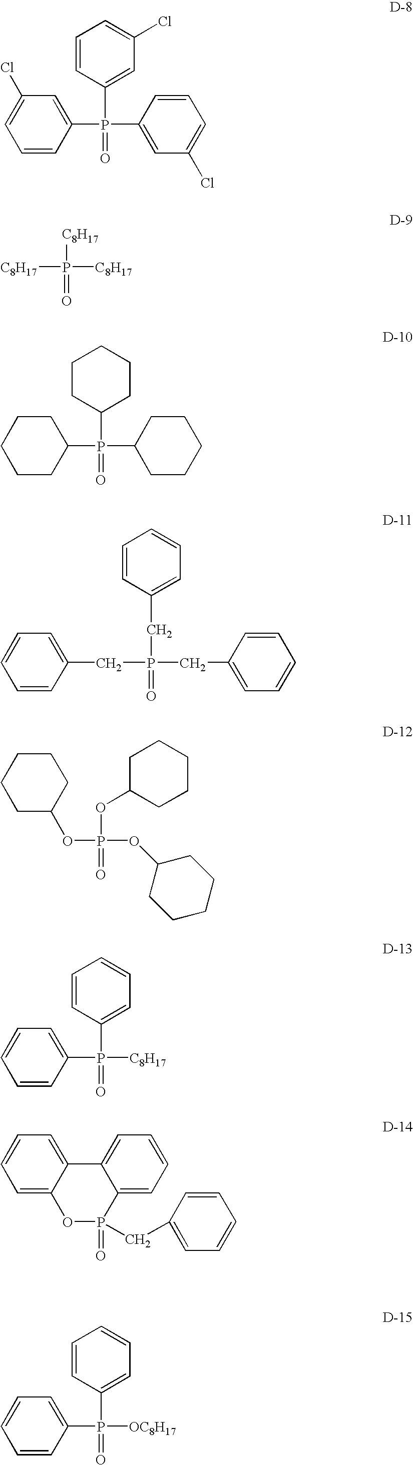

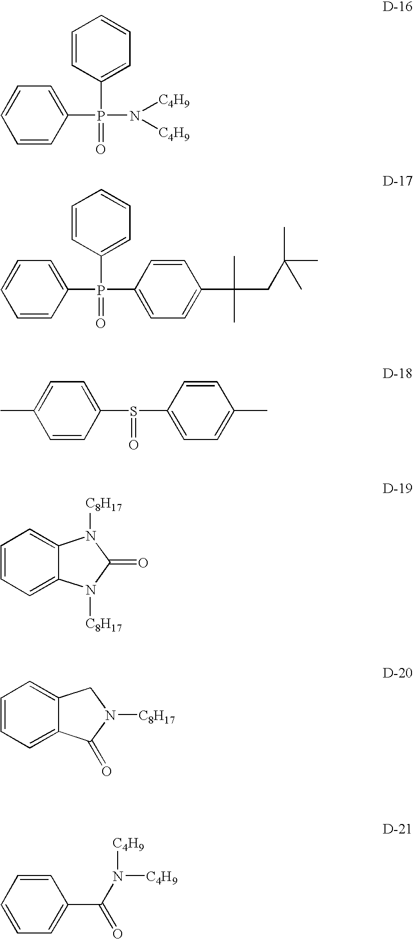

Specific examples of hydrogen bonding compounds other than those enumerated above can be found in those described in JP-A Nos. 2001-281793 and 2002-14438.

The hydrogen bonding compound of the invention can be used in the photothermographic material by being incorporated into the coating solution in the form of solution, emulsion dispersion, or solid fine particle dispersion similar to the case of the reducing agent. In the solution, the hydrogen bonding compound of the invention forms a hydrogen-bonded complex with a compound having a phenolic hydroxy group, and can be isolated as a complex in crystalline state depending on the combination of the reducing agent and the compound expressed by formula (D).

It is particularly preferred to use the crystal powder thus isolated in the form of a solid fine particle dispersion, because it provides stable performance. Further, it is also preferred to use a method of leading to form complex during dispersion by mixing the reducing agent and the hydrogen bonding compound of the invention in the form of powders and dispersing them with a proper dispersing agent using a sand grinder mill and the like.

The hydrogen bonding compound of the invention is preferably used in the range from 1 mol % to 200 mol %, more preferably from 10 mol % to 150 mol %, and further preferably, from 30 mol % to 100 mol %, with respect to the reducing agent.

(Binder)

Any kind of polymer may be used as the binder for the layer containing organic silver salt in the photothermographic material of the invention. Suitable as the binder are those that are transparent or translucent, and that are generally colorless, such as natural resin or polymer and their copolymers; synthetic resin or polymer and their copolymer; or media forming a film; for example, included are gelatin, rubber, poly (vinyl alcohol), hydroxyethyl cellulose, cellulose acetate, cellulose acetate butyrate, poly (vinyl pyrrolidone), casein, starch, poly(acrylic acid), poly(methylmethacrylic acid), poly(vinyl chloride), poly(methacrylic acid), styrene-maleic anhydride copolymers, styrene-acrylonitrile copolymers, styrene-butadiene copolymers, poly(vinyl acetal) (e.g., poly(vinyl formal) and poly(vinyl butyral)), poly(ester), poly(urethane), phenoxy resin, poly(vinylidene chloride), poly(epoxide), poly(carbonate), poly(vinyl acetate), poly(olefin), cellulose esters, and poly(amide). A binder may be used with water, an organic solvent or emulsion to form a coating solution.

In the invention, the glass transition temperature (Tg) of the binder of the layer including organic silver salts is preferably in the range from 10° C. to 80° C., more preferably, from 20° C. to 70° C. and, further preferably, from 23° C. to 65° C.

In the specification, Tg is calculated according to the following equation.
1/Tg=Σ(Xi/Tgi)

Where, the polymer is obtained by copolymerization of n monomer compounds (from i=1 to i=n); Xi represents the mass fraction of the ith monomer (ΣXi=1), and Tgi is the glass transition temperature (absolute temperature) of the homopolymer obtained with the ith monomer. The symbol Σ stands for the summation from i=1 to i=n. Values for the glass transition temperature (Tgi) of the homopolymers derived from each of the monomers were obtained from J. Brandrup and E. H. Immergut, Polymer Handbook (3rd Edition) (Wiley-Interscience, 1989).

The polymer used for the binder may be of one kind or, may be two or more kinds of polymers, if necessary. And, the polymer having Tg of 20° C. or more and the polymer having Tg of less than 20° C. can be used in combination. In the case where two or more kinds of polymers differing in Tg may be blended for use, it is preferred that the weight-average Tg is in the range mentioned above.

In the case where the layer containing organic silver salt is formed by first applying a coating solution containing 30% by weight or more of water in the solvent and by then drying, furthermore, in the case where the binder of the layer containing organic silver salt is soluble or dispersible in an aqueous solvent (water solvent), and particularly in the case where a polymer latex having an equilibrium water content of 2% by weight or lower under 25° C. and 60% RH is used, the performance can be ameliorated.

Most preferred embodiment is such prepared to yield an ion conductivity of 2.5 mS/cm or lower, and as such a preparing method, there can be mentioned a refining treatment using a separation function membrane after synthesizing the polymer.

The aqueous solvent in which the polymer is soluble or dispersible, as referred herein, signifies water or water containing mixed therein 70% by weight or less of a water-admixing organic solvent.

As water-admixing organic solvents, there can be mentioned, for example, alcohols such as methyl alcohol, ethyl alcohol, propyl alcohol, and the like; cellosolves such as methyl cellosolve, ethyl cellosolve, butyl cellosolve, and the like; ethyl acetate, dimethylformamide, and the like.

The term “equilibrium water content under 25° C. and 60% RH” as referred herein can be expressed as follows:
Equilibrium water content under 25° C. and 60% RH=[(W1−W0)/W0]×100(% by weight)
wherein, W1 is the weight of the polymer in moisture-controlled equilibrium under the atmosphere of 25° C. and 60% RH, and W0 is the absolutely dried weight at 25° C. of the polymer.

For the definition and the method of measurement for water content, reference can be made to Polymer Engineering Series 14, “Testing methods for polymeric materials” (The Society of Polymer Science, Japan, published by Chijin Shokan).

The equilibrium water content under 25° C. and 60% RH is preferably 2% by weight or lower, but is more preferably, 0.01% by weight to 1.5% by weight, and is most preferably, 0.02% by weight to 1% by weight.

The binders used in the invention are, particularly preferably, polymers capable of being dispersed in aqueous solvent. Examples of dispersed states may include a latex, in which water-insoluble fine particles of hydrophobic polymer are dispersed, or such in which polymer molecules are dispersed in molecular states or by forming micelles, and both are preferred. The average particle size of the dispersed particles is in the range from 1 nm to 50,000 nm, and preferably from 5 nm to 1,000 nm. There is no particular limitation concerning particle size distribution of the dispersed particles, and may be widely distributed or may exhibit a monodisperse particle size distribution.

In the invention, preferred embodiment of the polymers capable of being dispersed in aqueous solvent includes hydrophobic polymers such as acrylic polymers, poly(ester), rubber (e.g., SBR resin), poly(urethane), poly(vinyl chloride), poly(vinyl acetate), poly(vinylidene chloride), poly(olefin), and the like. As the polymers above, usable are straight chain polymers, branched polymers, or crosslinked polymers; also usable are the so-called homopolymers in which one kind of monomer is polymerized, or copolymers in which two or more kinds of monomers are polymerized. In the case of a copolymer, it may be a random copolymer or a block copolymer.

The molecular weight of these polymers is, in number average molecular weight, in the range from 5,000 to 1,000,000, preferably from 10,000 to 200,000. Those having too small molecular weight exhibit insufficient mechanical strength on forming the image forming layer, and those having too large molecular weight are also not preferred because the filming properties result poor.

Specific examples of preferred polymer latexes are given below, which are expressed by the starting monomers with % by weight given in parenthesis. The molecular weight is given in number average molecular weight. In the case polyfunctional monomer is used, the concept of molecular weight is not applicable because they build a crosslinked structure. Hence, they are denoted as “crosslinking”, and the molecular weight is omitted. Tg represents glass transition temperature.
P-1; Latex of -MMA(70)-EA(27)-MAA(3)-(molecular weight 37000, Tg 61° C.)
P-2; Latex of -MMA(70)-2EHA(20)-St(5)-AA(5)-(molecular weight 40000, Tg 59° C.)
P-3; Latex of -St(50)-Bu(47)-MAA(3)-(crosslinking, Tg -17° C.)
P-4; Latex of -St(68)-Bu(29)-AA(3)-(crosslinking, Tg 17° C.)
P-5; Latex of -St(71)-Bu(26)-AA(3)-(crosslinking, Tg 24° C.)
P-6; Latex of -St(70)-Bu(27)-IA(3)-(crosslinking)
P-7; Latex of -St(75)-Bu(24)-AA(1)-(crosslinking, Tg 29° C.)
P-8; Latex of -St(60)-Bu(35)-DVB(3)-MAA(2)-(crosslinking)
P-9; Latex of -St(70)-Bu(25)-DVB(2)-AA(3)-(crosslinking)
P-10; Latex of -VC(50)-MMA(20)-EA(20)-AN(5)-AA(5)-(molecular weight 80000)
P-11; Latex of -VDC(85)-MMA(5)-EA(5)-MAA(5)-(molecular weight 67000)
P-12; Latex of -Et(90)-MAA(10)-(molecular weight 12000)
P-13; Latex of -St(70)-2EHA(27)-AA(3)-(molecular weight 130000, Tg 43° C.)
P-14; Latex of -MMA(63)-EA(35)-AA(2)-(molecular weight 33000, Tg 47° C.)
P-15; Latex of -St(70.5)-Bu(26.5)-AA(3)-(crosslinking, Tg 23° C.)
P-16; Latex of -St(69.5)-Bu(27.5)-AA(3)-(crosslinking, Tg 20.5° C.)

In the structures above, abbreviations represent monomers as follows. MMA: methyl metacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, IA: itaconic acid.

The polymer latexes above are commercially available, and polymers below are usable. As examples of acrylic polymers, there can be mentioned Cevian A-4635, 4718, and 4601 (all manufactured by Daicel Chemical Industries, Ltd.), Nipol Lx811, 814, 821, 820, and 857 (all manufactured by Nippon Zeon Co., Ltd.), and the like; as examples of poly(ester), there can be mentioned FINETEX ES650, 611, 675, and 850 (all manufactured by Dainippon Ink and Chemicals, Inc.), WD-size and WMS (all manufactured by Eastman Chemical Co.), and the like; as examples of poly(urethane), there can be mentioned HYDRAN AP10, 20, 30, and 40 (all manufactured by Dainippon Ink and Chemicals, Inc.), and the like; as examples of rubber, there can be mentioned LACSTAR 7310K, 3307B, 4700H, and 7132C (all manufactured by Dainippon Ink and Chemicals, Inc.), Nipol Lx416, 410, 438C, and 2507 (all manufactured by Nippon Zeon Co., Ltd.), and the like; as examples of poly(vinyl chloride), there can be mentioned G351 and G576 (all manufactured by Nippon Zeon Co., Ltd.), and the like; as examples of poly(vinylidene chloride), there can be mentioned L502 and L513 (all manufactured by Asahi Chemical Industry Co., Ltd.), and the like; as examples of poly(olefin), there can be mentioned Chemipearl S120 and SA100 (all manufactured by Mitsui Petrochemical Industries, Ltd.), and the like.

The polymer latex above may be used alone, or may be used by blending two or more kinds depending on needs.

Particularly preferable as the polymer latex for use in the invention is that of styrene-butadiene copolymer. The weight ratio of monomer unit for styrene to that of butadiene constituting the styrene-butadiene copolymer is preferably in the range of from 40:60 to 95:5. Further, the monomer unit of styrene and that of butadiene preferably account for 60% by weight to 99% by weight with respect to the copolymer. Preferable range of molecular weight is similar to that described above.

As the latex of styrene-butadiene copolymer preferably used in the invention, there can be mentioned P-3 to P-8, P-14 and P-15, or commercially available LACSTAR-3307B, 7132C, Nipol Lx4l6, and the like.

In the layer containing organic silver salt of the photothermographic material according to the invention, if necessary, there can be added hydrophilic polymers such as gelatin, polyvinyl alcohol, methyl cellulose, hydroxypropyl cellulose, carboxymethyl cellulose, and the like.

The hydrophilic polymers above are added at an amount of 30% by weight or less, preferably 20% by weight or less, with respect to the total weight of the binder incorporated in the layer containing organic silver salt.

According to the invention, the layer containing organic silver salt (image forming layer) is preferably formed by using polymer latex for the binder. According to the amount of the binder for the layer containing organic silver salt, the weight ratio for total binder to organic silver salt (total binder/organic silver salt) is preferably in the range of 1/10 to 10/1, and more preferably 1/5 to 4/1.

The layer containing organic silver salt is, in general, a photosensitive layer (image forming layer) containing a photosensitive silver halide, i.e., the photosensitive silver salt; in such a case, the weight ratio for total binder to silver halide (total binder/silver halide) is in the range of from 400 to 5, more preferably, from 200 to 10.

The total amount of binder in the image forming layer of the invention is preferably in the range from 0.2 g/m² to 30 g/m², and more preferably from 1 g/m² to 15 g/m². As for the image forming layer of the invention, there may be added a crosslinking agent for crosslinking, or a surfactant and the like to improve coating properties.

In the invention, a solvent of a coating solution for a layer containing organic silver salt (wherein a solvent and water are collectively described as a solvent for simplicity) is preferably an aqueous solvent containing water at 30% by weight or more. Examples of solvents other than water may include any of water-miscible organic solvents such as methyl alcohol, ethyl alcohol, isopropyl alcohol, methyl cellosolve, ethyl cellosolve, dimethylformamide and ethyl acetate. A water content in a solvent is more preferably 50% by weight or more and still more preferably 70% by weight or more.

Concrete examples of a preferable solvent composition, in addition to water=100, are compositions in which methyl alcohol is contained at ratios of water/methyl alcohol=90/10 and 70/30, in which dimethylformamide is further contained at a ratio of water/methyl alcohol/dimethylformamide=80/15/5, in which ethyl cellosolve is further contained at a ratio of water/methyl alcohol/ethyl cellosolve=85/10/5, and in which isopropyl alcohol is further contained at a ratio of water/methyl alcohol/isopropyl alcohol=85/10/5 (wherein the numerals presented above are values in % by weight).

(Antifoggant)

1) Organic polyhalogen compound

In the invention, preferred polyhalogen compounds are the compounds expressed by formula (H) below:
Q—(Y)n-C(Z₁)(Z₂)X Formula (H)

In formula (H), Q represents an alkyl group, an aryl group, or a heterocyclic group; Y represents a divalent connecting group; n represents 0 or 1; Z₁ and Z₂ represent a halogen atom; and X represents hydrogen atom or an electron-attracting group.

Q preferably is a phenyl group substituted by an electron-attracting group whose Hammett substituent constant σp yields a positive value. For the details of Hammett substituent constant, reference can be made to Journal of Medicinal Chemistry, vol. 16, No. 11 (1973), pages 1207 to 1216, and the like.

As such electron-attracting groups, examples include, halogen atoms (fluorine atom (σp value: 0.06), chlorine atom (σp value: 0.23), bromine atom (σp value: 0.23), iodine atom (σp value: 0.18)), trihalomethyl groups (tribromomethyl (σp value: 0.29), trichloromethyl (σp value: 0.33), trifluoromethyl (σp value: 0.54)), a cyano group (σp value: 0.66), a nitro group (σp value: 0.78), an aliphatic aryl or heterocyclic sulfonyl group (for example, methanesulfonyl (σp value: 0.72)), an aliphatic aryl or heterocyclic acyl group (for example, acetyl (σp value: 0.50) and benzoyl (σp value: 0.43)), an alkynyl (e.g., C≡CH (σp value: 0.23)), an aliphatic aryl or heterocyclic oxycarbonyl group (e.g., methoxycarbonyl (σp value: 0.45) and phenoxycarbonyl (σp value: 0.44)), a carbamoyl group (σp value: 0.36), sulfamoyl group (σp value: 0.57), sulfoxido group, heterocyclic group, and phosphoryl group.

Preferred range of the σp value is from 0.2 to 2.0, and more preferably, from 0.4 to 1.0.

Preferred as the electron-attracting groups are carbamoyl group, an alkoxycarbonyl group, an alkylsulfonyl group, an alkylphosphoryl group, a carboxyl group, an alkylcarbonyl group, an arylcarbonyl group, and arylsulfonyl group. Particularly preferred among them are a carbamoyl group, an alkoxycarbonyl group, an alkylsulfonyl group and an alkylphosphoryl group, and most preferred is a carbamoyl group.

X preferably is an electron-attracting group, more preferably, a halogen atom, an aliphatic aryl or heterocyclic sulfonyl group, an aliphatic aryl or heterocyclic acyl group, an aliphatic aryl or heterocyclic oxycarbonyl group, carbamoyl group, or sulfamoyl group; particularly preferred among them is a halogen atom.

Among halogen atoms, preferred are chlorine atom, bromine atom, and iodine atom; more preferred are chlorine atom and bromine atom; and particularly preferred is bromine atom.

Y preferably represents —C(═O)—, —SO—, or —SO₂—; more preferably, —C(═O)— or —SO₂—; and particularly preferred is —SO₂—. n represents 0 or 1, and preferably represents 1.

Specific examples of the compounds expressed by formula (H) of the invention are shown below, but the present invention is not limited in these.

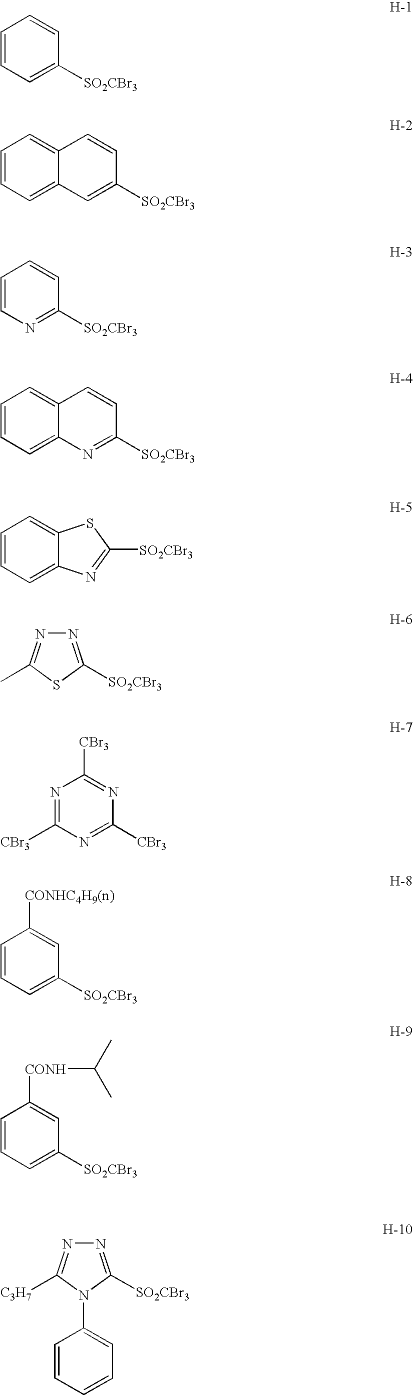

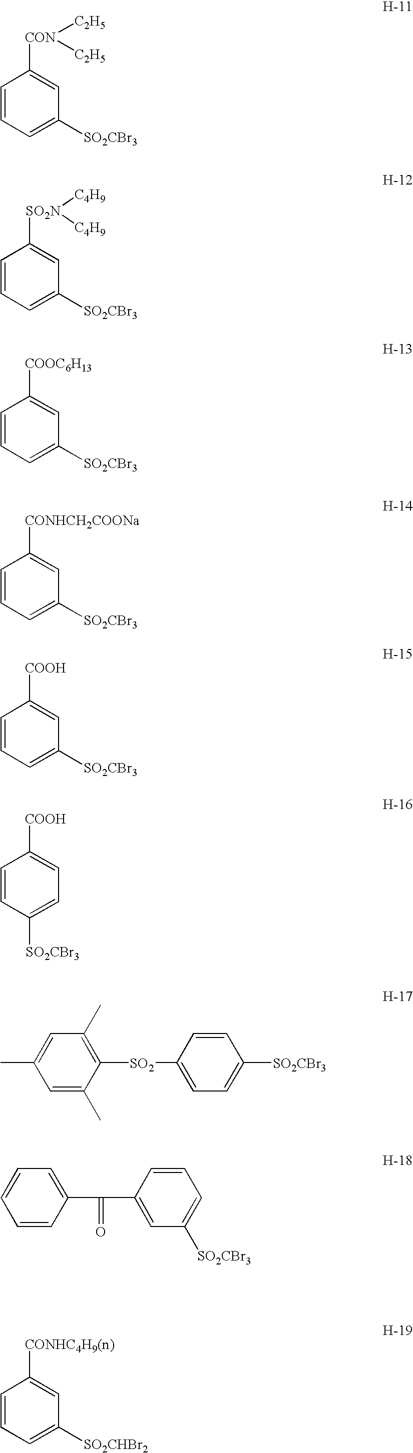

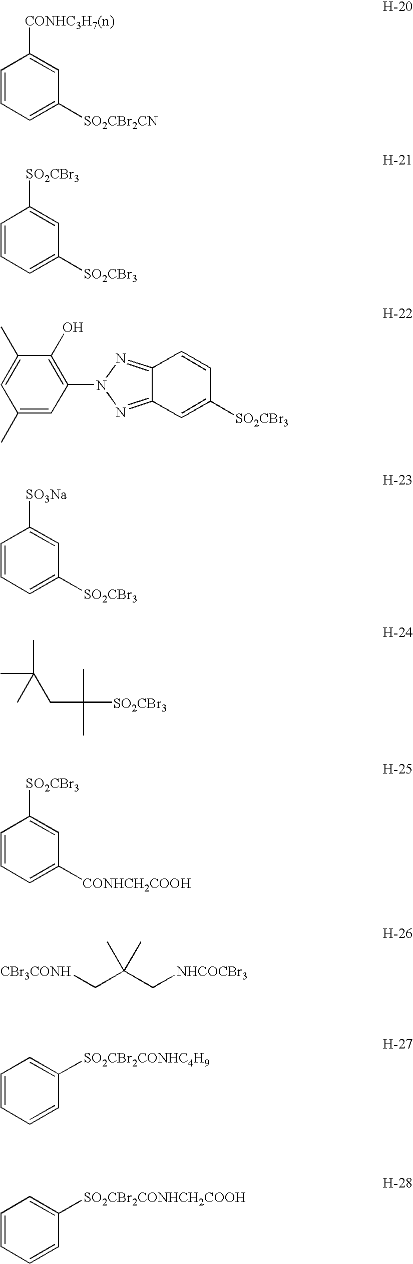

The compounds expressed by formula (H) of the invention are preferably used in an amount of 10⁻⁴ mol to 0.8 mol, more preferably, 10⁻³ mol to 0.1 mol, and further preferably, 5×10⁻³ mol to 0.05 mol, per 1 mol of non-photosensitive silver salt incorporated in the image forming layer.

Particularly, in the case where a silver halide having a composition of a high silver iodide content according to the invention is used, an addition amount of the compound expressed by formula (H) is important in order to obtain a sufficient anti-fogging effect and the compound is most preferably used in the range from 5×10⁻³ mol to 0.03 mol.

In the invention, methods of incorporating a compound expressed by formula (H) into a photothermographic material are described in the methods of incorporating a reducing agent described above.

A melting point of a compound expressed by formula (H) is preferably 200° C. or lower, and more preferably 170° C. or lower.

Examples of other organic polyhalogen compound used in the invention are disclosed in paragraphs Nos. 0111 to 0112 of JP-A No. 11-65021. Preferable examples thereof are an organic halogen compound expressed by formula (P) described in JP-A No. 11-87297, an organic polyhalogen compound expressed by formula (II) described in JP-A No. 10-339934 and an organic polyhalogen compound described in JP-A No. 2001-033911.

2) Other Antifoggants

As other antifoggants, there can be mentioned a mercury (II) salt described in paragraph number 0113 of JP-A No. 11-65021, benzoic acids described in paragraph number 0114 of the same literature, a salicylic acid derivative described in JP-A No. 2000-206642, a formaline scavenger compound expressed by formula (S) in JP-A No. 2000-221634, a triazine compound related to claim 9 of JP-A No. 11-352624, a compound expressed by formula (III), 4-hydroxy-6-methyl-1,3,3a,7-tetrazaindene and the like, as described in JP-A No. 6-11791.

As an antifoggant, stabilizer and stabilizer precursor usable in the invention, there can be mentioned those disclosed as patents in paragraph number 0070 of JP-A No. 10-62899 and in line 57 of page 20 to line 7 of page 21 of EP No. 0803764A1, the compounds described in JP-A Nos. 9-281637 and 9-329864.

The photothermographic material of the invention may further contain an azolium salt in order to prevent fog. As azolium salts, there can be mentioned a compound expressed by formula (XI) as described in JP-A No. 59-193447, a compound described in JP-B No. 55-12581, and a compound expressed by formula (II) in JP-A No. 60-153039. The azolium salt may be added to any part of the photothermographic material, but as the addition layer, preferred is to select a layer on the side having thereon the image forming layer, and more preferred is to select a layer containing organic silver salt.

The azolium salt may be added at any time of the process of preparing the coating solution; in the case the azolium salt is added into the layer containing the organic silver salt, any time of the process may be selected, from the preparation of the organic silver salt to the preparation of the coating solution, but preferred is to add the salt after preparing the organic silver salt and just before the coating. As the method for adding the azolium salt, any method using a powder, a solution, a fine-particle dispersion, and the like, may be used. Furthermore, it may be added as a solution having mixed therein other additives such as sensitizing agents, reducing agents, tone adjusting agents, and the like.

In the invention, the azolium salt may be added at any amount, but preferably, it is added in a range of 1×10⁻⁶ mol to 2 mol, and more preferably, 1×10⁻³ mol to 0.5 mol per 1 mol of silver.

(Other Additives)

1) Mercapto Compounds, Disulfides and Thiones

In the invention, mercapto compounds, disulfide compounds, and thione compounds may be added in order to control the development by suppressing or enhancing development, to improve spectral sensitization efficiency, and to improve storage properties before and after development. Descriptions can be found in paragraph Nos. 0067 to 0069 of JP-A No. 10-62899, a compound expressed by formula (I) of JP-A No. 10-186572 and specific examples thereof shown in paragraph Nos. 0033 to 0052, in lines 36 to 56 in page 20 of EP-A No. 0803764A1, in JP-A No. 2001-100358 and the like. Among them, mercapto-substituted heterocyclic aromatic compound is preferred.

2) Toner

In the photothermographic material of the present invention, the addition of a toner is preferred. The description of the toner can be found in JP-A No. 10-62899 (paragraph Nos. 0054 to 0055), EP No. 0803764A1 (page21, lines 23 to 48), JP-A Nos. 2000-356317 and the like. Preferred are phthalazinones (phthalazinone, phthalazinone derivatives and metal salts thereof, e.g.,4-(1-naphthyl)phthalazinone, 6-chlorophthalazinone, 5,7-dimethoxyphthalazinone and 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate and tetrachlorophthalic anhydride); phthalazines (phthalazine, phthalazine derivatives and metal salts thereof, (e.g., 4-(1-naphthyl)phthalazine, 6-isopropylphthalazine, 6-ter-butylphthalazine, 6-chlorophthalazine, 5,7-dimethoxyphthalazine and 2,3-dihydrophthalazine); combinations of phthalazines and phthalic acids. As for the combination with the silver halide having a high silver iodide content, particularly preferred is a combination of phthalazines and phthalic acids.

Preferred addition amount of the phthalazines in the invention is in the range from 0.01 mol to 0.3 mol, more preferably 0.02 mol to 0.2 mol and particularly preferably 0.02 mol to 0.1 mol, per 1 mol of organic silver salt. This addition amount is one important factor for the problem of development acceleration when using a silver halide emulsion having a high silver iodide content of the invention. By selecting appropriate addition amount, both of sufficient development performance and low fog will be possible.

3) Plasticizer and Lubricant

Plasticizers and lubricants usable in the photothermographic material of the invention are described in paragraph No. 0117 of JP-A No. 11-65021. Lubricants are described in paragraph Nos. 0061 to 0064 of JP-A No. 11-84573.

4) Dyes and Pigments

From the viewpoint of improving image tone, preventing the generation of interference fringes and preventing irradiation on laser exposure, various kinds of dyes and pigments (for instance, C.I. Pigment Blue 60, C.I. Pigment Blue 64, and C.I. Pigment Blue 15:6) may be used in the image forming layer of the invention. Detailed description can be found in WO No. 98/36322, JP-A Nos. 10-268465 and 11-338098, and the like.

5) Nucleation Accelerator

A nucleation accelerator can be used with the means for nucleation of the invention. Concerning a nucleation accelerator, description can be found in paragraph No. 0102 of JP-A No. 11-65021, and in paragraph Nos. 0194 to 0195 of JP-A No. 11-223898.

In the case of using a nucleation accelerator in the photothermographic material of the invention, it is preferred to use an acid resulting from hydration of diphosphorus pentaoxide, or its salt. Acids resulting from the hydration of diphosphorus pentaoxide or salts thereof include metaphosphoric acid (salt), pyrophosphoric acid (salt), orthophosphoric acid (salt), triphosphoric acid (salt), tetraphosphoric acid (salt), hexametaphosphoric acid (salt), and the like. Particularly preferred acids obtainable by the hydration of diphosphorus pentaoxide or salts thereof include orthophosphoric acid (salt) and hexametaphosphoric acid (salt). Specifically mentioned as the salts are sodium orthophosphate, sodium dihydrogen orthophosphate, sodium hexametaphosphate, ammonium hexametaphosphate, and the like.

The addition amount of the acid obtained by hydration of diphoshorus pentaoxide or a salt thereof (i.e., the coating amount per 1 m² of the photothermographic material) may be set as desired depending on sensitivity and fog, but preferred is in an amount of 0.1 mg/m² to 500 mg/m², and more preferably, 0.5 mg/m² to 100 mg/m².

(Preparation of Coating Solution and Coating)

The temperature for preparing the coating solution for use in the image forming layer of the invention is preferably from 30° C. to 65° C., more preferably, from 35° C. or more to less than 60° C., and further preferably, from 35° C. to 55° C. Furthermore, the temperature of the coating solution for the image forming layer immediately after adding the polymer latex is preferably maintained in the temperature range from 30° C. to 65° C.

2. Layer Constitution and other Constituents

The photothermographic material of the present invention may be either “single-sided type” having an image forming layer on one side of the support, or “double-sided type” having image forming layers on both sides of the support.

(Double-sided Type Photothermographic Material)

The photothermographic material of the present invention is preferably applied for an image forming method to record X-ray images using an X-ray intensifying screen.

For the image forming method, the photothermographic material as described below can be preferably employed: where the photothermographic material is exposed with a monochromatic light having the same wavelength as the main emission peak wavelength of the X-ray intensifying screen and having a half band width of 15±5 nm, and after a thermal developing process, an exposure value required for a density of fog+0.5 for an image obtained by removing the image forming layer that is disposed on the opposite side of an exposure face is 1×10⁻⁶ watt·sec m⁻² to 1×10⁻³ watt·sec m², and preferably 6×10⁻⁶ watt·sec m⁻² to 6×10⁻⁴ watt·sec·m⁻².

The image forming method using the photothermographic materials described above comprises the steps of:
(a) providing an assembly for forming an image by placing the photothermographic material between a pair of the X-ray intensifying screens,
(b) putting an analyte between the assembly and the X-ray source,
(c) applying an X-ray,
(d) taking the photothermographic material out of the assembly, and
(e) heating the thus taken out photothermographic material in the temperature range of 90° C. to 180° C.

The photothermographic material used for the assembly in the present invention is subjected to X-ray exposure through a step wedge tablet and thermal development. On the photographic characteristic curve having an optical density (D) and an exposure amount (log E) along the rectangular coordinates having the equal axis-of-coordinate unit, it is preferred to adjust so that the thermal developed image may have the photographic characteristic curve where the average gamma (γ) made at the points of a density of fog+0.1 and a density of fog+0.5 is from 0.5 to 0.9, and the average gamma (γ) made at the points of a density of fog+1.2 and a density of fog+1.6 is from 3.2 to 4.0. For the X-ray radiography employed in the practice of the present invention, the use of photothermographic material having the aforesaid photographic characteristic curve would give the X-ray images with excellent photographic properties that exhibit an extended bottom portion and high gamma value at middle density area. According to this photogaraphic property, the photographic properties mentioned has the advantage of that the depiction in low density portion on the mediastinal region and the heart shadow region having little X-ray transmittance becomes excellent, and that the density becomes pleasing to the eye, and that the contrast in the images on the lung field region having much X-ray transmittance becomes excellent.

The photothermographic material having the preferred photographic characteristic curve mentioned above can be easily prepared, for example, by the method where each of the image forming layer of both sides may be constituted of two or more image forming layers containing silver halide and having a sensitivity different from each other. Especially, the aforesaid image forming layer preferably comprises an emulsion of high sensitivity for the upper layer and an emulsion with photographic properties of low sensitivity and high contrast for the lower layer. In the case of preparing the image forming layer comprising two layers, the sensitivity difference between the silver halide emulsion in each layer is preferably from 1.5 times to 20 times, and more preferably from 2 times to 15 times. The ratio of the amount of emulsion used for forming each layer may depend on the sensitivity difference between emulsions used and the covering power. Generally, as the sensitivity difference is large, the ratio of the using amount of high sensitivity emulsion is reduced. For example, if the sensitivity difference is two times, and the covering power is equal, the ratio of the amount of high sensitivity emulsion to low sensitivity emulsion would be preferably adjusted to be in the range from 1:20 to 1:50 based on silver amount.

The techniques such as an emulsion sensitizing method, kinds of additives and constituents employed in the production of the photothermographic material of the present invention are not particularly limited. For example, various kinds of techniques described in JP-A Nos. 2-68539, 2-103037 and 2-115837 can be applied.

As the techniques for crossover cut (in the case of double-sided coated photosensitive material) and anti-halation (in the case of single-sided coated photosensitive material), dyes or combined use of dye and mordant described in JP-A. No. 2-68539, (from page 13, left lower column, line 1 to page 14, left lower column, line 9) can be employed.

Next the fluorescent intensifying screen (radiographic intensifying screen) employed in the practice of the present invention is explained below. The radiographic intensifying screen essentially comprises a support and a fluorescent substance layer coated on one side of the support as the fundamental structure. The fluorescent substance layer is a layer where the fluorescent substance is dispersed in binders. On the surface of a fluorescent substance layer opposite to the support side (the surface of the side that does not face on the support), a transparent protective layer is generally disposed to protect the fluorescent substance layer from chemical degradation and physical shock.

Preferred fluorescent substances of the present invention are described below. Tungstate type fluorescent substances (CaWO₄, MgWO₄, CaWO₄:Pb and the like), terbium activated rare earth sulfoxide type fluorescent substances [Y₂O₂S:Tb, Gd₂O₂S:Tb, La₂O₂S:Tb, (Y,Gd)₂O₂S:Tb, (Y,Gd)O₂S:Tb, Tm and the like], terbium activated rare earth phosphate type fluorescent substances (YPO₄:Tb, GdPO₄:Tb, LaPO₄:Tb and the like), terbium activated rare earth oxyhalogen type fluorescent substances (LaOBr:Tb, LaOBr:Tb, Tm, LaOCl:Tb, LaOCl:Tb, Tm, LaOBr:Tb, GdOBr:Tb, GdOCl:Tb and the like), thulium activated rare earth oxyhalogen type fluorescent substances (LaOBr:Tm, LaOCl:Tm and the like), barium sulfate type fluorescent substances [BaSO₄:Pb, BaSO₄:Eu²⁺, (Ba,Sr)SO₄:Eu²⁺ and the like], divalent europium activated alkali earth metal phosphate type fluorescent substances [(Ba₂PO₄)₂:Eu²⁺, (Ba₂PO₄)₂:Eu²⁺, and the like], divalent europium activated alkali earth metal fluorinated halogenide type fluorescent substances [BaFCl:Eu²⁺, BaFBr:Eu²⁺, BaFCl:Eu²⁺, Tb, BaFBr:Eu²⁺, Tb, BaF₂•BaCl•KCl:Eu²⁺, (Ba,Mg)F₂•BaCl•KCl:Eu²⁺, and the like], iodide type fluorescent substances (CsI:Na, CsI:Tl, NaI, KI:Tl and the like), sulfide type fluorescent substances [ZnS:Ag(Zn,Cd)S:Ag, (Zn,Cd)S:Cu, (Zn,Cd)S:Cu, Al and the like], hafnium phosphate type fluorescent substances (HfP₂O₇:Cu and the like). However, the fluorescent substance used in the present invention is not particularly limited to these specific examples, so long as to emit light in visible and near ultraviolet region by exposure to a radioactive ray.

In the fluorescent intensifying screen used in the present invention, the fluorescent substances are preferably packed in the grain size graded structure. Especially, fluorescent substance particles having a large particle size is preferably coated at the side of the surface protective layer and fluorescent substance particles having a small particle size is preferably coated at the side of the the support. Hereto, the small particle size of fluorescent substance is preferably in the range from 0.5 μm to 2.0 μm and the large size is preferably in the range from 10 μm to 30 μm.

(Single-sided Type Photothermographic Material)

The single-sided type photothermographic material of the present invention is favorably applied for an X-ray photosensitive material used for mammography.

To use the single-sided type photothermographic material for that purpose, it is very important to design the contrast of the obtained image in the suitable range.

The method to draw the photographic characteristic curve of the photothermographic material of the present invention is explained below. As for mammography, molybdenum target tube which emits a low pressure X-ray is usually employed as beam source. However, as far as the intensifying screen comprising substantially the fluorescent substance comprising Gd₂O₂S:Tb is used, the photographic characteristic curve obtained by changing the X-ray exposure value by the method of distance using the X-ray beam emitted by tungsten target tube as the beam source, may give substantially the same result obtained above.

Specifically for the measurement employed in the present invention, X-ray emitted from tungsten target tube operated by three-phase electric power supply at 50 KVp and penetrated through an aluminum plate having a thickness of 3 mm is used. The commercially availabe UM-Fine screen and the photosensitive material to be measured are made contact and installed in ECMA cassette produced by Fuji Photo Film Co., Ltd. After arranging so that the top plate of cassette, the photothermographic material and the screen may be set, from X-ray tube, in turn, X-ray irradiation is performed. By changing the X-ray exposure value by the method of distance, the assembly is subjected to exposure with a step wedge tablet having a width of 0.15 in terms of log E.

The exposed photothermographic material is thermally developed under the determined condition. Thereafter, density is measured, and then the photographic characteristic curve is obtained where the logarithm of radiation exposure value is plotted on abscissa axis, and the optical density is plotted on ordinate axis. The contrast is determined from the gradient (tan θ, when the angle to the abscissa axis is θ) of the straight line connecting the points at a density of fog+0.25 and a density of fog+2.0.

Next, the measuring method of the sensitivity of the photosensitive material is explained. As for the light source, a monochromatic light having the same wavelength as a main emission peak wavelength of the X-ray intensifying screen is employed. As a means of obtaining such a required monochromic light, a method using the filter system where interference filters are combined can be used. According to the aforesaid method, usually the monochromic light having a required exposure value and a half band width of 15±5 nm can be obtained easily, although it depends also on the combination of interference filters used.

The monochromic light whose intensity is correctly measured by an illuminometer in advance is employed as the light source. Thereby the photothermographic material is subjected to exposure with a step wedge tablet through a neutral filter for one second, where the photothermographic material and the light source are one meter apart. The density is measured after a thermal developing process, the sensitivity can be obtained by determining the exposure value required to give a density of fog+0.5 and can be expressed by Lux·second.

Preferred sensitivity of the photothermographic material used for mammography according to the invention is 1×10⁻⁶ watt·sec·m⁻² to 1×10⁻³ watt·sec·m⁻², and more preferably, 6×10⁻⁶ watt·sec·m⁻² to 6×10⁻⁴ watt·sec·m⁻².

Preferred contrast for the photothermographic material used for mammography according to the present invention is from 3.0 to 5.0.

The fluorescent intensifying screen for mammography used in the invention is explained in detail below. The X-ray intensifying screen used for photographic assembly of mammography used in the present invention is required to have high image sharpness in comparison with the conventional chest diagnosis. Generally, the image sharpness of commercially available X-ray intensifying screens used for mammography is usually enhanced by coloring the fluorescent screen layer. However, the light emitted by X-ray beam absorbed in the inner side of the fluorescent substance to the X-ray irradiation plane cannot effectively be taken out from the colored screen. For the X-ray intensifying screen according to the present invention, it is required to provide the intensifying screen coated with the amount of fluorescent substances enough to absorb X-ray and having high image sharpness without coloring the fluorescent substance layer substantially.

In order to attain the object of the aforesaid screen, the particle size of fluorescent substances preferably may be below a fixed size. The measurement of the particle size is performed by Coulter counter or observation through electron microscope. As for the preferred particle size of the fluorescent substance, the sphere equivalent diameter of the fluorescent substance particles is preferably in the range from 1 μm to 5 μm, and more preferably from 1 μm to 4 μm. Although the above condition is not important to the conventional intensifying screen for mammography whose fluorescent substance layer is colored, it is very important to the present invention.

Moreover, in order to raise the sharpness of the screen mentioned above, the use of fewer binders is preferred in regard to the weight ratio of binder to fluorescent substance in the fluorescent substance layer. The weight ratio of binder/fluorescent substance is preferably from 1/50 to 1/20, and more preferably from 1/50 to 1/25.

As for the binder, known substances described in JP-A No. 6-75097, from line 45 on right column at page 4 to line 10 on left column at page 5, can be employed. The thermoplastic elastomer having a softening temperature or a melting temperature of 30° C. to 150° C. can be preferably used alone or in combination with the other binder polymer. Especially for the screen of the present invention, which contains very small amount of binder to enhance the image sharpness, the proper selection of the binder used is very important to resist to the defect, because of the poor durability of the screen. It is desirable to choose entirely flexible binders as the solution for the defect. And also plasticizers and the like are preferably added in the fluorescent substance layer. As specific examples as the thermoplastic elastomer, polystyrenes, polyolefines, polyurethanes, polyesters, polyamides, polybutadienes, ethylene vinyl acetates, natural rubbers, fluorinated rubbers, polyisoprenes, ethylene chlorides, styrene-butadiene rubbers, silicone rubbers, and the like can be described. Among them, polyurethanes are particularly preferred. Moreover, the selection of the binder for the undercoat of the fluorescent substance layer is very important. Acrylate type binders are preferably employed.

To the allowable limit in respect to the anti-scratch and anti-stain properties of the screen, the thickness of the surface protective layer is preferably thin. The preferred thickness of the surface protective layer is in the range of from 2 μm to 7 μm.

As the materials for the surface protective layer of the screen, films such as PET (especially, stretched type), PEN, nylon and the like can be preferably stuck thereon. The surface protective layer of the screen is preferably formed by coating the fluorinated resins dissolved in a suitable solvent from the standpoint of preventing stain. The preferred embodiments of the fluorinated resins are described in detail in JP-A No. 6-75097, line 4 on left column at page 6 to line 43 on right column at the same page. As for specific examples of the resin suited for solvent coating type to form the surface protective layer, polyurethane resins, polyacrylate resins, cellulose derivatives, polymethyl methacrylates, polyester resins, epoxy resins and the like can be mentioned beside of the fluorinated resins described above.

Moreover, it is important that filling factor of the fluorescent substances is sufficiently high to obtain a screen with high image sharpness and high sensitivity. Specifically, the volume filling factor of the fluorescent substance is preferably from 60% to 80%, and more preferably from 65% to 80%. In order to keep the volume filling factor of fine particles of the fluorescent substances high as in the present invention, the compression processes of fluorescent substance layer described in JP-A No. 6-75097, line 29 on right column at page 4 to line 1 on left column at page 6, are preferably applied.

The fluorescent substance used in the present invention preferably comprises substantially Gd₂O₂S:Tb. The term “substantially” described here means that main component of the fluorescent substance is Gd₂O₂S:Tb, and several % of any other additives to improve the property of the screen, and silica and the like to decorate the surface can preferably be included. And also, in place of Gd, Y, La, and Lu can be possibly mixed inside the ratio of several ten %.

Generally, fluorescent substance having a heavy density is preferred to absorb X-ray effectively. As such fluorescent substance that shows a desirable X-ray absorption ability in beam source used for mammography, YTaO₄ and the one adding various kinds of activator as the emission center thereto, CaWO₄, BaFBr:Eu and the like are mentioned besides Gd₂O₂S:Tb.

(Combined use with Ultraviolet Fluorescent Screen)

As for the image forming method using photothermographic material according to the present invention, it is preferred that the image forming method is perfomed in combination with a fluorescent substance having a main emittion peak at 400 nm or lower. And more preferably, the image forming method is performed in combination with a fluorescent substance having a main emittion peak at 380 nm or lower. Either single-sided coated photosensitive material or double-sided coated photosensitive material can be applied for the assembly. As the screen having a main emittion peak at 400 nm or lower, the screens described in JP-A No. 6-11804 and WO No. 93/01521 and the like are used, but the present invention is not limited to these. As the techniques of crossover cut (for double-sided coated photosensitive material) and anti-halation (for single-sided coated photosensitive material) of ultraviolet light, the technique described in JP-A No. 8-76307 can be applied. As ultraviolet absorbing dyes, the dye described in JP-A No. 2001-144030 is particularly preferred.

The photothermographic material according to the invention may have a non-photosensitive layer in addition to the image forming layer. The non-photosensitive layers can be classified depending on the layer arrangement into (a) a surface protective layer provided on the image forming layer (on the side farther from the support), (b) an intermediate layer provided among plural image forming layers or between the image forming layer and the protective layer, (c) an undercoat layer provided between the image forming layer and the support, and (d) a back layer provided to the side opposite to the image forming layer.

Furthermore, a layer that functions as an optical filter may be provided as (a) or (b) above. An antihalation layer may be provided as (c) or (d) to the photothermographic material.

1) Surface Protective Layer

The photothermographic material of the invention may further comprise a surface protective layer with an object to prevent adhesion of the image forming layer. The surface protective layer may be a single layer, or plural layers. Description on the surface protective layer may be found in paragraph Nos. 0119 to 0120 of JP-A No. 11-65021 and in JP-A No. 2001-348546.

Preferred as the binder of the surface protective layer of the invention is gelatin, but polyvinyl alcohol (PVA) may be used preferably instead, or in combination. As gelatin, there can be used an inert gelatin (e.g., Nitta gelatin 750), a phthalated gelatin (e.g., Nitta gelatin 801), and the like.

Usable as PVA are those described in paragraph Nos. 0009 to 0020 of JP-A No. 2000-171936, and preferred are the completely saponified product PVA-105 and the partially saponified PVA-205 and PVA-335, as well as modified polyvinyl alcohol MP-203 (all trade name of products from Kuraray Ltd.).

The coating amount of polyvinyl alcohol (per 1 m² of support) in the protective layer (per one layer) is preferably in the range from 0.3 g/m² to 4.0 g/m² and, more preferably, from 0.3 g/m² to 2.0 g/m².

The coating amount of total binder (including water-soluble polymer and polymer latex) (per 1 m² of support) in the surface protective layer (per one layer) is preferably in the range from 0.3 g/m² to 5.0 g/m², and more preferably, from 0.3 g/m² to 2.0 g/m².

2) Antihalation Layer

The photothermographic material of the present invention may comprise an antihalation layer provided to the side farther from the light source with respect to the photosensitive layer. Descriptions on the antihalation layer can be found in paragraph Nos. 0123 to 0124 of JP-A No. 11-65021, in JP-A Nos. 11-223898, 9-230531, 10-36695, 10-104779, 11-231457, 11-352625, 11-352626, and the like.

The antihalation layer contains an antihalation dye having its absorption at the wavelength of the exposure light. In the case the exposure wavelength is in the infrared region, an infrared-absorbing dye may be used, and in such a case, preferred are dyes having no absorption in the visible region.

In the case of preventing halation from occurring by using a dye having absorption in the visible region, it is preferred that the color of the dye would not substantially reside after image formation, and is preferred to employ a means for bleaching color by the heat of thermal development; in particular, it is preferred to add a thermal bleaching dye and a base precursor to the non-photosensitive layer to impart function as an antihalation layer. Those techniques are described in JP-A No. 11-231457 and the like.

The addition amount of the bleaching dye is determined depending on the usage of the dye. In general, it is used at an amount as such that the optical density (absorbance) exceeds 0.1 when measured at the desired wavelength. The optical density is preferably in the range from 0.2 to 2. The addition amount of dyes to obtain optical density in the above range is generally from 0.001 g/m² to 1 g/m².

By decoloring the dye in such a manner, the optical density after thermal development can be lowered to 0.1 or lower. Two or more kinds of bleaching dyes may be used in combination in a photothermographic material. Similarly, two or more kinds of base precursors may be used in combination.

In the case of thermal decolorization by the combined use of a bleaching dye and a base precursor, it is advantageous from the viewpoint of thermal decolorization efficiency to further use the substance capable of lowering the melting point by at least 3° C. when mixed with the base precursor (e.g., diphenylsulfone, 4-chlorophenyl(phenyl)sulfone) as disclosed in JP-A No. 11-352626.

3) Back Layer

Back layers usable in the invention are described in paragraph Nos. 0128 to 0130 of JP-A No. 11-65021.

In the invention, coloring matters having maximum absorption in the wavelength range from 300 nm to 450 nm may be added in order to improve color tone of developed silver images and a deterioration of the images during aging. Such coloring matters are described in, for example, JP-A Nos. 62-210458, 63-104046, 63-103235, 63-208846, 63-306436, 63-314535, 01-61745, 2001-100363, and the like. Such coloring matters are generally added in the range from 0.1 mg/m² to 1 g/m², preferably to the back layer which is provided to the surface side opposite to the image forming layer.

4) Matting Agent

A matting agent may be preferably added to the surface protective layer and to the back layer in order to improve transportability. Description on the matting agent can be found in paragraphs Nos. 0126 to 0127 of JP-A No.11-65021.

The amount of adding the matting agents is preferably in the range from 1 mg/m² to 400 mg/m², and more preferably, from 5 mg/m² to 300 mg/m², with respect to the coating amount per 1 m² of the photothermographic material.

The mattness on the image forming layer surface is not restricted as far as star-dust trouble occurs, but the mattness of 30 seconds to 2000 seconds is preferred, particularly preferred, 40 seconds to 1500 seconds as Beck's smoothness. Beck's smoothness can be calculated easily, by seeing Japan Industrial Standared (JIS) P8119 “The method of testing Beck's smoothness for papers and sheets using Beck's test apparatus”, or TAPPI standard method T479.

The matting degree of the back layer in the invention is preferably in a range of 1200 seconds or less and 10 seconds or more; more preferably, 800 seconds or less and 20 seconds or more; most preferably, 500 seconds or less and 40 seconds or more when expressed by Beck smoothness.

In the present invention, a matting agent is preferably contained in an outermost layer, in a layer which can be function as an outermost layer, or in a layer nearer to outer surface, and also preferably is contained in a layer which can function as so-called protective layer.

5) Polymer Latex

A polymer latex can be incorporated in the surface protective layer and the back layer of the present invention.

As such polymer latex, descriptions can be found in “Gousei Jushi Emulsion (Synthetic resin emulsion)” (Taira Okuda and Hiroshi Inagaki, Eds., published by Koubunshi Kankoukai (1978)), “Gousei Latex no Ouyou (Application of synthetic latex)” (Takaaki Sugimura, Yasuo Kataoka, Souichi Suzuki, and Keiji Kasahara, Eds., published by Koubunshi Kankoukai (1993)), and “Gousei Latex no Kagaku (Chemistry of synthetic latex)” (Souichi Muroi, published by Koubunshi Kankoukai (1970)). More specifically, there can be mentioned a latex of methyl methacrylate(33.5% by weight)/ethyl acrylate(50% by weight)/methacrylic acid (16.5% by weight) copolymer, a latex of methyl methacrylate(47.5% by weight)/butadiene(47.5% by weight)/itaconic acid(5% by weight) copolymer, a latex of ethyl acrylate/methacrylic acid copolymer, a latex of methyl methacrylate(58.9% by weight)/2-ethylhexyl methacrylate(25.4% by weight)/styrene (8.6% by weight)/2-hydroethyl methacrylate(5.1% by weight)/acrylic acid(2.0% by weight) copolymer, a latex of methyl methacrylate(64.0% by weight)/styrene(9.0% by weight)/butyl acrylate(20.0% by weight)/2-hydroxyethyl methacrylate(5.0% by weight)/acrylic acid(2.0% by weight) copolymer, and the like.

The polymer latex is preferably contained in an amount of 10% by weight to 90% by weight, particularly preferably, of 20% by weight to 80% by weight of the total weight of binder (including water-soluble polymer and polymer latex) in the surface protective layer or the back layer.

6) Surface pH

The surface pH of the photothermographic material according to the invention preferably yields a pH of 7.0 or lower, more preferably, 6.6 or lower, before thermal developing process. Although there is no particular restriction concerning the lower limit, the lower limit of pH value is about 3, and the most preferred surface pH range is from 4 to 6.2.

From the viewpoint of reducing the surface pH, it is preferred to use an organic acid such as phthalic acid derivative or a non-volatile acid such as sulfuric acid, or a volatile base such as ammonia for the adjustment of the surface pH. In particular, ammonia can be used favorably for the achievement of low surface pH, because it can easily vaporize to remove it before the coating step or before applying thermal development.

It is also preferred to use a non-volatile base such as sodium hydroxide, potassium hydroxide, lithium hydroxide, and the like, in combination with ammonia. The method of measuring surface pH value is described in paragraph No. 0123 of the specification of JP-A No. 2000-284399.

7) Hardener

A hardener can be used in each of image forming layer, protective layer, back layer, and the like. As examples of the hardener, descriptions of various methods can be found in pages 77 to 87 of T. H. James, “THE THEORY OF THE PHOTOGRAPHIC PROCESS, FOURTH EDITION” (Macmillan Publishing Co., Inc., 1977). Preferably used are, in addition to chromium alum, sodium salt of 2,4-dichloro-6-hydroxy-s-triazine, N,N-ethylene bis(vinylsulfonacetamide), and N,N-propylene bis(vinylsulfonacetamide), polyvalent metal ions described in page 78 of the above literature and the like, polyisocyanates described in U.S. Pat. No. 4281060, JP-A No. 6-208193 and the like, epoxy compounds of U.S. Pat. No. 4791042 and the like, and vinyl sulfone based compounds of JP-A No. 62-89048.

The hardener is added as a solution, and the solution is added to the coating solution for forming the protective layer 180 minutes before coating to just before coating, preferably 60 minutes before to 10 seconds before coating. However, so long as the effect of the invention is sufficiently exhibited, there is no particular restriction concerning the mixing method and the conditions of mixing.

As specific mixing methods, there can be mentioned a method of mixing in the tank, in which the average stay time calculated from the flow rate of addition and the feed rate to the coater is controlled to yield a desired time, or a method using static mixer as described in Chapter 8 of N. Harnby, M. F. Edwards, A. W. Nienow (translated by Kouji Takahashi) “Liquid Mixing Technology” (Nikkan Kougyou Shinbunsha, 1989), and the like.

8) Surfactant

As the surfactant applicable in the invention, there can be mentioned those disclosed in paragraph No. 0132 of JP-A No. 11-65021.

In the invention, preferably used are fluorocarbon surfactants. Specific examples of fluorocarbon surfactants can be found in those described in JP-A Nos. 10-197985, 2000-19680, and 2000-214554. Polymer fluorocarbon surfactants described in JP-A 9-281636 can be also used preferably.

9) Antistatic Agent

The photothermographic material of the invention may contain an electrically conductive layer including various kinds of metal oxides or electrically conductive polymers known to the public. The antistatic layer may serve as an undercoat layer described above, or a back surface protective layer, and the like, but can also be placed specially. As to the antistatic layer, technologies described in paragraph No. 0135 of JP-A No. 11-65021, JP-A Nos. 56-143430, 56-143431, 58-62646, and 56-120519, and in paragraph Nos. 0040 to 0051 of JP-A No. 11-84573, U.S. Pat. No. 5575957, and in paragraph Nos. 0078 to 0084 of JP-A No. 11-223898 can be applied.

10) Support

As the transparent support, favorably used is polyester, particularly, polyethylene terephthalate, which is subjected to heat treatment in the temperature range from 130° C. to 185° C. in order to relax the internal strain caused by biaxial stretching and remaining inside the film, and to remove strain ascribed to heat shrinkage generated during thermal development.

As the support of the photothermographic material used in combination with the ultraviolet light emission screen, PEN is preferably used, but the present invention is not limited thereto. As the PEN, polyethylene-2,6-naphthalate is preferred. The “polyethylene-2,6-naphthalate” herein means that the structure repeating units essentially may consist of ethylene-2,6-naphthalene dicarboxylate groups and also may include un-copolymerized polyethylene-2,6-naphthalene dicarboxylate, and the copolymer comprising 10% or less, and preferably 5% or less, of the structure repeating units denatured with the other components and mixtures or constituents of other polymer.

Polyethylene-2,6-naphthalate can be synthesized by reacting a naphthalene-2,6-dicarboxylic acid or functional derivatives thereof, and an ethylene glycol or functional derivatives thereof in the presence of a suitable catalyst at proper reaction condition. The polyethylene-2,6-naphthalate of the present invention may be copolymerized or blended polysters, where one or more kinds of suitable third component (denaturing agent) is added before the completion of polymerization of the polyethylene-2,6-aphthalate. As the suitable third component, compounds containing a divalent ester forming functional group, for example, dicarboxylic acids such as oxalic acid, adipic acid, phthalic acid, isophthalic acid, terephthalic acid, naphthalene-2,7-dicarboxylic acid, succinic acid, diphenylether dicarboxylic acid and the like, or lower alkylesters thereof, oxycarboxylic acids such as p-oxybenzoic acid, p-oxyethoxybenzoic acid, or lower alkylesters thereof, and divalent alcohols such as propylene glycol, trimethylene glycol and the like are described. Polyethylene-2,6-naphthalate and the denatured polymers thereof may include, for example, the polymer where the terminal hydroxy group and/or the carboxylic group is blocked by mono-functional compounds such as benzoic acid, benzoyl benzoic acid, benzyloxy benzoic acid, methoxy polyalkylene glycol and the like, or the polymer denatured with a very small amount of compounds having tri-functional or tetra-functional ester forming group such as glycerine and penta-erthritol in the extent to form linear chain copolymers substantially.

In the case of a photothermographic material for medical use, the transparent support may be colored with a blue dye (for instance, dye-1 described in Examples of JP-A No. 8-240877), or may be uncolored.

Exemplified embodiments of the support are described in paragraph No. 0134 of JP-A No. 11-65021.

As to the support, it is preferred to apply undercoating technology, such as water-soluble polyester described in JP-A No. 11-84574, a styrene-butadiene copolymer described in JP-A No. 10-186565, a vinylidene chloride copolymer described in JP-A No. 2000-39684.

11) Other Additives

Furthermore, antioxidant, stabilizing agent, plasticizer, UV absorbent, or a film forming promoting agent may be added to the photothermographic material. A solvent described in paragraph No. 0133 of JP-A No. 11-65021 may be added. Each of the additives is added to either of the image forming layer (photosensitive layer) or the non-photosensitive layer. Reference can be made to WO No. 98/36322, EP No. 803764A1, JP-A Nos. 10-186567 and 10-18568, and the like.

12) Coating Method

The photothermographic material of the invention may be coated by any method. More specifically, various types of coating operations inclusive of extrusion coating, slide coating, curtain coating, immersion coating, knife coating, flow coating, or an extrusion coating using the kind of hopper described in U.S. Pat. No. 2681294 are used. Preferably used is extrusion coating or slide coating described in pages 399 to 536 of Stephen F. Kistler and Petert M. Schweizer, “LIQUID FILM COATING” (Chapman & Hall, 1997), and particularly preferably used is slide coating.

Example of the shape of the slide coater for use in slide coating is shown in FIG. 11b.1, page 427, of the same literature. If desired, two or more layers can be coated simultaneously by the method described in pages 399 to 536 of the same literature, or by the method described in U.S. Pat. No. 2761791 and British Patent No. 837095.

The coating solution for the layer containing organic silver salt in the invention is preferably a so-called thixotropic fluid. For the details of this technology, reference can be made to JP-A No. 11-52509.

Viscosity of the coating solution for the layer containing organic silver salt in the invention at a shear velocity of 0.1 S⁻¹ is preferably from 400 mPa·s to 100,000 mPa·s, and more preferably, from 500 mPa·s to 20,000 mPa·s.

At a shear velocity of 1000 S⁻¹, the viscosity is preferably from 1 mPa·s to 200 mPa·s, and more preferably, from 5 mPa·s to 80 mPa·s.

13) Wrapping Material

In order to suppress fluctuation from occurring on the photographic property during a preservation of the invention before thermal development, or in order to improve curling or winding tendencies when the photothermographic material is manufactured in a roll state, it is preferred that a wrapping material having low oxygen transmittance and/or vapor transmittance is used. Preferably, oxygen transmittance is 50 mL·atm⁻¹m⁻²day⁻¹ or lower at 25° C., more preferably, 10 mL·atm¹m²day⁻¹ or lower, and further preferably, 1.0 mL·atm⁻¹m⁻²day⁻¹ or lower. Preferably, vapor transmittance is 10 g·atm⁻¹m⁻²day⁻¹ or lower, more preferably, 5 g·atm⁻¹m⁻²day⁻¹ or lower, and further preferably, 1 g·atm⁻¹m⁻²day⁻¹ or lower. As specific examples of a wrapping material having low oxygen transmittance and/or vapor transmittance, reference can be made to, for instance, the wrapping material described in JP-A Nos. 8-254793 and 2000-206653.

14) Other Applicable Techniques

Techniques which can be used for the photothermographic material of the invention also include those in EP No. 803764A1, EP No. 883022A1, WO No. 98/36322, JP-A Nos. 56-62648, 58-62644, JP-A Nos. 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-20699, 2001-275471, 2001- 275461, 2000-313204, 2001-292844, 2000-324888, 2001- 293864 and 2001-348546.

15) Color Image Formation

The constitution of a multicolor photothermographic material may include combinations of two layers for those for each of the colors, or may contain all the components in a single layer as described in U.S. Pat. No. 4,708,928.

In the case of multicolor photothermographic material, each of the image forming layers is maintained distinguished from each other by incorporating functional or non-functional barrier layer between each of the photosensitive layers as described in U.S. Pat. No. 4460681.

3. Image Forming Method

3-1. Exposure

Although the photosensitive material of the invention may be subjected to exposure by any methods, laser beam is preferred as an exposure light source. Particularly, silver halide emulsion of high content of silver iodide had a problem having low photosensitivity, but this problem was solved with the use of high intensity like laser beam. And it made clear that it needs small amount of energy to record an image. Using thus strong light in a short time made it possible to achieve photosensitivity to the purpose.

Especially, for giving the exposure intensity to provide maximum density (Dmax), the light intensity on the surface of the photothermographic material is preferably in the range of 0.1 W/mm² to 100 W/mm², more preferably 0.5 W/mm² to 50 W/mm², and most preferably 1 W/mm² to 50 W/mm².

As laser beam according to the invention, preferably used are gas laser (Ar⁺, He—Ne, He—Cd), YAG laser, pigment laser and laser diode. Laser diode and second harmonics generator element can also be used. Preferred laser is determined corresponding to the peak absorption wavelength of spectral sensitizer and the like, but preferred is He—Ne laser of red through infrared emission, red laser diode, or Ar⁺, He—Ne, He—Cd laser of blue through green emission, blue laser diode. Meanwhile, modules having SHG (Second H ermonic Generator) chip and laser diode which are integrated, or blue laser diode have been espcially developed recently, and thus laser output devices for short wavelength region have attracted the attention. Blue laser diode has been expected as a light source with increasing demand hereafter because image recording with high definition is possible, and increased recording density, as well as stable output with longer operating life are enabled. The peak wavelength of laser beam is 350 nm to 500 nm, preferably 400 nm to 500 nm, of blue, or 600 nm to 900 nm, preferably 620 nm to 850 nm, of red to infrared.

Laser beam which oscillates in a longitudinal multiple modulation by a method such as high frequency superposition is also preferably employed.

3-2. Thermal Development

Although any method may be used for the development of the photothermographic material of the invention, the thermal development process is usually performed by elevating the temperature of the photothermographic material exposed imagewise. The temperature for the development is preferably in the range from 80° C. to 250° C., and more preferably, from 100° C. to 140° C.

Time period for development is preferably in the range from 1 second to 60 seconds, more preferably from 5 seconds to 30 seconds, and particularly preferably from 5 seconds to 20 seconds.

In the process for thermal development, plate type heater processes are preferred. Preferable process for thermal development by a plate type heater may be a process described in JP-A NO. 11-133572, which discloses a thermal developing device in which a visible image is obtained by bringing a photothermographic material with a formed latent image into contact with a heating means at a thermal developing portion, wherein the heating means comprises a plate heater, and plurality of retainer rollers are oppositely provided along one surface of the plate heater, the thermal developing device is characterized in that thermal development is performed by passing the photothermographic material between the retainer rollers and the plate heater. It is preferred that the plate heater is divided into 2 to 6 parts, with the leading end having the lower temperature by 1° C. to 10° C.

Such a process is also described in JP-A NO. 54-30032, which allows for excluding moisture and organic solvents included in the photothermographic material out of the system, and also allows for suppressing the change of shapes of the support of the photothermographic material upon rapid heating of the photothermographic material.

3-3. System

Examples of a medical laser imager equipped with a light exposing portion and a thermal developing portion include Fuji Medical Dry Laser Imager FM-DP L and DRYPIX 7000. Concerning FM-DP L, description is found in Fuji Medical Review, No. 8, pages 39 to 55, and these techniques can be applied. In addition, the present photothermographic material can be also applied as a photothermographic material for the laser imager used in “AD network” which was proposed by Fuji Film Medical Co., Ltd. as a network system accommodated to DICOM standard.

4. Application of the Invention

The image forming method in which the photothermographic material of the invention is used is preferably employed as image forming methods for photothermographic materials for use in medical imaging, photothermographic materials for use in industrial photographs, photothermographic materials for use in graphic arts, as well as for COM, through forming black and white images by silver imaging.

### EXAMPLES

The present invention is specifically explained by way of Examples below, which should not be construed as limiting the invention thereto.

The following Examples are expressed in the present form.

### Example 1

1. Preparation of PET Support and Undercoating

1-1. Film Manufacturing

PET having IV (intrinsic viscosity) of 0.66 (measured in phenol/tetrachloroethane=6/4 (weight ratio) at 25° C.) is obtained according to a conventional manner using terephthalic acid and ethylene glycol. The product is pelletized, dried at 130° C. for 4 hours, and colored blue with the blue dye (1,4-bis(2,6-diethylanilinoanthraquinone). Thereafter, the mixture is extruded from a T-die and rapidly cooled to form a non-tentered film.

The film is stretched along the longitudinal direction by 3.3 times using rollers of different peripheral speeds, and then stretched along the transverse direction by 4.5 times using a tenter machine. The temperatures used for these operations are 110° C. and 130° C., respectively. Then, the film is subjected to thermal fixation at 240° C. for 20 seconds, and relaxed by 4% along the transverse direction at the same temperature. Thereafter, the chucking part is slit off, and both edges of the film are knurled. Then the film is rolled up at the tension of 4 kg/cm² to obtain a roll having the thickness of 175 μm.

1-2. Surface Corona Discharge Treatment

Both surfaces of the support are treated at room temperature at 20 m/minute using Solid State Corona Discharge Treatment Machine Model 6KVA manufactured by Piller GmbH. It is proven that treatment of 0.375 kV·A·minute·m⁻² is executed, judging from the readings of current and voltage on that occasion. The frequency upon this treatment is 9.6 kHz, and the gap clearance between the electrode and dielectric roll is 1.6 mm.

1-3. Preparation of Undercoated Support

(1) Preparation of Coating Solution for Undercoat Layer

| | |
|---|---|
| Pesresin A-520 manufactured by Takamatsu Oil & Fat | 46.8 g |
| Co., Ltd. (30% by weight solution) | |
| BAIRONAARU MD-1200 manufactured by Touyou Bouseki | 10.4 g |
| Co., Ltd. | |
| Polyethylene glycol monononylphenylether (average | 11.0 g |
| ethylene oxide number = 8.5) 1% by weight solution | |
| MP-1000 manufactured by Soken Chemical & | 0.91 g |
| Engineering Co., Ltd. (PMMA polymer fine particle, mean | |
| particle diameter of 0.4 μm) | |
| distilled water | 931 mL |

(2) Undercoating

Both surfaces of the biaxially tentered polyethylene terephthalate support having the thickness of 175 μm are subjected to the corona discharge treatment as described above. Thereafter, the aforementioned coating solution for undercoating is coated with a wire bar so that the amount of wet coating becomes 6.6 mL/m² (per one side), and dried at 180° C. for 5 minutes. This is performed on both sides, and thus an undercoated support is produced.

2. Image Forming Layer, Intermediate Layer and Surface Protective Layer

2-1. Preparation of Coating Materials

1) Silver Halide Emulsion

<Preparation of Silver Halide Emulsion A (AgI Grains, Grain Size of 0.04 μm)>

To 1420 mL of distilled water is added 4.3 mL of a 1% by weight potassium iodide solution. Further, a liquid added with 3.5 mL of a 0.5 mol/L sulfuric acid and 36.7 g of phthalated gelatin is kept at 42° C. while stirring in a stainless steel reaction pot, and thereto are added total amount of: solution A prepared through diluting 22.22 g of silver nitrate by adding distilled water to give the volume of 195.6 mL; and solution B prepared through diluting 21.8 g of potassium iodide with distilled water to give the volume of 218 mL, over 9 minutes at a constant flow rate. Thereafter, 10 mL of a 3.5% by weight aqueous solution of hydrogen peroxide is added thereto, and 10.8 mL of a 10% by weight aqueous solution of benzimidazole is further added.

Moreover, a solution C prepared through diluting 51.86 g of silver nitrate by adding distilled water to give the volume of 317.5 mL and a solution D prepared through diluting 60 g of potassium iodide with distilled water to give the volume of 600 mL are added. A method of controlled double jet is executed through adding total amount of the solution C at a constant flow rate over 120 minutes, accompanied by adding the solution D while maintaining the pAg at 8.1. Hexachloroiridium (III) potassium salt is added in its entirety to give 1×10⁻⁴ mol per 1 mol of silver, at 10 minutes post initiation of the addition of the solution C and the solution D. Moreover, at 5 seconds after completing the addition of the solution C, a potassium iron (II) hexacyanide aqueous solution is added in its entirety to give 3×10⁻⁴ mol per 1 mol of silver. The mixture is adjusted to the pH of 3.8 with 0.5 mol/L sulfuric acid. After stopping stirring, the mixture is subjected to precipitation/desalting/water washing steps. The mixture is adjusted to the pH of 5.9 with 1 mol/L sodium hydroxide to produce a silver halide dispersion having the pAg of 8.0.

The above-mentioned silver halide dispersion is kept at 38° C. with stirring, and thereto is added 5 mL of a 0.34% by weight methanol solution of 1,2-benzoisothiazoline-3-one, followed by elevating the temperature to 47° C. At 20 minutes after elevating the temperature, sodium benzene thiosulfonate in a methanol solution is added at 7.6×10⁻⁵ mol per 1 mol of silver. At additional 5 minutes later, a tellurium sensitizer C in a methanol solution is added at 2.9×10⁻⁴ mol per 1 mol of silver and subjected to aging for 91 minutes.

Thereto is added 1.3 mL of a 0.8% by weight N,N′-dihydroxy-N″,N″-diethylmelamine in methanol, and at additional 4 minutes thereafter, 5-methyl-2-mercaptobenzimidazole in a methanol solution at 4.8×10⁻³ mol per 1 mol of silver, and 1-phenyl-2-heptyl-5-mercapto-1,3,4-triazole in a methanol solution at 5.4×10⁻³ mol per 1 mol of silver are added to produce a silver halide emulsion A.

Grains in the prepared silver halide emulsion are pure silver iodide grains having a mean sphere equivalent diameter of 0.040 μm, a variation coefficient of 18%, and tetradecahedral shaped grains having faces of (001), {100} and {101}. The ratio of γ phase is 30%, determined by powder X-ray diffraction analysis. Grain size and the like are determined from the average of 1000 grains using an electron microscope.

<Preparations of Silver Halide Emulsion B and C (AgI Grains, Grain Size of 0.08 μm and 0.16 μm)>

Preparations of silver halide emulsion B and C are conducted in a similar manner to the process in the preparation of the silver halide emulsion A except that controlling the reaction temperature and the addition speed of silver nitrate aqueous solution and potassium iodide aqueous solution. Grains in thus prepared silver halide emulsion B and C are pure silver iodide tetradecahedral shaped grains having a mean sphere equivalent diameter of 0.08 μm and 0.16 μm, respectively.

<Preparation of Silver Halide Emulsion D (Host Tabular AgI Grain, Grain Size of 0.42 μm)>

A solution is prepared by adding 4.3 mL of a 1% by weight potassium iodide solution, and then 3.5 mL of sulfuric acid at the concentration of 0.5 mol/L, 36.5 g of phthalated gelatin, and 160 mL of a 5% by weight methanol solution of 2,2′-(ethylene dithio)diethanol to 1421 mL of distilled water. The solution is kept at 75° C. while stirring in a stainless steel reaction pot, and thereto are added total amount of: solution A prepared through diluting 22.22 g of silver nitrate by adding distilled water to give the volume of 218 mL; and solution B prepared through diluting 36.6 g of potassium iodide with distilled water to give the volume of 366 mL. A method of controlled double jet is executed through adding total amount of the solution A at a constant flow rate over 16 minutes, accompanied by adding the solution B while maintaining the pAg at 10.2. Thereafter, 10 mL of a 3.5% by weight aqueous solution of hydrogen peroxide is added thereto, and 10.8 mL of a 10% by weight aqueous solution of benzimidazole is further added.

Moreover, a solution C prepared through diluting 51.86 g of silver nitrate by adding distilled water to give the volume of 508.2 mL and a solution D prepared through diluting 63.9 g of potassium iodide with distilled water to give the volume of 639 mL are added. A method of controlled double jet is executed through adding total amount of the solution C at a constant flow rate over 80 minutes, accompanied by adding the solution D while maintaining the pAg at 10.2. Hexachloroiridium (III) potassium salt is added in its entirety to give 1×10⁻⁴ mol per 1 mol of silver, at 10 minutes post initiation of the addition of the solution C and the solution D. Moreover, at 5 seconds after completing the addition of the solution C, a potassium iron (II) hexacyanide aqueous solution is added in its entirety to give 3×10⁻⁴ mol per 1 mol of silver. The mixture is adjusted to the pH of 3.8 with 0.5 mol/L sulfuric acid. After stopping stirring, the mixture is subjected to precipitation/ desalting/ water washing steps. The mixture is adjusted to the pH of 5.9 with 1 mol/L sodium hydroxide to produce a silver halide dispersion having the pAg of 11.0.

The silver halide emulsion D is a pure silver iodide emulsion, and in the silver halide emulsion D tabular grains having a mean projection area equivalent diameter of 0.93 μm, a variation coefficient of the mean projection area equivalent diameter of 17.7%, a mean thickness of 0.057 μm and a mean aspect ratio of 16.3 occupy 80% or more of the total projection area. The sphere equivalent diameter of the grains is 0.42 μm. 30% or more of the silver iodide exists in γ phase from the result of powder X-ray diffraction analysis.

<Preparation of Silver Halide Emulsion E (Epitaxial Grains, Grain Size of 0.42 μm)>

1 mol of the silver halide emulsion D prepared above is added to the reaction pot. pAg measured at 38° C. is 10.2. 0.5 mol/L potassium bromide solution and 0.5 mol/L silver nitrate solution are added at an addition speed of 10 mL/min over 20 minutes by the method of controlled double jet to precipitate substantially a 10 mol % of silver bromide on the host silver iodide grains as epitaxial form while keeping the pAg at 10.2 during the operation.

Furthermore, the mixture is adjusted to the pH of 3.8 with 0.5 mol/L sulfuric acid. After stopping stirring, the mixture is subjected to precipitation/desalting/water washing steps. The mixture is adjusted to the pH of 5.9 with 1 mol/L sodium hydroxide to produce a silver halide dispersion having the pAg of 11.0.

The above-mentioned silver halide dispersion is kept at 38° C. with stirring, and thereto is added 5 mL of a 0.34% by weight methanol solution of 1,2-benzoisothiazoline-3-one, and after 40 minutes the temperature is elevated to 47° C. At 20 minutes after elevating the temperature, sodium benzene thiosulfonate in a methanol solution is added at 7.6×10⁻⁵ mol per 1 mol of silver. At additional 5 minutes later, a tellurium sensitizer C in a methanol solution is added at 2.9×10⁻⁵ mol per 1 mol of silver and subjected to aging for 91 minutes. And then, 1.3 mL of a 0.8% by weight N,N′-dihydroxy-N″,N″-diethylmelamine in methanol is added thereto, and at additional 4 minutes thereafter, 5-methyl-2-mercaptobenzimidazole in a methanol solution at 4.8×10⁻³ mol per 1 mol of silver, 1-phenyl-2-heptyl-5-mercapto-1,3,4-triazole in a methanol solution at 5.4×10⁻³ mol per 1 mol of silver, and 1-(3-methylureido phenyl)-5-mercaptotetrazole in an aqueous solution at 8.5×10⁻³ mol per 1 mol of silver are added to produce a silver halide emulsion E.

<Preparation of Silver Halide Emulsion F (Host Tabular AgI Grains, Grain Size of 0.71 μm)>

Preparation of silver halide emulsion F is conducted in a similar manner to the process in the preparation of the silver halide emulsion D except that adequately changing the addition amount of a 5% by weight methanol solution of 2,2′-(ethylene dithio)diethanol, the temperature at grain formation step, and the time period for adding the solution A. The silver halide emulsion F is a pure silver iodide grain emulsion, and tabular grains having a mean projection area equivalent diameter of 1.384 μm, a variation coefficient of the mean projection area equivalent diameter of 19.7%, a mean thickness of 0.125 μm and a mean aspect ratio of 11.1 occupy 80% or more of the total projection area. The sphere equivalent diameter of the grains is 0.71 μm. 15% or more of the silver iodide exists in γ phase from the result of powder X-ray diffraction analysis.

21 Preparation of Silver Halide Emulsion G (Epitaxial Grains, Grain Size of 0.71 μm)>

Preparation of silver halide emulsion G is conducted in a similar manner to the process in the preparation of the silver halide emulsion E except that using silver halide emulsion F instead of using silver halide emulsion D. The silver halide emulsion G contains 10 mol % of epitaxial silver bromide.

<Preparation of Silver Halide Emulsion H (Host Tabular AgI Grains, Grain Size of 0.30 μm)>

Preparation of silver halide emulsion H is conducted in a similar manner to the process in the preparation of the silver halide emulsion D except that adequately changing the addition amount of a 5% by weight methanol solution of 2,2′-(ethylene dithio)diethanol, the temperature at grain formation step, and the time period for adding the solution A. The silver halide emulsion H is a pure silver iodide grain emulsion, and tabular grains having a mean projection area equivalent diameter of 0.565 μm, a variation coefficient of the mean projection area equivalent diameter of 18.5%, a mean thickness of 0.056 μm and a mean aspect ratio of 10.0 occupy 80% or more of the total projection area. The sphere equivalent diameter of the grains is 0.30 μm. 90% or more of the silver iodide exists in γ phase from the result of powder X-ray diffraction analysis.

<Preparation of Silver Halide Emulsion I (Epitaxial Grains, Grain Size of 0.30 μm)>

Preparation of silver halide emulsion I is conducted in a similar manner to the process in the preparation of the silver halide emulsion E except that using silver halide emulsion H instead of using silver halide emulsion D. The silver halide emulsion I contains 10 mol % of epitaxial silver bromide.

<Preparations of Emulsion A, B, C, E, G, and I for Coating Solution>

Each of the silver halide emulsion A, B, C, E, G, and I are dissolved, and thereto is added benzothiazolium iodide in a 1% by weight aqueous solution at 7×10⁻³ mol per 1 mol of silver. Further, as “a compound that can be one-electron-oxidized to provide a one-electron oxidation product, which releases one or more electrons” , the compounds Nos. 1, 2, and 3 are added respectively in an amount of 2×10⁻³ mol per 1 mol of silver in silver halide.

Thereafter, as “a compound having an adsorptive group and a reducible group”, the compound Nos. 1 and 2 are added respectively in an amount of 8×10⁻³ mol per 1 mol of silver halide.

Further, water is added thereto to give the content of silver halide of 15.6 g in terms of silver, per 1 liter of the mixed emulsion for a coating solution.

2) Preparation of Silver Salt of Fatty Acid

<Preparation of Recrystallized Behenic Acid>

Behenic acid manufactured by Henkel Co. (trade name: Edenor C22-85R) in an amount of 100 kg is admixed with 1200 kg of isopropyl alcohol, and dissolved at 50° C. The mixture is filtrated through a 10 μm filter, and cooled to 30° C. to allow recrystallization. Cooling speed for the recrystallization is controlled to be 3° C./hour. The resulting crystal is subjected to centrifugal filtration, and washing is performed with 100 kg of isopropyl alcohol. Thereafter, the crystal is dried. The resulting crystal is esterified, and subjected to GC-FID analysis to give the results of the content of behenic acid being 96 mol %, lignoceric acid 2 mol %, and arachidic acid 2 mol %. In addition, erucic acid is included at 0.001 mol % or less.

<Preparation of Dispersion of Silver Salt of Fatty Acid>

88 kg of recrystallized behenic acid, 422 L of distilled water, 49.2 L of an aqueous sodium hydroxide solution at the concentration of 5 mol/L, 120 L of t-butyl alcohol are admixed, and subjected to a reaction with stirring at 75° C. for one hour to give a solution of sodium behenate. Separately, 206.2 L of an aqueous solution of 40.4 kg of silver nitrate (pH 4.0) is provided, and kept at a temperature of 10° C. A reaction vessel charged with 635 L of distilled water and 30 L of t-butyl alcohol is kept at 30° C., and thereto are added the total amount of the solution of sodium behenate and the total amount of the aqueous silver nitrate solution with sufficient stirring at a constant flow rate over 93 minutes and 15 seconds, and 90 minutes, respectively. Upon this operation, during first 11 minutes following the initiation of adding the aqueous silver nitrate solution, the added material is restricted to the aqueous silver nitrate solution alone. The addition of the solution of sodium behenate is thereafter started, and during 14 minutes and 15 seconds following the completion of adding the aqueous silver nitrate solution, the added material is restricted to the solution of sodium behenate alone. The temperature inside of the reaction vessel is then set to be 30° C., and the temperature outside is controlled so that the liquid temperature could be kept constant. In addition, the temperature of a pipeline for the addition system of the solution of sodium behenate is kept constant by circulation of warm water outside of a double wall pipe, so that the temperature of the liquid at an outlet in the leading edge of the nozzle for addition is adjusted to be 75° C. Further, the temperature of a pipeline for the addition system of the aqueous silver nitrate solution is kept constant by circulation of cool water outside of a double wall pipe. Position at which the solution of sodium behenate is added and the position, at which the aqueous silver nitrate solution is added, is arranged symmetrically with a shaft for stirring located at a center. Moreover, both of the positions are adjusted to avoid contact with the reaction liquid.

After completing the addition of the solution of sodium behenate, the mixture is left to stand at the temperature as it is for 20 minutes. The temperature of the mixture is then elevated to 35° C. over 30 minutes followed by aging for 210 minutes. Immediately after completing the aging, solid matters are filtered out with centrifugal filtration. The solid matters are washed with water until the electric conductivity of the filtrated water becomes 30 μS/cm. A silver salt of fatty acid is thus obtained. The resulting solid matters are stored as a wet cake without drying.

When the shape of the resulting particles of the silver behenate is evaluated by an electron micrography, a crystal is revealed having a=0.21 μm, b=0.4 μm and c=0.4 μm on the average value, with a mean aspect ratio of 2.1, and a variation coefficient of 11% (a, b and c are as defined aforementioned.).

To the wet cake corresponding to 260 kg of a dry solid matter content, are added 19.3 kg of polyvinyl alcohol (trade name: PVA-217) and water to give the total amount of 1000 kg. Then, a slurry is obtained from the mixture using a dissolver blade. Additionally, the slurry is subjected to preliminary dispersion with a pipeline mixer (manufactured by MIZUHO Industrial Co., Ltd.: PM-10 type).

Next, a stock liquid after the preliminary dispersion is treated three times using a dispersing machine (trade name: Microfluidizer M-610, manufactured by Microfluidex International Corporation, using Z type Interaction Chamber) with the pressure controlled to be 1150 kg/cm² to give a dispersion of the silver behenate. For the cooling manipulation, coiled heat exchangers are equipped in front of and behind the interaction chamber respectively, and accordingly, the temperature for the dispersion is set to be 18° C. by regulating the temperature of the cooling medium.

3) Preparation of Reducing Agent Dispersion

<Preparation of Reducing Agent-1 Dispersion>

To 10 kg of reducing agent-1 (1,1-bis(2-hydroxy-3,5-dimethylphenyl)-3,5,5-trimethylhexane) and 16 kg of a 10% by weight aqueous solution of modified polyvinyl alcohol (manufactured by Kuraray Co., Ltd., Poval MP203) is added 10 kg of water, and thoroughly mixed to give a slurry. This slurry is fed with a diaphragm pump, and is subjected to dispersion with a horizontal sand mill (UVM-2: manufactured by IMEX Co., Ltd.) packed with zirconia beads having a mean particle diameter of 0.5 mm for 3 hours. Thereafter, 0.2 g of a benzoisothiazolinone sodium salt and water are added thereto, thereby adjusting the concentration of the reducing agent to be 25% by weight. This dispersion is subjected to heat treatment at 60° C. for 5 hours to obtain reducing agent-1 dispersion. Particles of the reducing agent included in the resulting reducing agent dispersion have a median diameter of 0.40 μm, and a maximum particle diameter of 1.4 μm or less. The resultant reducing agent dispersion is subjected to filtration with a polypropylene filter having a pore size of 3.0 μm to remove foreign substances such as dust, and stored.

4) Preparation of Hydrogen Bonding Compound Dispersion

To 10 kg of hydrogen bonding compound-1 (tri(4-t-butylphenyl)phosphineoxide) and 16 kg of a 10% by weight aqueous solution of modified polyvinyl alcohol (manufactured by Kuraray Co., Ltd., Poval MP203) is added 10 kg of water, and thoroughly mixed to give a slurry. This slurry is fed with a diaphragm pump, and is subjected to dispersion with a horizontal sand mill (UVM-2: manufactured by IMEX Co., Ltd.) packed with zirconia beads having a mean particle diameter of 0.5 mm for 4 hours. Thereafter, 0.2 g of a benzoisothiazolinone sodium salt and water are added thereto, thereby adjusting the concentration of the hydrogen bonding compound to be 25% by weight. This dispersion is warmed at 40° C. for one hour, followed by a subsequent heat treatment at 80° C. for one hour to obtain hydrogen bonding compound-1 dispersion. Particles of the hydrogen bonding compound included in the resulting hydrogen bonding compound dispersion have a median diameter of 0.45 μm, and a maximum particle diameter of 1.3 μm or less. The resultant hydrogen bonding compound dispersion is subjected to filtration with a polypropylene filter having a pore size of 3.0 μm to remove foreign substances such as dust, and stored.

5) Preparations of Dispersions of Development Accelerator and Color-tone-adjusting Agent

<Preparation of Development Accelerator-1 Dispersion>

To 10 kg of development accelerator-1 and 20 kg of a 10% by weight aqueous solution of modified polyvinyl alcohol (manufactured by Kuraray Co., Ltd., Poval MP203) is added 10 kg of water, and thoroughly mixed to give a slurry. This slurry is fed with a diaphragm pump, and is subjected to dispersion with a horizontal sand mill (UVM-2: manufactured by IMEX Co., Ltd.) packed with zirconia beads having a mean particle diameter of 0.5 mm for 3 hours and 30 minuets. Thereafter, 0.2 g of a benzoisothiazolinone sodium salt and water are added thereto, thereby adjusting the concentration of the development accelerator to be 20% by weight. Accordingly, development accelerator-1 dispersion is obtained. Particles of the development accelerator included in the resulting development accelerator dispersion have a median diameter of 0.48 μm, and a maximum particle diameter of 1.4 μm or less. The resultant development accelerator dispersion is subjected to filtration with a polypropylene filter having a pore size of 3.0 μm to remove foreign substances such as dust, and stored.

<Preparations of Solid Dispersions of Development Accelerator-2 and Color-tone-adjusting Agent-1>

Also concerning solid dispersions of development accelerator-2 and color-tone-adjusting agent-1, dispersion is executed in a similar manner to the development accelerator-1, and thus dispersions of 20% by weight and 15% by weight are respectively obtained.

6) Preparations of Organic Polyhalogen Compound Dispersion

<Preparation of Organic Polyhalogen Compound-1 Dispersion>

10 kg of organic polyhalogen compound-1 (tribromomethane sulfonylbenzene), 10 kg of a 20% by weight aqueous solution of modified polyvinyl alcohol (manufactured by Kuraray Co., Ltd., Poval MP203), 0.4 kg of a 20% by weight aqueous solution of sodium triisopropylnaphthalenesulfonate and 14 kg of water are thoroughly admixed to give a slurry. This slurry is fed with a diaphragm pump, and is subjected to dispersion with a horizontal sand mill (UVM-2: manufactured by IMEX Co., Ltd.) packed with zirconia beads having a mean particle diameter of 0.5 mm for 5 hours. Thereafter, 0.2 g of a benzoisothiazolinone sodium salt and water are added thereto, thereby adjusting the concentration of the organic polyhalogen compound to be 30% by weight. Accordingly, organic polyhalogen compound-1 dispersion is obtained. Particles of the organic polyhalogen compound included in the resulting organic polyhalogen compound dispersion have a median diameter of 0.41 μm, and a maximum particle diameter of 2.0 μm or less. The resultant organic polyhalogen compound dispersion is subjected to filtration with a polypropylene filter having a pore size of 10.0 μm to remove foreign substances such as dust, and stored.

<Preparation of Organic Polyhalogen Compound-2 Dispersion>

10 kg of organic polyhalogen compound-2 (N-butyl-3-tribromomethane sulfonylbenzoamide), 20 kg of a 10% by weight aqueous solution of modified polyvinyl alcohol (manufactured by Kuraray Co., Ltd., Poval MP203) and 0.4 kg of a 20% by weight aqueous solution of sodium triisopropylnaphthalenesulfonate are thoroughly admixed to give a slurry. This slurry is fed with a diaphragm pump, and is subjected to dispersion with a horizontal sand mill (UVM-2: manufactured by IMEX Co., Ltd.) packed with zirconia beads having a mean particle diameter of 0.5 mm for 5 hours. Thereafter, 0.2 g of a benzoisothiazolinone sodium salt and water are added thereto, thereby adjusting the concentration of the organic polyhalogen compound to be 30% by weight. This fluid dispersion is heated at 40° C. for 5 hours to obtain organic polyhalogen compound-2 dispersion. Particles of the organic polyhalogen compound included in the resulting organic polyhalogen compound dispersion have a median diameter of 0.40 μm, and a maximum particle diameter of 1.3 μm or less. The resultant organic polyhalogen compound dispersion is subjected to filtration with a polypropylene filter having a pore size of 3.0 μm to remove foreign substances such as dust, and stored.

7) Preparation of Silver Iodide Complex Forming Agent

8 kg of modified polyvinyl alcohol MP203 is dissolved in 174.57 kg of water, and thereto are added 3.15 kg of a 20% by weight aqueous solution of sodium triisopropylnaphthalenesulfonate and 14.28 kg of a 70% by weight aqueous solution of 6-isopropylphthalazine. Accordingly, a 5% by weight solution of silver iodide complex forming agent compound is prepared.

8) Preparations of Aqueous Solution of Mercapto Compound

<Preparation of Aqueous Solution of Mercapto Compound-1>

Mercapto compound-1 (1-(3-sulfophenyl)-5-mercaptotetrazole sodium salt) in an amount of 7 g is dissolved in 993 g of water to give a 0.7% by weight aqueous solution.

<Preparation of Aqueous Solution of Mercapto Compound-2>

Mercapto compound-2 (1-(3-methylureidophenyl)-5-mercaptotetrazole) in an amount of 20 g is dissolved in 980 g of water to give a 2.0% by weight aqueous solution.

9) Preparation of SBR Latex Solution

To a polymerization tank of a gas monomer reaction apparatus (manufactured by Taiatsu Techno Corporation, TAS-2J type), are charged 287 g of distilled water, 7.73 g of a surfactant (Pionin A-43-S (manufactured by TAKEMOTO OIL & FAT CO., LTD.): solid matter content of 48.5% by weight), 14.06 mL of 1 mol/L sodium hydroxide, 0.15 g of ethylenediamine tetraacetate tetrasodium salt, 255 g of styrene, 11.25 g of acrylic acid, and 3.0 g of tert-dodecyl mercaptan, followed by sealing of the reaction vessel and stirring at a stirring rate of 200 rpm. Degassing is conducted with a vacuum pump, followed by repeating nitrogen gas replacement several times. Thereto is injected 108.75 g of 1,3-butadiene, and the inner temperature is elevated to 60° C. Thereto is added a solution of 1.875 g of ammonium persulfate dissolved in 50 mL of water, and the mixture is stirred for 5 hours as it stands. The temperature is further elevated to 90° C., followed by stirring for 3 hours. After completing the reaction, the inner temperature is lowered to reach to the room temperature, and thereafter the mixture is treated by adding 1 mol/L sodium hydroxide and ammonium hydroxide to give the molar ration of Na⁺ ion : NH₄⁺, ion=1:5.3, and thus, the pH of the mixture is adjusted to 8.4. Thereafter, filtration with a polypropylene filter having the pore size of 1.0 μm is conducted to remove foreign substances such as dust followed by storage. Accordingly, SBR latex is obtained in an amount of 774.7 g. Upon the measurement of halogen ion by ion chromatography, concentration of chloride ion is revealed to be 3 ppm. As a result of the measurement of the concentration of the chelating agent by high performance liquid chromatography, it is revealed to be 145 ppm.

The aforementioned latex has a mean particle diameter of 90 nm, Tg of 17° C., solid matter concentration of 44% by weight, the equilibrium moisture content at 25° C. and 60%RH of 0.6% by weight, ionic conductance of 4.80 mS/cm (measurement of the ionic conductance performed using a conductivity meter CM-30S manufactured by Toa Electronics Ltd. for the latex stock solution (44% by weight) at 25° C.) and pH of 8.4.

10) Preparation of Nucleator Dispersion

2.5 g of polyvinyl alcohol (manufactured by Kuraray Co., Ltd., PVA-217) and 87.5 g of water are added to 10 g of the nucleator shown in Table 1, and thoroughly admixed to give a slurry. This slurry is allowed to stand for 3 hours. Zirconia beads having a mean particle diameter of 0.5 mm are provided in an amount of 240 g, and charged in a vessel with the slurry. Dispersion is performed with a dispersing machine (1/4G sand grinder mill: manufactured by IMEX Co., Ltd.) for 10 hours to obtain a solid fine particle dispersion of nucleator. Particles of the nucleator included in the resulting nucleator dispersion have a mean particle diameter of 0.5 μm, and 80% by weight of the particles has a particle diameter of 0.1 μm to 1.0 μm.

2-2. Preparations of Coating Solutions

1) Preparations of Coating Solution for Image Forming Layer

To the dispersion of the silver salt of fatty acid obtained as described above in an amount of 1000 g and 276 mL of water are serially added the organic polyhalogen compound-1 dispersion, the organic polyhalogen compound-2 dispersion, the SBR latex (Tg: 17° C.) solution, the reducing agent-1 dispersion, the nucleator dispersion (kind and addition amount of the nucleator are shown in Table 1), the hydrogen bonding compound-1 dispersion, the development accelerator-1 dispersion, the development accelerator-2 dispersion, the color-tone-adjusting agent-1 dispersion, the mercapto compound-1 aqueous solution, and the mercapto compound-2 aqueous solution. After adding thereto the silver iodide complex forming agent, the silver halide emulsion for coating solution A, B, C, E, G, or I is added thereto in an amount of 0.22 mol per 1 mol of silver salt of fatty acid, followed by thorough mixing just prior to the coating, which is fed directly to a coating die, and is coated.

Viscosity of the aforementioned coating solution for the image forming layer is measured with a B type viscometer from Tokyo Keiki, and is revealed to be 25 [mPa·s] at 40° C. (No. 1 rotor, 60 rpm).

Viscosity of the coating solution at 25° C. when it is measured using RFS fluid spectrometer manufactured by Rheometrix Far-East Co. Ltd. is 242, 65, 48, 26, and 20 [mPa·s], respectively, at the shearing rate of 0.1, 1, 10, 100, 1000 [1/second].

The amount of zirconium in the coating solution is 0.52 mg per 1 g of silver.

2) Preparation of Coating Solution for Intermediate Layer

To 1000 g of polyvinyl alcohol PVA-205 (manufactured by Kuraray Co., Ltd.), and 4200 mL of a 19% by weight solution of methyl methacrylate/styrene/butyl acrylate/hydroxyethyl methacrylate/acrylic acid copolymer (weight ratio of the copolymerization of 64/9/20/5/2) latex, are added 27 mL of a 5% by weight aqueous solution of aerosol OT (manufactured by American Cyanamid Co.), 135 mL of a 20% by weight aqueous solution of ammonium secondary phthalate and water to give total amount of 10000 g. The mixture is adjusted with sodium hydroxide to give the pH of 7.5. Accordingly, the coating solution for the intermediate layer is prepared, and is fed to a coating die to provide 9.1 mL/m².

Viscosity of the coating solution is 58 [mPa·s] which is measured with a B type viscometer at 40° C. (No. 1 rotor, 60 rpm).

3) Preparation of Coating Solution for First Layer of Surface Protective Layers

In water is dissolved 64 g of inert gelatin, and thereto are added 112 g of a 19.0% by weight solution of methyl methacrylate/styrene/butyl acrylate/hydroxyethyl methacrylate/acrylic acid copolymer (weight ratio of the copolymerization of 64/9/20/5/2) latex, 30 mL of a 15% by weight methanol solution of phthalic acid, 23 mL of a 10% by weight aqueous solution of 4-metyl phthalic acid, 28 mL of 0.5 mol/L sulfuric acid, 5 mL of a 5% by weight aqueous solution of aerosol OT (manufactured by American Cyanamid Co.), 0.5 g of phenoxyethyl alcohol, and 0.1 g of benzoisothiazolinone. Water is added to give total amount of 750 g. Immediately before coating, 26 mL of a 4% by weight chrome alum which has been mixed with a static mixer is fed to a coating die so that the amount of the coating solution becomes 18.6 mL/m².

Viscosity of the coating solution is 20 [mPa·s] which is measured with a B type viscometer at 40° C. (No. 1 rotor, 60 rpm).

4) Preparation of Coating Solution for Second Layer of Surface Protective Layers

In water is dissolved 80 g of inert gelatin and thereto are added 102 g of a 27.5% by weight solution of methyl methacrylate/styrene/butyl acrylate/hydroxyethyl methacrylate/acrylic acid copolymer (weight ratio of the copolymerization of 64/9/20/5/2) latex, 5.4 mL of a 2% by weight solution of a fluorocarbon surfactant (F-1), 5.4 mL of a 2% by weight aqueous solution of another fluorocarbon surfactant (F-2), 23 mL of a 5% by weight aqueous solution of aerosol OT (manufactured by American Cyanamid Co.), 4 g of polymethyl methacrylate fine particles (mean particle diameter of 0.7 μm, distribution of volume weighted average being 30%) and 21 g of polymethyl methacrylate fine particles (mean particle diameter of 3.6 μm, distribution of volume weighted average being 60%), 1.6 g of 4-methyl phthalic acid, 4.8 g of phthalic acid, 44 mL of 0.5 mol/L sulfuric acid, and 10 mg of benzoisothiazolinone. Water is added to give total amount of 650 g. Immediately before coating, 445 mL of a aqueous solution containing 4% by weight chrome alum and 0.67% by weight phthalic acid are added and admixed with a static mixer to give a coating solution for the second layer of the surface protective layers, which is fed to a coating die so that 8.3 mL/m² could be provided.

Viscosity of the coating solution is 19 [mPa·s] which is measured with a B type viscometer at 40° C. (No. 1 rotor, 60 rpm).

2-3. Preparations of Photothermographic Material-1 to -12

Simultaneous overlaying coating by a slide bead coating method is subjected in order of the image forming layer, intermediate layer, first layer of the surface protective layers and second layer of the surface protective layers, starting from the undercoated face, and thus sample-1 to -12 of the photothermographic materials are produced. In this method, the temperature of the coating solution is adjusted to 31° C. for the image forming layer and intermediate layer, to 36° C. for the first layer of the surface protective layers, and to 37° C. for the second layer of the surface protective layers. The coating amount of silver in the image forming layer is 0.821 g/m² per one side with respect to total amount of silver contained in silver salt of fatty acid and silver halide. This coating is performed on both sides of the support.

The coating amount of each compound (g/m²) for the image forming layer per one side is as follows.

| | |
|---|---|
| Silver salt of fatty acid | 2.80 |
| Organic polyhalogen compound-1 | 0.028 |
| Organic polyhalogen compound-2 | 0.094 |
| Silver iodide complex forming agent | 0.46 |
| SBR latex | 5.20 |
| Reducing agent-1 | 0.46 |
| Nucleator | (see Table 1) |
| Hydrogen bonding compound-1 | 0.15 |
| Development accelerator-1 | 0.005 |
| Development accelerator-2 | 0.035 |
| Color-tone-adjusting agent-1 | 0.002 |
| Mercapto compound-1 | 0.001 |
| Mercapto compound-2 | 0.003 |
| Silver halide (on the basis of Ag content) | 0.146 |

Conditions for coating and drying are as follows.

The support is decharged by ionic wind. Coating is performed at the speed of 160 m/min.

Conditions for coating and drying are adjusted within the range described below, and conditions are set to obtain the most stable surface state.

The clearance between the leading end of the coating die and the support is 0.10 mm to 0.30 mm.

The pressure in the vacuum chamber is set to be lower than atmospheric pressure by 196 Pa to 882 Pa.

In the subsequent cooling zone, the coating solution is cooled by wind having the dry-bulb temperature of 10° C. to 20° C.

Transportation with no contact is carried out, and the coated support is dried with an air of the dry-bulb of 23° C. to 45° C. and the wet-bulb of 15° C. to 21° C. in a helical type contactless drying apparatus.

After drying, moisture conditioning is performed at 25° C. in the humidity of 40% RH to 60% RH.

Then, the film surface is heated to be 70° C. to 90° C., and after heating, the film surface is cooled to 25° C.

Thus prepared photothermographic material has the matness of 250 seconds as Beck's smoothness. In addition, measurement of the pH of the film surface on the image forming layer side surface gives the result of 6.0.

Chemical structures of the compounds used in Examples of the invention are shown below.
Tellurium Sensitizer C 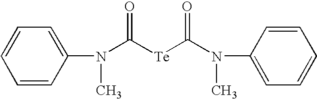
Compound 1 that can be one-electron-oxidized to provide a one-electron oxidation product which releases one or more electrons 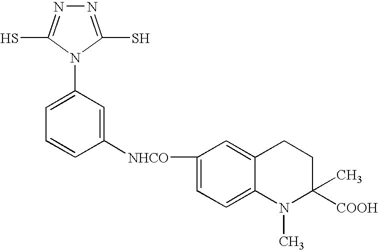
Compound 2 that can be one-electron-oxidized to provide a one-electron oxidation product which releases one or more electrons 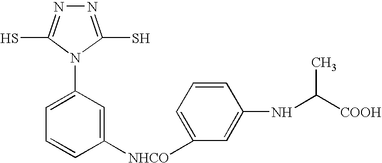
Compound 3 that can be one-electron-oxidized to provide a one-electron oxidation product which releases one or more electrons 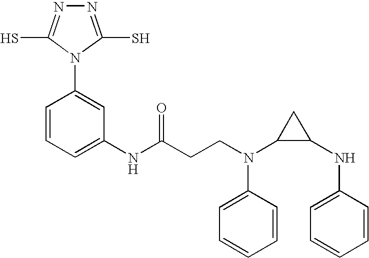
Compound 1 having adsorptive group and reducible group

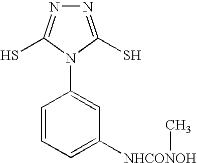

Compound 2 having adsorptive group and reducible group

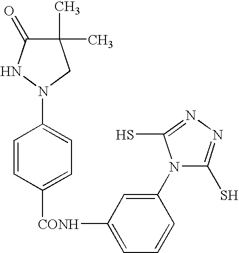

Reducing agent-1

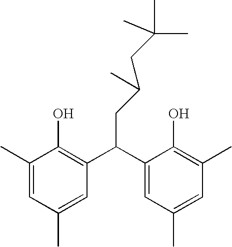

Hydrogen bonding compound-1

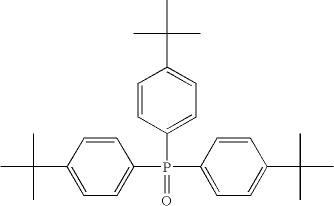

Organic polyhalogen
compound-1

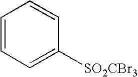

Organic polyhalogen
compound-2

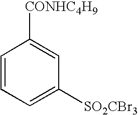

Mercapto compound-1

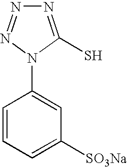

Mercapto compound-2

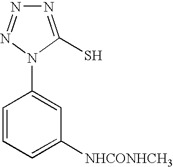

Silver iodide complex
forming agent

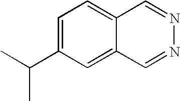

Development accelerator-1

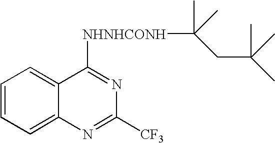

Development accelerator-2

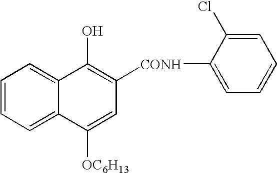

Color-tone-adjusting
agent-1

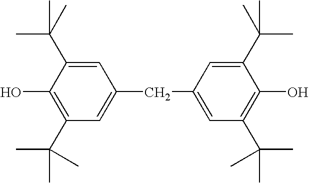

(F-1)

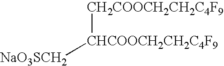

(F-2)

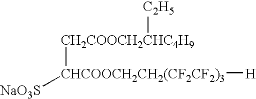

3. Evaluation of Photographic Properties
3-1. Preparation

The resulting sample is cut into a half-cut size (43 cm in length×35 cm in width), and is wrapped with the following packaging material under an environment of 25° C. and 50% RH, and stored for 2 weeks at an ambient temperature.

<Packaging Material>

A film laminated with PET 10 μm/PE 12 μm/aluminum foil 9 μm/Ny 15 μm/polyethylene 50 μm containing carbon at 3% by weight:
oxygen permeability at 25° C: 0.02 mL·atm⁻¹m⁻²day⁻¹,
vapor permeability at 25° C: 0.10 g·atm⁻¹m⁻²day⁻.
   3-2. Condition of Evaluation

1) Measurement of Haze Degree of Film

The “haze degree” indicates the degree of diffusion of the light incident to a photosensitive material, and the ratio of the amount of diffused transmitted light to total amount of transmitted light is expressed in percentage. The haze measuring apparatus Model 1001DP produced by NIPPON DENSHOKU Co., Ltd. is used for the measurement of haze degree.

The haze degree of the film is measured before and after thermal development of each unexposed sample.

Thermal development condition: Thermal developing portion of Fuji Medical Dry Laser Imager FM-DP L is modified so that it can heat from both sides. And by another modification, the transportation rollers in the thermal developing portion are changed to the heating drum so that the sheet of film can be conveyed. The temperature of four panel heaters are set to 112° C.-118° C.-120° C.-120° C., and the temperature of the heating drum is set to 120° C. By adjusting the transportation speed, the total time period for thermal development is set to be 24 seconds.

2) Observation of the Numbers of Silver Halide Grains and Developed Silver Grains in the Film through Electron Microscope

The ultrathin slices of film obtained from maximum density part of individual samples before and after thermal development are observed through a transmission electron microscope.

Observation condition: The ultrathin slice having a thickness around 0.1 μm is prepared by cutting the samples using a diamond knife.

The numbers of silver halide grains and developed silver grains are obtained by counting the numbers of the grains which exist in unit area calculated from the thickness and the length of the slice of film at maximum density part before and after thermal development.

By the using the obtained numbers of silver halide grains and developed silver grains, and the coating amount of silver obtained by measuring the samples before thermal development using a conventional method (fluorescent X-ray analysis), the ratio of the coating amount of silver/the number of silver halide grains (g/grain), and the ratio of the number of developed silver grains/the number of silver halide grains are calculated.

3) Determination of Volume Occupied by Silver Halide Grains in the Image Forming Layer

By counting the number of silver halide grains existed in unit volume of the image forming layer calculated from the thickness and area of the slice of film before thermal development, the occupied volume by silver halide grains in the image forming layer is determined.

4) Evaluation of Photographic Properties

Two sets of X-ray regular screen HI-SCREEN B3 (CaWO₄ is used as fluorescent substance, the emission peak wavelength of 425 nm) produced by Fuji Photo Film Co., Ltd. are used, and the assembly for image formation is provided by inserting the sample between them. This assembly is subjected to X-ray exposure for 0.05 seconds, and then X-ray sensitometry is performed. The X-ray apparatus used is DRX-3724HD (trade name) produced by Toshiba Corp., and a tungsten target tube is used. X-ray emitted by a pulse generator operated at three phase voltage of 80 kVp and penetrated through a filter comprising 7 cm thickness of water having the absorption ability almost the same as human body is used as the light source. By the method of distance, varying the exposure value of X-ray, the sample is subjected to exposure with a step wedge tablet having a width of 0.15 in terms of log E. After exposure, the exposed sample is subjected to thermal development with the condition mentioned below, and then the obtained image is evaluated by a densitometer.

The thermal developing portion of Fuji Medical Dry Laser Imager FM-DP L is modified so that it can heat from both sides, and by another modification the transportation rollers in the thermal developing portion are changed to the heating drum so that the sheet of film can be conveyed. The temperature of four panel heaters are set to 112° C.-118° C.-120° C.-120° C., and the temperature of the heating drum is set to 120° C. The total time period for thermal development is set to be 24 seconds.

Fog: Fog is expressed in terms of the density of the unexposed part.

Sensitivity: Sensitivity is expressed in terms of a relative value based on the sensitivity obtained for sample-5, which is taken as 100.

Dmax: Dmax is a maximum density obtained with increasing the exposure value.

Average gradient: Average gradient is expressed in terms of a gradient of a straight line connecting the points at a density of fog+0.25 and a density of fog+2.0 (if the angle between the straight line and the abscissa is θ, then tan θ) on the photographic characteristic curve.

Graininess: Graininess is evaluated with visual observation by rating the degree according to the criteria; ◯, Δ, and X.

3-3. Results of Evaluation

The results obtained are shown in Table 2.

From the results shown in Table 2, it is understood that the photothermographic material of the invention (sample-4 to -6) has high sensitivity, high density and a gradation suitable for medical diagnosis and is excellent in graininess.

TABLE 1

| | | | | | | | | | Number of | | |
|---|---|---|---|---|---|---|---|---|---|---|---|
| | | | | | | | | | developed | | |
| | | Sphere | Total coating | | Total | | | Total | silver | Nucleator | |
| | | equivalent | amount of | Total coating | coating | Total coating | Occupied | number of | grains/ | | Addition |
| | | diameter | silver salt of | amount of | amount of | amount of | volume | silver halide | number | | amount |
| Sam- | Emul- | of silver | fatty acid on | silver halide | silver on | silver/number of | by silver | grains on | of silver | | per one |
| ple | sion | halide | both | on both | both | silver halide | halide grain | both sides | halide | | side |
| No. | No. | grain(μm) | sides^{*1}(g/m²) | sides^{*2}(g/m²) | sides(g/m²) | grains(g/grain) | (μm³/grain) | (grains/m²) | grains | No. | (g/m²) |
| 1 | A | 0.04 | 1.35 | 0.292 | 1.642 | 4.9 × 10⁻¹⁶ | 0.006 | 3.3 × 10¹⁵ | 2 | SH-7 | 0.035 |
| 2 | B | 0.08 | 1.35 | 0.292 | 1.642 | 3.9 × 10⁻¹⁵ | 0.048 | 4.2 × 10¹⁴ | 8 | SH-7 | 0.035 |
| 3 | C | 0.16 | 1.35 | 0.292 | 1.642 | 3.1 × 10⁻¹⁴ | 0.38 | 5.2 × 10¹³ | 12 | SH-7 | 0.035 |
| 4 | I | 0.30 | 1.35 | 0.292 | 1.642 | 2.1 × 10⁻¹³ | 2.52 | 7.9 × 10¹² | 25 | SH-7 | 0.035 |
| 5 | E | 0.42 | 1.35 | 0.292 | 1.642 | 5.7 × 10⁻¹³ | 6.92 | 2.9 × 10¹² | 30 | SH-7 | 0.035 |
| 6 | G | 0.71 | 1.35 | 0.292 | 1.642 | 2.8 × 10⁻¹² | 32.5 | 6.0 × 10¹¹ | 45 | SH-7 | 0.035 |
| 7 | A | 0.04 | 1.35 | 0.292 | 1.642 | 4.9 × 10⁻¹⁶ | 0.006 | 3.3 × 10¹⁵ | 0.83 | — | 0 |
| 8 | B | 0.08 | 1.35 | 0.292 | 1.642 | 3.9 × 10⁻¹⁵ | 0.048 | 4.2 × 10¹⁴ | 0.85 | — | 0 |
| 9 | C | 0.16 | 1.35 | 0.292 | 1.642 | 3.1 × 10⁻¹⁴ | 0.38 | 5.2 × 10¹³ | 0.92 | — | 0 |
| 10 | I | 0.30 | 1.35 | 0.292 | 1.642 | 2.1 × 10⁻¹³ | 2.52 | 7.9 × 10¹² | 0.95 | — | 0 |
| 11 | E | 0.42 | 1.35 | 0.292 | 1.642 | 5.7 × 10⁻¹³ | 6.92 | 2.9 × 10¹² | 0.96 | — | 0 |
| 12 | G | 0.71 | 1.35 | 0.292 | 1.642 | 2.8 × 10⁻¹² | 33.5 | 6.0 × 10¹¹ | 0.96 | — | 0 |

^{*1, *2}The amount on the basis of silver content

TABLE 2

| | | Haze degree of film(%) | | Photographic | | | | |
|---|---|---|---|---|---|---|---|---|
| | | Before | After | properties | | | | |
| Sample | Emulsion | thermal | thermal | | | | Average | |
| No. | No. | development | development | Fog | Sensitivity | Dmax | gradient | Graininess |
| 1 | A | 24 | 18 | 0.16 | 0.1 | 4.6 | 6.3 | X |
| 2 | B | 27 | 17 | 0.17 | 0.7 | 4.2 | 5.3 | X |
| 3 | C | 29 | 18 | 0.17 | 5.6 | 3.9 | 4.7 | Δ |
| 4 | I | 33 | 18 | 0.17 | 38 | 3.6 | 3.7 | ◯ |
| 5 | E | 39 | 18 | 0.17 | 100 | 3.3 | 3.1 | ◯ |
| 6 | G | 42 | 18 | 0.18 | 495 | 2.9 | 2.9 | ◯ |
| 7 | A | 25 | 17 | 0.16 | 0.08 | 4.2 | 3.5 | ◯ |
| 8 | B | 28 | 18 | 0.16 | 0.4 | 3.3 | 2.9 | ◯ |
| 9 | C | 29 | 17 | 0.17 | 4.3 | 2.9 | 1.5 | ◯ |
| 10 | I | 32 | 18 | 0.17 | 11 | 2.2 | 1.1 | ◯ |
| 11 | E | 40 | 18 | 0.17 | 22 | 0.7 | — | ◯ |
| 12 | G | 42 | 18 | 0.17 | 27 | 0.1 | — | ◯ |

### Example 2

Sample-21 to -30 are prepared in a similar manner to the process in the preparation of the sample-5, except that changing the kind and the addition amount of nucleator as shown in Table 3.

The results of evaluations that are conducted similar to Example 1 are shown in Table 3.

It can be understood from the results that the photothermographic material of the invention (sample-21 to -30) has high sensitivity, high density, and a gradation suitable for medical diagnosis and is excellent in graininess.

TABLE 3

| | Nucleator | | | | | | |
|---|---|---|---|---|---|---|---|
| | | Addition | Photographic properties | | | | |
| | | amount per | | | | Average | |
| Sample No. | No. | one side(g/m²) | Fog | Sensitivity | Dmax | gradient | Graininess |
| 11 | — | 0 | 0.17 | 22 | 0.7 | — | ◯ |
| 2 | SH-7 | 0.035 | 0.17 | 100 | 3.3 | 3.1 | ◯ |
| 21 | SH-1 | 0.030 | 0.20 | 108 | 3.5 | 3.3 | ◯ |
| 22 | SH-2 | 0.045 | 0.18 | 93 | 3.2 | 3.1 | ◯ |
| 23 | SH-3 | 0.045 | 0.18 | 95 | 3.2 | 3.1 | ◯ |
| 24 | SH-4 | 0.035 | 0.19 | 101 | 3.2 | 3.2 | ◯ |
| 25 | SH-5 | 0.035 | 0.19 | 98 | 3.2 | 3.2 | ◯ |
| 26 | SH-6 | 0.040 | 0.17 | 92 | 3.1 | 3.1 | ◯ |
| 27 | SH-8 | 0.040 | 0.17 | 96 | 3.2 | 3.1 | ◯ |
| 28 | SH-9 | 0.040 | 0.18 | 102 | 3.3 | 3.1 | ◯ |
| 29 | SH-10 | 0.035 | 0.19 | 103 | 3.4 | 3.3 | ◯ |
| 30 | SH-12 | 0.035 | 0.20 | 105 | 3.2 | 3.3 | ◯ |

### Example 3

1. Preparations of Materials

1) Preparation of Tabular Silver Bromide Emulsion J

(Grain Formation)

An aqueous solution in an amount of 1178 mL where 0.8 g of potassium bromide and 3.2 g of acid-processed gelatin having an average molecular weight of 20000 are contained is kept at 35° C. and stirred. Thereto are added an aqueous solution of 1.6 g of silver nitrate, an aqueous solution of 1.16 g of potassium bromide, an aqueous solution of 1.1 g of acid-processed gelatin having an average molecular weight of 20000 by the method of triple jet over 45 seconds. The concentration of silver nitrate is 0.3 mol/L. Thereafter, the temperature of the mixture is elevated to 76° C. spending 20 minutes, and 26 g of succinated gelatin having an average molecular weight of 100000 is added. 209 g of silver nitrate aqueous solution and an aqueous solution of potassium bromide are added by the method of controlled double jet at increasing flow rate, while keeping pAg of 8.0, over 75 minutes. After the addition of gelatin having an average molecular weight of 100000, the mixture is desalted according to the known method. Thereafter, gelatin having an average molecular weight of 100000 is added and, the mixture is dispersed and is adjusted to pH of 5.8 and pAg of 8.0 at 40° C. The obtained emulsion contains one mole of silver and 40 g of gelatin per 1 kg of the emulsion.

(Chemical Sensitization)

Chemical sensitization is applied for the above emulsion with stirring and keeping the temperature at 56° C. At first, thiosulfonate compound-1 described below is added in an amount of 10⁻⁴ mol per 1 mol of silver halide, and then silver iodide grains having a grain size of 0.03 μm are added in an amount of 0.15 mol % with respect to total coating amount of silver. 3 minutes later, thiourea dioxide is added in an amount of 1×10⁻⁶ mol per 1 mol of silver halide, and the reduction sensitization is applied for the period of 22 minutes. Thereafter, 4-hyroxy-6-methyl-1,3.3a,7-tetrazaindene, sensitizing dye-3, sensitizing dye-1 and sensitizing dye-2 are added in an amount of 3×10⁻⁴ mol, 1×10⁻³ mol, 1×10⁻⁴ mol and 1×10⁻⁴ mol per 1 mol of silver halide respectively, and then further an aqueous solution of calcium chloride is added.

Subsequently, continuing to the above procedure, sodium thiosulfate and selenium compound-1 are added in an amount of 6×10⁻⁶ mol and 4×10⁻⁶ mol per 1 mol of silver halide, respectively, to the dispersion, thereafter aurichloric acid is added in an amount of 2×10⁻³ mol per 1 mol of silver halide. Thereto, nucleic acid (trade name: RNA-F, manufactured by Sanyo Kokusaku Pulp Co., Ltd.) is added in an amount of 67 mg per 1 mol of silver halide. 40 minutes later, water-soluble Mercapto compound-1 is added in a concentration of 1×10⁻⁴ mol per 1 mol of silver halide and cooled to 35° C. to finish the chemical sensitization of the emulsion J.

(Shape of the Obtained Grains)

By observation through electron microscope, the obtained tabular silver bromide grains have a mean projection area equivalent diameter of 1.117 μm, a mean sphere equivalent diameter of 0.472 μm, a mean thickness of 0.056 μm, a mean aspect ratio of 19.9, and a variation coefficient between the grains of the mean projection area equivalent diameter of 23%.

2) Preparations of Tabular Silver Bromide Emulsion K, L, and M

Preparations of silver halide emulsion K, L and M are conducted in a similar manner to the process in the preparation of silver halide emulsion J, except that changing the addition speed and the reaction temperature. The shapes of the obtained silver halide grains are summarized in the following Table 4.

TABLE 4

| | Projection | | | | |
|---|---|---|---|---|---|
| | area | | Sphere | | |
| | equivalent | Variation | equivalent | | |
| | diameter | coefficient | diameter | Thickness | Aspect |
| Emulsion No. | (μm) | (%) | (μm) | (μm) | ratio |
| J | 1.117 | 23 | 0.472 | 0.056 | 19.9 |
| K | 1.054 | 24 | 0.445 | 0.053 | 19.9 |
| L | 0.964 | 22 | 0.409 | 0.049 | 19.7 |
| M | 0.848 | 22 | 0.385 | 0.053 | 16.0 |

3) Crossover Cut Layer

(Preparation of Dispersion of Solid Fine Particles (a) of Base Precursor)

The base precursor-1 in an amount of 2.5 kg, and 300 g of a surfactant (trade name: DEMOL N, manufactured by Kao Corporation), 800 g of diphenyl sulfone, 1.0 g of benzoisothiazolinone sodium salt are mixed with distilled water to give the total amount of 8.0 kg and mixed. The mixed liquid is subjected to beads dispersion using a horizontal sand mill (UVM-2: manufactured by IMEX Co., Ltd.). Process for dispersion includs feeding the mixed liquid to UVM-2 packed with zirconia beads having a mean particle diameter of 0.5 mm with a diaphragm pump, followed by the dispersion at the inner pressure of 50 hPa or higher until desired mean particle diameter could be achieved.

The dispersion is continued until the ratio of the optical density at 450 nm and the optical density at 650 nm for the spectral absorption of the dispersion (D₄₅₀/D₆₅₀) becomes 3.0 upon spectral absorption measurement. Thus resulting dispersion is diluted with distilled water so that the concentration of the base precursor becomes 25% by weight, and filtrated (with a polypropylene filter having a mean fine pore diameter of 3 μm) for eliminating dust to put into practical use.

(Preparation of Dispersion of Solid Fine Particle of Orthochromatic Thermal Bleaching Dye)

Orthochromatic thermal bleaching dye-1 (λ max=566 nm) described in JP-A No. 11-231457 in an amount of 6.0 kg, 3.0 kg of sodium p-dodecylbenzenesulfonate, 0.6 kg of DEMOL SNB (a surfactant manufactured by Kao Corporation), and 0.15 kg of a defoaming agent (trade name: SURFYNOL 104E, manufactured by Nissin Chemical Industry Co., Ltd.) are mixed with distilled water to give the total amount of 60 kg. The mixed solution is subjected to dispersion with 0.5 mm zirconia beads using a horizontal sand mill (UVM-2: manufactured by IMEX Co., Ltd.).

The dispersion is dispersed until the ratio of the optical density at 650 nm and the optical density at 750 nm for the spectral absorption of the dispersion (D₆₅₀/D₇₅₀) becomes 5.0 or higher upon spectral absorption measurement. Thus resulting dispersion is diluted with distilled water so that the concentration of the cyanine dye becomes 6% by weight, and filtrated with a filter (mean fine pore diameter: 1 μm) for eliminating dust to put into practical use.

(Preparation of Coating Solution for Crossover Cut Layer)

17 g of polyvinyl alcohol PVA-205 (manufactured by Kuraray Co., Ltd.), 9.6 g of polyacrylamide, 70 g of the dispersion of the solid fine particles (a) of the base precursor, 56 g of the aforementioned dispersion of the solid fine particles of the orthochromatic thermal bleaching dye (solid content of dye of 3% by weight), 0.03 g of benzoisothiazolinone, 2.2 g of sodium polystyrenesulfonate, and 844 mL of water are admixed to give a coating solution for the crossover cut layer.

2. Preparations of Sample-31 to -38

Preparations of sample-31 to -38 are conducted in a similar manner to Example 1, except that setting the crossover cut layer between the image forming layer and the support and changing the kinds of silver halide emulsion and nucleator as shown in Table 5.

The crossover cut layer is coated, so that the coating amount of solid content of orthochromatic thermal bleaching dye gives 0.04 g/m². The coating amounts of other layers are similar to Example 1.

Chemical structures of the compounds used in Examples of the invention are shown below. 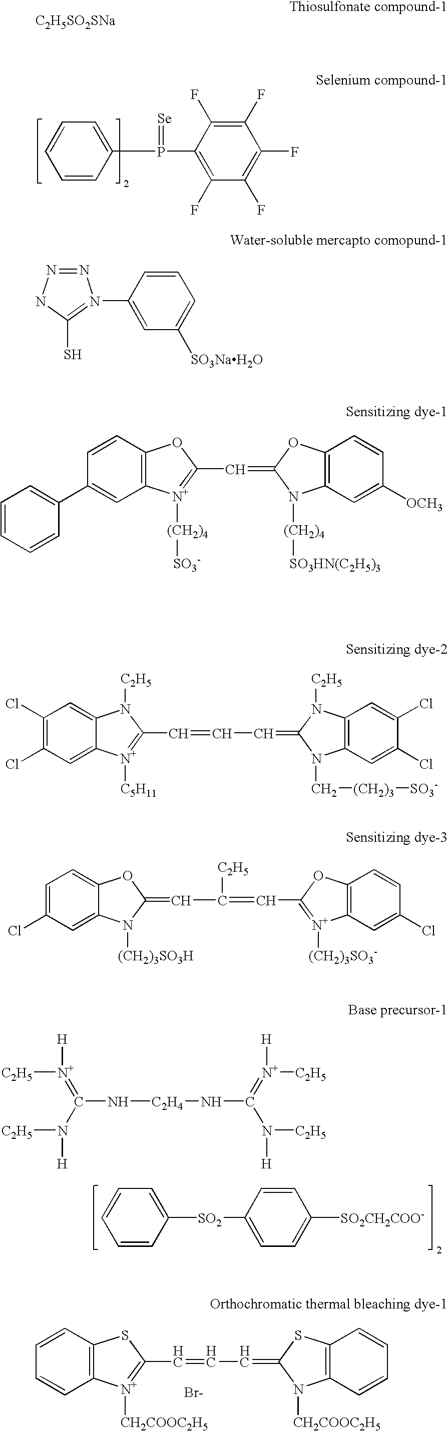
3. Evaluation of Photographic Properties

X-ray exposure and thermal development are performed similar to Example 1, except that using X-ray Orthochomatic Screen HG-M produced by Fuji Photo Film Co., Ltd. as a fluorescent screen (using as fluorescent substance a terbium activated gadolinium oxysulfide fluorescent substance, emission peak wavelength of 545 nm).

The measurement of crossover is done similar to Example 1 in JP-A No. 11-142723, except that changing the developing process to thermal developing process. As a result, crossover is 7%.

The results of evaluations which are done similar to Example 1 are shown in Table 6.

From the results, it is understood that the photothermographic material of the invention (sample-31 to -34) has high sensitivity, high density and a gradation suitable for medical diagnosis, and is excellent in graininess. But, compared with photothermographic material of Example 1 where silver iodide is used, as for the photothermographic material of Example 3 using silver bromide tabular grains the haze degree after thermal development remains high.

TABLE 5

| | | | | | | | | | Number of | | |
|---|---|---|---|---|---|---|---|---|---|---|---|
| | | | | | | | | | developed | | |
| | | Sphere | Total coating | | Total | | | Total | silver | Nucleator | |
| | | equivalent | amount of | Total coating | coating | Total coating | Occupied | number of | grains/ | | Addition |
| | | diameter | silver salt of | amount of | amount of | amount of | volume | silver halide | number | | amount |
| Sam- | Emul- | of silver | fatty acid on | silver halide | silver on | silver/number of | by silver | grains on | of silver | | per one |
| ple | sion | halide | both | on both | both | silver halide | halide grain | both sides | halide | | side |
| No. | No. | grain(μm) | sides^{*1}(g/m²) | sides^{*2}(g/m²) | sides(g/m²) | grains(g/grain) | (μm³/grain) | (grains/m²) | grains | No. | (g/m²) |
| 31 | J | 0.472 | 1.35 | 0.292 | 1.642 | 1.2 × 10⁻¹² | 14.0 | 1.4 × 10¹² | 21 | SH-7 | 0.035 |
| 32 | K | 0.445 | 1.35 | 0.292 | 1.642 | 9.6 × 10⁻¹³ | 11.7 | 1.7 × 10¹² | 22 | SH-7 | 0.035 |
| 33 | L | 0.409 | 1.35 | 0.292 | 1.642 | 7.5 × 10⁻¹³ | 9.10 | 2.2 × 10¹² | 23 | SH-7 | 0.035 |
| 34 | M | 0.385 | 1.35 | 0.292 | 1.642 | 6.2 × 10⁻¹³ | 7.60 | 2.6 × 10¹² | 20 | SH-7 | 0.035 |
| 35 | J | 0.472 | 1.35 | 0.292 | 1.642 | 1.2 × 10⁻¹³ | 14.0 | 1.4 × 10¹² | 0.95 | — | 0 |
| 36 | K | 0.445 | 1.35 | 0.292 | 1.642 | 9.6 × 10⁻¹³ | 11.7 | 1.7 × 10¹² | 0.94 | — | 0 |
| 37 | L | 0.409 | 1.35 | 0.292 | 1.642 | 7.5 × 10⁻¹³ | 9.10 | 2.2 × 10¹² | 0.96 | — | 0 |
| 38 | M | 0.385 | 1.35 | 0.292 | 1.642 | 6.2 × 10⁻¹³ | 7.60 | 2.6 × 10¹² | 0.95 | — | 0 |

^{*1, *2}The amount on the basis of silver content

TABLE 6

| | | Haze degree of film(%) | | | | | | |
|---|---|---|---|---|---|---|---|---|
| | | Before | After | Photographic properties | | | | |
| Sample | Emulsion | thermal | thermal | | | | Average | |
| No. | No. | development | development | Fog | Sensitivity | Dmax | gradient | Graininess |
| 31 | J | 44.1 | 46.1 | 0.34 | 100 | 3.1 | 3.2 | ◯ |
| 32 | K | 53.1 | 55.1 | 0.36 | 88 | 3.3 | 3.1 | ◯ |
| 33 | L | 58.5 | 60.5 | 0.34 | 73 | 3.2 | 3.2 | ◯ |
| 34 | M | 46.1 | 48.1 | 0.33 | 57 | 3.4 | 3.3 | ◯ |
| 35 | J | 44.1 | 46.1 | 0.30 | 49 | 0.7 | — | ◯ |
| 36 | K | 53.1 | 55.1 | 0.31 | 39 | 0.8 | — | ◯ |
| 37 | L | 58.5 | 60.5 | 0.32 | 34 | 0.8 | — | ◯ |
| 38 | M | 46.1 | 48.1 | 0.31 | 28 | 1.0 | — | ◯ |

### Example 4

1. Preparation of Sample

A single-sided photothermographic material having the image forming layer only on one side and disposing a back layer on the opposite surface side of the image forming layer is prepared in a similar manner to Example 1.

The image forming layer is double-coated to give an upper layer and a lower layer, and each coating amount of silver (total amount of silver contained in silver salt of fatty acid and silver halide) is 0.8 g/m². The silver halide emulsion I is used for the upper layer, and the silver halide emulsion E is used for the lower layer. An optimal orthochromatic sensitization is performed by using the sensitizing dye-1, -2 and -3.

<Constitution of Back Layer>

1) Preparation of Coating Solution for Antihalation Layer

A vessel is kept at 40° C., and thereto are added 40 g of gelatin, 20 g of monodispersed polymethyl methacrylate fine particles (mean particle size of 8 μm, standard deviation of particle diameter of 0.4), 0.1 g of benzoisothiazolinone and 490 mL of water to allow gelatin to be dissolved. Additionally, 2.3 mL of a 1 mol/L aqueous sodium hydroxide solution, 40 g of the dispersion solution of the solid fine particles of the orthochromatic thermal bleaching dye of Example 3, 90 g of the dispersion solution of the solid fine particles (a) of the base precursor of Example 3, 12 mL of a 3% by weight aqueous solution of sodium polystyrenesulfonate, and 180 g of a 10% by weight solution of SBR latex are admixed. Just prior to the coating, 80 mL of a 4% by weight aqueous solution of N,N-ethylenebis(vinylsulfone acetamide) is admixed to give a coating solution for the antihalation layer.

2) Preparation of Coating Solution for Back Surface Protective Layer

A vessel is kept at 40° C., and thereto are added 40 g of gelatin, 35 mg of benzoisothiazolinone and 840 mL of water to allow gelatin to be dissolved. Additionally, 5.8 mL of a 1 mol/L aqueous sodium hydroxide solution, 5 g of a 10% by weight emulsion of liquid paraffin, 5 g of a 10% by weight emulsion of tri(isostearic acid)-trimethylol-propane, 10 mL of a 5% by weight aqueous solution of di(2-ethylhexyl) sodium sulfosuccinate, 20 mL of a 3% by weight aqueous solution of sodium polystyrenesulfonate, 2.4 mL of a 2% by weight solution of a fluorocarbon surfactant (F-1), 2.4 mL of a 2% by weight solution of another fluorocarbon surfactant (F-2), and 32 g of a 19% by weight solution of methyl methacrylate/styrene/butyl acrylate/hydroxyethyl methacrylate/acrylic acid copolymer (weight ratio of the copolymerization of 57/8/28/5/2) latex are admixed. Just prior to the coating, 25 mL of a 4% by weight aqueous solution of N,N-ethylenebis(vinylsulfone acetamide) is admixed to give a coating solution for the back surface protective layer.

3) Coating of Back Layer

The back surface side of the undercoated support as described above is subjected to simultaneous double coating so that the coating solution for the antihalation layer gives the coating amount of gelatin of 0.52 g/m², and so that the coating solution for the back surface protective layer gives the coating amount of gelatin of 1.7 g/m², followed by drying to produce a back layer.

2. Evaluation of Photographic Properties

Thus obtained orthochromatic sensitized single-sided coated material is evaluated as follows.

As for fluorescent intensifying screen, the fluorescent intensifying screen UM MAMMO FINE for mammography (using as fluorescent substance, a terbium activated gadolinium oxysulfide fluorescent substance, the emission peak wavelength of 545 nm) produced by Fuji Photo Film Co., Ltd. is used. The photothermographic material and the intensifying screen are loaded in ECMA cassette produced by Fuji Photo Film Co., Ltd. so as the image forming layer of the photothermographic material comes in contact with the surface protective layer of the screen. The X-ray exposure is performed after arranging so that the top plate of cassette, the photothermographic material and the screen may be set, from X-ray tube, in turn.

The commercially available. mammography apparatus DRX-B1356EC produced by Toshiba Corp. is used as for X-ray source. The X-ray emitted from the molydenum target tube operated by three-phase electric power at 26 kVp, which penetrated Be of 1 mm, Mo of 0.03 mm and an acrylic filter of 2 cm, is used. By the method of distance, the exposure value of X-ray is changed. The photothermographic material is subjected to exposure for one second with a step wedge tablet having a width of 0.15 in terms of log E.

After exposure, the photothermographic material is subjected to thermal development in a similar manner to Example 1.

On the other hand, UM-MAHC film for mammographic use produced by Fuji Photo Film Co., Ltd. is subjected to X-ray exposure as the same condition as above, and processed for 90 seconds with the automatic photographic processor CEPRO-M2 produced by Fuji Photo Film Co., Ltd. and Developer CE-D1, to obtain an image.

As a result of comparing photographic properties of both images, the similar excellent properties are attained.

### Example 5

The double-sided coated photothermographic material is prepared in a similar manner to Example 1 except that the support is changed to PEN (polyethylene naphthalene).

The commercially available polyethylene-2,6-naphthalate polymer is melted at 300° C., extruded from a T-die, and the film is stretched along the longitudinal direction by 3.3 times and then stretched along the transverse direction by 3.3 times. The temperatures used for these operations are 140° C., respectively. Then the film is subjected to thermal fixation at 250° C. for 6 seconds to give the film having a thickness of 175 μm. The corona treatment of the support is performed as follows. The surface of the support having a width of 30 cm is treated at 20 m/minute using a Solid State Corona Discharge Treatment Machine Model 6KVA manufactured by Pillar GmbH. It is proven that treatment of 0.375 KV·A·minute·m⁻² is executed, judging from the readings of current and voltage on that occasion. The frequency upon this treatment is 9.6 KHz and the gap clearance between the electrode and the dielectric roll is 1.6 mm. Coating of undercoat layer is performed in a similar manner to the process in the preparation of the support of Example 1.

The obtained double-sided coated photothermographic material is evaluated as follows.

As for the fluorescent intensifying screen, Ultravision Fast Detail (UV) produced by Du Pont Co., Ltd. is used. Both sides of the photothermographic material of the invention are contacted with the screens, and the combination is subjected to X-ray exposure for 0.05 seconds to make X-ray sensitometry. The exposure value is adjusted by changing the distance between the X-ray tube and the cassette.

After exposure, thermal development is performed in a similar manner to Example 1.

The results with excellent images similar to those of Example 1 are obtained.

### Example 6

Sample-601 is prepared in a similar manner to the process in the preparation of the sample-6 of Example 1, except that setting the following crossover cut layer between the undercoat layer of the support and the image forming layer.

1) Preparation of Coating Solution for Crossover Cut Layer

17 g of polyvinyl alcohol PVA-205 (manufactured by Kuraray Co., Ltd.), 9.6 g of polyacrylamide, 4.2 g of the following ultraviolet absorber-1, 0.03 g of benzoisothiazolinone, 2.2 g of sodium polystyrenesulfonate, and 844 mL of water are admixed to give a coating solution for the crossover cut layer.

The coating solution for the crossover cut layer is fed to the coating station by controlling the flow speed of the coating solution to give the coating amount of solid content of the ultraviolet absorber-1 of 0.04 g/m².

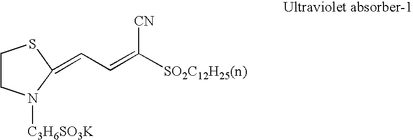

2) Conditions of Exposure and Development

X-ray exposure is preformed similar to Example 1 except that using two sheets of the following fluorescent intensifying screen A.

<Preparation of Fluorescent Intensifying Screen A>

(1) Preparation of Undercoat Layer

In a similar manner to Example 4 in JP-A. No. 2001-124898, a light reflecting layer comprising alumina powder is coated on polyethylene terephthalate film (support) having a thickness of 250 μm. The light reflecting layer which has a film thickness of 50 μm after drying, is prepared.

(2) Preparation of Fluorescent Sheet

250 g of BaFBr:Eu fluorescent substance (mean particle size of 3.5 μm), 8 g of polyurethane type binder resin (manufactured by Dai Nippon Ink & Chemicals, Inc., trade name: PANDEX T5265M ), 2 g of epoxy type binder resin (manufactured by Yuka Shell Epoxy Co., Ltd., trade name: EPIKOTE 1001) and 0.5 g of isocyanate compounds (manufactured by Nippon Polyurethane Industry Co., Ltd., trade name: CORONATE HX) are added into methylethylketone, and the mixture is then dispersed by a propeller mixer to prepare the coating solution for the fluorescent substance layer having a viscosity of 25 PS (25° C.). This coating solution is coated on the surface of a temporary support (pretreated by coating a silicone agent on the surface of polyethylene terephthalate film), and dried to make the fluorescent substance layer. Thereafter, the fluorescent sheet is prepared by peeling the fluorescent substance layer from the temporary support.

(3) Overlaying the Fluorescent Sheet on Light Reflective Layer.

The fluorescent substance sheet prepared above is overlaid on the surface of the light reflective layer of the support having a light reflective layer made in the above process (1), and then pressed by a calendar roller at the pressure of 400 kgw/cm² and the temperature of 80° C. to form the fluorescent substance layer on the light reflective layer. The thickness of the obtained fluorescent substance layer is 125 μm and the volume filling factor of fluorescent substance particles in the fluorescent substance layer is 68%.

(4) Preparation of Surface Protective Layer

Polyester type adhesive agents are coated on one side of polyethylene terephthalate film having a thickness of 6 μm, and thereafter the surface protective layer on the fluorescent substance layer is formed by a laminating method. As described above, the fluorescent intensifying screen A comprising a support, a light reflective layer, a fluorescent substance layer and a surface protective layer is prepared.

(5) Emission Characteristics

The emission spectrum of the intensifying screen A is measured by X-ray at 40 kVp and is shown in FIG. 1. The fluorescent intensifying screen A shows an emission having a peak at 390 nm and a narrow half band width.

After exposure, thermal development is performed by the following condition.

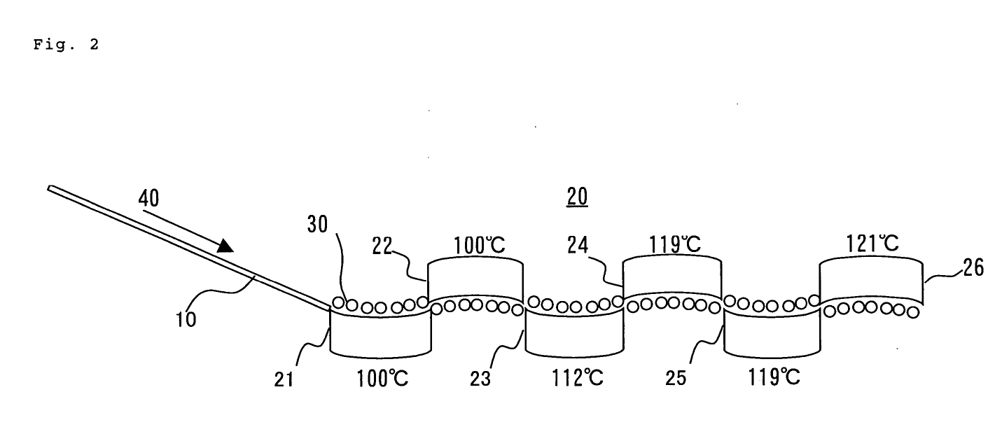

As shown in FIG. 2, Fuji Medical Dry Laser Imager FM-DP L is modified to arrange the six sheets of panel heater in a zigzag pattern. The photothermographic material 10 is conveyed so that the surface and the backside of the material might touch the surface of panel heater directly by turn. The temperature of the panel heater is set to 100° C.-100° C.-112° C.-119° C.-121° C.-121° C. and total time period for passing through six sheets of the panel heater is adjusted to be 33 seconds.

The panel heater 20 comprises the combination of the first heat plate 21, the second heat plate 22, the third heat plate 23, the fourth heat plate 24, the fifth heat plate 25, the sixth heat plate 26, and a plurality of transportation rollers 30. The arrow 40 shows the conveying direction.

Excellent results similar to those of Example 1 are obtained. The photothermographic material of the present invention has high sensitivity, high density and a gradation suitable for medical diagnosis, and is excellent in graininess.

3) Measurement of Sensitivity

The sensitivity at 390 nm that is the main emission peak of the aforesaid fluorescent intensifying screen A is measured as follows.

Sample-601 is subjected to exposure for 1/10 seconds by a 2856K color temperature tungsten light source filtered through a interference filter produced by Corning Inc., which has a half band width of 10 nm and a central transparency wavelength at 390 nm, an infrared light cut filter and a neutral step wedge. After exposure, the photosensitive material is subjected to thermal development in a similar manner to the manner described above. After peeling off the image forming layer which is disposed on the opposite side to the exposed side, densities are measured to draw a photographic characteristic curve. From the photographic characteristic curve, the exposure value required to give a density of fog+0.5 is determined. On determination of the exposure value, the light emitted by the tungsten light source and passed through the filter is measured using the radiophotometer DR-2550 produced by EG&G Inc.

As the result of measurement, the exposure value required for a density to be fog+0.5 is 1.3×10⁻⁴ watt·sec·m⁻².

### Example 7

Samples are prepared similar to Example 4, except that: using the silver halide emulsion E for the upper layer and the emulsion G for the lower layer, and not performing spectral sensitization by a sensitizing dye; using the coating solution for the crossover cut layer of Example 6 instead of using the coating solution for antihalation layer; and feeding the coating solution for the crossover cut layer to the coating station by controlling the flow speed of the coating solution to give the coating amount of solid content of the ultraviolet absorber-1 of 0.04 g/m².

X-ray exposure is performed similar to Example 4, except that using the screen A of Example 6.

The exposed samples are subjected to thermal development similar to Example 1.

From the results, it is understood that the photothermographic material of the invention has high sensitivity, high density and a gradation suitable for medical diagnosis, and is excellent in graininess.

### Example 8

1. Preparation of PET Support and Undercoating

Preparation of PET support and undercoating are done similar to Example 1.

2. Image Forming Layer, Intermediate Layer and Surface Protective Layer

2-1. Preparations of Coating Materials

1) Preparations of Emulsion for Coating Solution A, B, C, E, G, and I

They are done similar to Example 1.

2) Preparation of Dispersion of Silver Salt of Fatty Acid

It is done similar to Example 1.

3) Preparations of Reducing Agent Dispersion

<<Preparation of Dispersion of Reducing Agent of Formula (R1)>>

To 10 kg of reducing agent (No. R1-1) of formula (R1) and 16 kg of a 10% by weight aqueous solution of modified polyvinyl alcohol (manufactured by Kuraray Co., Ltd., Poval MP203) is added 10 kg of water, and thoroughly mixed to give a slurry. This slurry is fed with a diaphragm pump, and is subjected to dispersion with a horizontal sand mill (UVM-2: manufactured by IMEX Co., Ltd.) packed with zirconia beads having a mean particle diameter of 0.5 mm for 3 hours. Thereafter, 0.2 g of a benzoisothiazolinone sodium salt and water are added thereto, thereby adjusting the concentration of the reducing agent to be 25% by weight. This dispersion is subjected to heat treatment at 60° C. for 5 hours to obtain reducing agent R1-1 dispersion. Particles of the reducing agent included in the resulting reducing agent dispersion have a median diameter of 0.40 μm, and a maximum particle diameter of 1.4 μm or less. The resultant reducing agent dispersion is subjected to filtration with a polypropylene filter having a pore size of 3.0 μm to remove foreign substances such as dust, and stored.

<<Preparation of Dispersion of Reducing Agent A for Comparison>>

To 10 kg of reducing agent A for comparison and 16 kg of 10% by weight aqueous solution of modified polyvinyl alcohol (manufactured by Kuraray Co., Ltd., Poval MP203) is added 10 kg of water, and thoroughly mixed to give a slurry. This slurry is fed with a diaphragm pump, and is subjected to dispersion with a horizontal sand mill (UVM-2: manufactured by IMEX Co., Ltd.) packed with zirconia beads having a mean particle diameter of 0.5 mm for 3 hours and 30 minutes. Thereafter, 0.2 g of a benzoisothiazolinone sodium salt and water are added thereto, thereby adjusting the concentration of the reducing agent to be 25% by weight. This dispersion is warmed at 40° C. for one hour, followed by a subsequent heat treatment at 80° C. for one hour to obtain a reducing agent A dispersion. Particles of the reducing agent included in the resulting reducing agent dispersion have a median diameter of 0.50 μm, and a maximum particle diameter of 1.6 μm or less. The resultant reducing agent dispersion is subjected to filtration with a polypropylene filter having a pore size of 3.0 μm to remove foreign substances such as dust, and stored.

4) Preparation of Hydrogen Bonding Compound Dispersion

It is done similar to Example 1.

5) Preparations of Development Accelerator Dispersion and Color-Tone-Adjusting Agent Dispersion

They are done similar to Example 1.

6) Preparations of Organic Polyhalogen Compound Dispersion

They are done similar to Example 1.

7) Preparation of Silver Iodide Complex Forming Agent

It is done similar to Example 1.

8) Preparations of Aqueous Solution of Mercapto Compound

They are done similar to Example 1.

9) Preparation of SBR Latex Solution

It is done similar to Example 1.

2-2. Preparations of Coating Solution

1) Preparation of Coating Solution for Image Forming Layer

To the dispersion of the silver salt of fatty acid obtained as described above in an amount of 1000 g and 276 mL of water are serially added the organic polyhalogen compound-1 dispersion, the organic polyhalogen compound-2 dispersion, the SBR latex (Tg: 17° C.) solution, the reducing agent dispersion (kind and addition amount of the reducing agent are shown in Table 7), the hydrogen bonding compound-1 dispersion, the development accelerator-1 dispersion, the development accelerator-2 dispersion, the color-tone-adjusting agent-1 dispersion, the mercapto compound-1 aqueous solution, and the mercapto compound-2 aqueous solution. After adding thereto the silver iodide complex forming agent, the silver halide emulsion for coating solution A, B, C, E, G, or I is added thereto in an amount of 0.22 mol per 1 mol of silver salt of fatty acid, followed by thorough mixing just prior to the coating, which is fed directly to a coating die, and is coated.

Viscosity of the aforementioned coating solution for the image forming layer is measured with a B type viscometer from Tokyo Keiki, and is revealed to be 25 [mPa·s] at 40° C. (No. 1 rotor, 60 rpm).

Viscosity of the coating solution at 25° C. when it is measured using RFS fluid spectrometer manufactured by Rheometrix Far-East Co. Ltd. is 242, 65, 48, 26, and 20 [mPa·s], respectively, at the shearing rate of 0.1, 1, 10, 100, 1000 [1/second].

The amount of zirconium in the coating solution is 0.52 mg per 1 g of silver.

2) Preparation of Coating Solution for Intermediate Layer

It is done similar to Example 1.

3) Preparation of Coating Solution for First Layer of Surface Protective Layers

It is done similar to Example 1.

4) Preparation of Coating Solution for Second Layer of Surface Protective Layers

It is done similar to Example 1.

2-3. Preparations of Photothermographic Material-101 to -112

Simultaneous overlaying coating by a slide bead coating method is subjected in order of the image forming layer, intermediate layer, first layer of the surface protective layers and second layer of the surface protective layers, starting from the undercoated face, and thus sample-101 to -112 of the photothermographic materials are produced. In this method, the temperature of the coating solution is adjusted to 31° C. for the image forming layer and intermediate layer, to 36° C. for the first layer of the surface protective layers, and to 37° C. for the second layer of the surface protective layers. The coating amount of silver in the image forming layer is 0.821 g/m² per one side with respect to total amount of silver salt of fatty acid and silver halide. This is coated on both sides of the support.

The coating amount of each compound (g/m²) for the image forming layer per one side is as follows.

| | |
|---|---|
| Silver salt of fatty acid | 2.80 |
| Organic polyhalogen compound-1 | 0.028 |
| Organic polyhalogen compound-2 | 0.094 |
| Silver iodide complex forming agent | 0.46 |
| SBR latex | 5.20 |
| Reducing agent | (see Table 7) |
| Hydrogen bonding compound-1 | 0.15 |
| Development accelerator-1 | 0.005 |
| Development accelerator-2 | 0.035 |
| Color-tone-adjusting agent-1 | 0.002 |
| Mercapto compound-1 | 0.001 |
| Mercapto compound-2 | 0.003 |
| Silver halide (on the basis of Ag content) | 0.146 |

Conditions for coating and drying are similar to Example 1.

Thus prepared photothermographic material has the matness of 250 seconds. In addition, measurement of the pH of the film surface on the image forming layer side surface gives the result of 6.0.

Chemical structures of the compounds used in Examples of the invention are shown below.

Reducing agent A for comparison

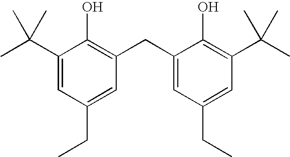

3. Evaluation of Photographic Properties

3-1. Preparation

It is done similar to Example 1.

3-2. Condition of Evaluation

It is similar to Example 1.

A sensitivity of the sample-105 is set to 100 and relative sensitivities are shown.

3-3. Results of Evaluation

The obtained results are shown in Table 8.

From the results shown in Table 8, it is understood that the sample-104 to -106 of the invention have high sensitivity, high density and a gradation suitable for medical diagnosis, and are excellent in graininess.

TABLE 7

| | | | | | | Total | | Total | | | |
|---|---|---|---|---|---|---|---|---|---|---|---|
| | | | | | | coating | | number | Number of | | |
| | | | | | | amount | | of | developed | | |
| | | Sphere | Total coating | | Total | of silver/ | | silver | silver | | |
| | | equivalent | amount of | Total coating | coating | number | Occupied | halide | grains/ | Reducing agent | |
| | | diameter | silver salt of | amount of | amount of | of silver | volume | grains on | number | | Addition |
| Sam- | Emul- | of silver | fatty acid on | silver halide | silver on | halide | by silver | both sides | of silver | | amount |
| ple | sion | halide | both | on both | both | grains | halide grain | (grains/ | halide | | per one |
| No. | No. | grain(μm) | sides^{*1}(g/m²) | sides^{*2}(g/m²) | sides(g/m²) | (g/grain) | (μm³/grain) | m²) | grains | No. | side(g/m²) |
| 101 | A | 0.04 | 1.35 | 0.292 | 1.642 | 4.9 × 10⁻¹⁶ | 0.006 | 3.3 × 10¹⁵ | 2 | R1-1 | 0.46 |
| 102 | B | 0.08 | 1.35 | 0.292 | 1.642 | 3.9 × 10⁻¹⁵ | 0.048 | 4.2 × 10¹⁴ | 8 | R1-1 | 0.46 |
| 103 | C | 0.16 | 1.35 | 0.292 | 1.642 | 3.1 × 10⁻¹⁴ | 0.38 | 5.2 × 10¹³ | 12 | R1-1 | 0.46 |
| 104 | I | 0.30 | 1.35 | 0.292 | 1.642 | 2.1 × 10⁻¹³ | 2.52 | 7.9 × 10¹² | 25 | R1-1 | 0.46 |
| 105 | E | 0.42 | 1.35 | 0.292 | 1.642 | 5.7 × 10⁻¹³ | 6.92 | 2.9 × 10¹² | 30 | R1-1 | 0.46 |
| 106 | G | 0.71 | 1.35 | 0.292 | 1.642 | 2.8 × 10⁻¹² | 32.5 | 6.0 × 10¹¹ | 45 | R1-1 | 0.46 |
| 107 | A | 0.04 | 1.35 | 0.292 | 1.642 | 4.9 × 10⁻¹⁶ | 0.006 | 3.3 × 10¹⁵ | 0.83 | Comparative | 0.44 |
| | | | | | | | | | | reducing | |
| | | | | | | | | | | agent A | |
| 108 | B | 0.08 | 1.35 | 0.292 | 1.642 | 3.9 × 10⁻¹⁵ | 0.048 | 4.2 × 10¹⁴ | 0.85 | Comparative | 0.44 |
| | | | | | | | | | | reducing | |
| | | | | | | | | | | agent A | |
| 109 | C | 0.16 | 1.35 | 0.292 | 1.642 | 3.1 × 10⁻¹⁴ | 0.38 | 5.2 × 10¹³ | 0.92 | Comparative | 0.44 |
| | | | | | | | | | | reducing | |
| | | | | | | | | | | agent A | |
| 110 | I | 0.30 | 1.35 | 0.292 | 1.642 | 2.1 × 10⁻¹³ | 2.52 | 7.9 × 10¹² | 0.95 | Comparative | 0.44 |
| | | | | | | | | | | reducing | |
| | | | | | | | | | | agent A | |
| 111 | E | 0.42 | 1.35 | 0.292 | 1.642 | 5.7 × 10⁻¹³ | 6.92 | 2.9 × 10¹² | 0.96 | Comparative | 0.44 |
| | | | | | | | | | | reducing | |
| | | | | | | | | | | agent A | |
| 112 | G | 0.71 | 1.35 | 0.292 | 1.642 | 2.8 × 10⁻¹² | 33.5 | 6.0 × 10¹¹ | 0.96 | Comparative | 0.44 |
| | | | | | | | | | | reducing | |
| | | | | | | | | | | agent A | |

^{*1, *2}The amount on the basis of silver content

TABLE 8

| | | Haze degree of film(%) | | | | | | |
|---|---|---|---|---|---|---|---|---|
| | | Before | After | Photographic properties | | | | |
| Sample | Emulsion | thermal | thermal | | | | Average | |
| No. | No. | development | development | Fog | Sensitivity | Dmax | gradient | Graininess |
| 101 | A | 25 | 19 | 0.17 | 0.1 | 4.5 | 6.2 | X |
| 102 | B | 28 | 18 | 0.18 | 0.7 | 4.1 | 5.2 | X |
| 103 | C | 30 | 19 | 0.18 | 5.5 | 3.8 | 4.8 | Δ |
| 104 | I | 34 | 19 | 0.18 | 36 | 3.5 | 3.8 | ◯ |
| 105 | E | 40 | 19 | 0.18 | 100 | 3.2 | 3.2 | ◯ |
| 106 | G | 43 | 19 | 0.19 | 483 | 2.8 | 2.8 | ◯ |
| 107 | A | 26 | 18 | 0.17 | 0.08 | 4.2 | 3.4 | ◯ |
| 108 | B | 29 | 19 | 0.17 | 0.4 | 3.4 | 2.8 | ◯ |
| 109 | C | 30 | 19 | 0.18 | 4.2 | 3 | 1.6 | ◯ |
| 110 | I | 33 | 19 | 0.18 | 10 | 2.3 | 1 | ◯ |
| 111 | E | 41 | 19 | 0.18 | 20 | 0.8 | — | ◯ |
| 112 | G | 43 | 19 | 0.18 | 25 | 0.2 | — | ◯ |

### Example 9

Sample-121 to -130 are prepared in a similar manner to the process in the preparation of the sample-105 in Example 8, except that changing the kind and addition amount of the reducing agent to those shown in Table 9.

Evaluations are done similar to Example 8, and the results of evaluation are shown in Table 9.

From the results, it is understood that the sample-121 to -130 of the invention have high sensitivity, high density and a gradation suitable for medical diagnosis, and are excellent in graininess.

TABLE 9

| | Reducing agent | | | | | | |
|---|---|---|---|---|---|---|---|
| | | Addition | | | | | |
| | | amount | Photographic properties | | | | |
| | | per one | | | | Average | |
| Sample No. | No. | side(g/m²) | Fog | Sensitivity | Dmax | gradient | Graininess |
| 111 | Comparative | 0.44 | 0.18 | 20 | 0.8 | — | ◯ |
| | reducing | | | | | | |
| | agent A | | | | | | |
| 105 | R1-1 | 0.46 | 0.18 | 100 | 3.2 | 3.2 | ◯ |
| 121 | R1-3 | 0.46 | 0.18 | 112 | 3.5 | 3.3 | ◯ |
| 122 | R1-4 | 0.46 | 0.19 | 105 | 3.4 | 3.4 | ◯ |
| 123 | R1-14 | 0.46 | 0.18 | 95 | 3.1 | 3.1 | ◯ |
| 124 | R1-17 | 0.46 | 0.20 | 98 | 3.1 | 3.2 | ◯ |
| 125 | R1-19 | 0.46 | 0.18 | 103 | 3.2 | 3.2 | ◯ |
| 126 | R1-25 | 0.46 | 0.19 | 96 | 3.1 | 3.1 | ◯ |
| 127 | R1-29 | 0.46 | 0.18 | 102 | 3.2 | 3.3 | ◯ |
| 128 | R1-32 | 0.46 | 0.19 | 95 | 3.1 | 3.1 | ◯ |
| 129 | R1-34 | 0.46 | 0.19 | 96 | 3.1 | 3.1 | ◯ |
| 130 | R1-35 | 0.46 | 0.18 | 94 | 3.1 | 3.1 | ◯ |

### Example 10

1. Preparations of Materials

1) Preparations of Silver Bromide Tabular Emulsion J, K, L, and M

Preparations of silver bromide tabular emulsion J, K, L, and M are conducted similar to Example 3.

2) Preparation of Coating Solution for Crossover Cut Layer

Preparation of coating solution for crossover cut layer is conducted in a similar manner to Example 3.

2. Preparations of Samples

Sample-131 to -138 are prepared in a similar manner to Example 8, except that setting the crossover cut layer between the image forming layer and the support and, changing the kind of silver halide emulsion and the kind of reducing agent to those shown in Table 10.

2. Evaluation of Photographic Properties

Evaluations are done similar to Example 8, and the results of evaluation are shown in Table 11.

From the results, the sample-131 to -134 of the invention have high sensitivity, high density and a gradation suitable for medical diagnosis, and are excellent in graininess. But, compared with the photothermographic material of Example 8 using silver iodide, as for the photothermographic material of Example 10 using silver bromide, the haze degree after thermal development remains high.

TABLE 10

| | | | | | | Total | | Total | | | |
|---|---|---|---|---|---|---|---|---|---|---|---|
| | | | | | | coating | | number | Number of | | |
| | | | | | | amount | | of | developed | | |
| | | Sphere | Total coating | | Total | of silver/ | | silver | silver | | |
| | | equivalent | amount of | Total coating | coating | number | Occupied | halide | grains/ | Reducing agent | |
| | | diameter | silver salt of | amount of | amount of | of silver | volume | grains on | number | | Addition |
| Sam- | Emul- | of silver | fatty acid on | silver halide | silver on | halide | by silver | both sides | of silver | | amount |
| ple | sion | halide | both | on both | both | grains | halide grain | (grains/ | halide | | per one |
| No. | No. | grain(μm) | sides^{*1}(g/m²) | sides^{*2}(g/m²) | sides(g/m²) | (g/grain) | (μm³/grain) | m²) | grains | No. | side(g/m²) |
| 131 | J | 0.472 | 1.35 | 0.292 | 1.642 | 1.2 × 10⁻¹² | 14.0 | 1.4 × 10¹² | 21 | R1-1 | 0.46 |
| 132 | K | 0.445 | 1.35 | 0.292 | 1.642 | 9.6 × 10⁻¹³ | 11.7 | 1.7 × 10¹² | 22 | R1-1 | 0.46 |
| 133 | L | 0.409 | 1.35 | 0.292 | 1.642 | 7.5 × 10⁻¹³ | 9.10 | 2.2 × 10¹² | 23 | R1-1 | 0.46 |
| 134 | M | 0.385 | 1.35 | 0.292 | 1.642 | 6.2 × 10⁻¹³ | 7.60 | 2.6 × 10¹² | 20 | R1-1 | 0.46 |
| 135 | J | 0.472 | 1.35 | 0.292 | 1.642 | 1.2 × 10⁻¹³ | 14.0 | 1.4 × 10¹² | 0.95 | Comparative | 0.44 |
| | | | | | | | | | | reducing | |
| | | | | | | | | | | agent A | |
| 136 | K | 0.445 | 1.35 | 0.292 | 1.642 | 9.6 × 10⁻¹³ | 11.7 | 1.7 × 10¹² | 0.94 | Comparative | 0.44 |
| | | | | | | | | | | reducing | |
| | | | | | | | | | | agent A | |
| 137 | L | 0.409 | 1.35 | 0.292 | 1.642 | 7.5 × 10⁻¹³ | 9.10 | 2.2 × 10¹² | 0.96 | Comparative | 0.44 |
| | | | | | | | | | | reducing | |
| | | | | | | | | | | agent A | |
| 138 | M | 0.385 | 1.35 | 0.292 | 1.642 | 6.2 × 10⁻¹³ | 7.60 | 2.6 × 10¹² | 0.95 | Comparative | 0.44 |
| | | | | | | | | | | reducing | |
| | | | | | | | | | | agent A | |

^{*1, *2}The amount on the basis of silver content

TABLE 11

| | | Haze degree of film(%) | | | | | | |
|---|---|---|---|---|---|---|---|---|
| | | Before | After | Photographic properties | | | | |
| Sample | Emulsion | thermal | thermal | | | | Average | |
| No. | No. | development | development | Fog | Sensitivity | Dmax | gradient | Graininess |
| 131 | J | 44.1 | 44.1 | 0.35 | 100 | 3.0 | 3.3 | ◯ |
| 132 | K | 53.1 | 53.1 | 0.37 | 89 | 3.2 | 3.2 | ◯ |
| 133 | L | 58.5 | 58.5 | 0.35 | 74 | 3.1 | 3.3 | ◯ |
| 134 | M | 46.1 | 46.1 | 0.34 | 58 | 3.3 | 3.4 | ◯ |
| 135 | J | 44.1 | 44.1 | 0.31 | 50 | 0.7 | — | ◯ |
| 136 | K | 53.1 | 53.1 | 0.32 | 40 | 0.8 | — | ◯ |
| 137 | L | 58.5 | 58.5 | 0.33 | 35 | 0.8 | — | ◯ |
| 138 | M | 46.1 | 46.1 | 0.32 | 29 | 1.0 | — | ◯ |

### Example 11

1. Preparations of Sample

A single-sided photothermographic material having the image forming layer on one side and disposing the back layer on the opposite surface side of the image forming layer is prepared in a similar manner to Example 8.

The image forming layer is double-coated to give an upper layer and a lower layer, and each layer has the coating amount of silver (total amount of silver halide and silver salt of fatty acid) of 0.8 g/m², respectively. The silver halide emulsion I is used for the upper layer and the silver halide emulsion E is used for the lower layer. An optimal orthochromatic sensitization is performed by using the sensitizing dye-1, -2 and -3.

<Constitution of Back Layer>

The back layer is set similar to Example 4.

2. Evaluation of Photographic Properties

Thus obtained orthochromatic sensitized single-sided coated material is evaluated as follows.

As for fluorescent intensifying screen, the fluorescent intensifying screen UM MAMMO FINE for mammography (using as fluorescent substance, a terbium activated gadolinium oxysulfide fluorescent substance, the emission peak wavelength of 545 nm) produced by Fuji Photo Film Co., Ltd. is used. The photothermographic material and the intensifying screen are loaded in ECMA cassette produced by Fuji Photo Film Co., Ltd. so as the image forming layer of the photothermographic material comes in contact with the surface protective layer of the screen. The X-ray exposure is performed after arranging so that the top plate of cassette, the photothermographic material and the screen may be set, from X-ray tube, in turn.

The commercially available mammography apparatus DRX-B1356EC produced by Toshiba Corp. is used as for X-ray source. The X-ray emitted from the molydenum target tube operated by three-phase electric power at 26 kVp, which penetrated Be of 1 mm, Mo of 0.03 mm and an acrylic filter of 2 cm, is used. By the method of distance, the exposure value of X-ray is changed. The photothermographic material is subjected to exposure for one second with a step wedge tablet having a width of 0.15 in terms of log E.

After exposure, the photothermographic material is subjected to thermal development in a similar manner to Example 8.

On the other hand, UM-MAHC film for mammographic use produced by Fuji Photo Film Co., Ltd. is subjected to X-ray exposure as the same condition as above, and processed for 90 seconds with the automatic photographic processor CEPRO-M2 produced by Fuji Photo Film Co., Ltd. and Developer CE-D1, to obtain an image.

As a result of comparing photographic properties of both images, the similar excellent properties are attained.

### Example 12

A double-sided coated photothermographic material is prepared similar to Example 8, except that changing the support to PEN (poly(ethylene naphthalate)) and that undercoating is performed in a similar manner to Example 5.

Thus obtained double-sided coated photothermographic material is evaluated similar to Example 8.

As a result, an excellent image similar to Example 8 is obtained.

### Example 13

1) Preparation of Sample

A sample is prepared in a similar manner to the process in the preparation of the sample-106 of Example 8, except that disposing a crossover cut layer between the undercoated surface of the support and the image forming layer.

2) Conditions of Exposure and Development

An X-ray exposure is performed similar to Example 8, except that using 2 sheets of fluorescent intensifying screen similar to Example 6.

After exposure, the sample is thermally developed in the condition similar to Example 6.

From the results, it is understood that the sample of the invention has high sensitivity, high density and a gradation suitable for medical diagnosis, and is excellent in graininess, similar to Example 8.

In addition, the exposure value required for a density of an image obtained to be fog+0.5 is measured, similar to Example 6. As a result, the exposure value to give the density of fog+0.5 is 1.3×10⁻⁴ watt·sec·m⁻².

### Example 14

A sample is prepared similar to Example 11, except that: using the silver halide emulsion E for the upper layer and using the emulsion G for the lower layer, and not performing a spectral sensitization by the sensitizing dyes; using the coating solution for the crossover cut layer of Example 13 instead of using the coating solution for the antihalation layer, and feeding the coating solution to the coating station by controlling the flow speed of the coating solution to give the coating amount of solid content of the ultraviolet absorber-1 of 0.04 g/m².

An X-ray exposure is performed similar to Example 11, except that using the screen A of Example 6.

After exposure, the sample is thermally developed similar to Example 8.

From the results, it is understood that the photothermographic material of the invention has high sensitivity, high density, a gradation suitable for medical diagnosis and is excellent in graininess.

1. A photothermographic material comprising, on at least one surface of a support, an image forming layer including at least a photosensitive silver halide, a non-photosensitive organic silver salt, a reducing agent for silver ions and a binder, wherein the photothermographic material has means for nucleation, and an average gradient of a photographic characteristic curve thereof is from 1.8 to 4.3.

2. The photothermographic material according to claim 1, wherein the means for nucleation comprises a nucleator.

3. The photothermographic material according to claim 1, wherein the means for nucleation comprises an infectious developing reducing agent.

4. The photothermographic material according to claim 1, wherein a value obtained by dividing a total coating amount of silver contained in the non-photosensitive organic silver salt and the photosensitive silver halide per unit of area by a number of the photosensitive silver halide grains per unit of area, is 5×10⁻¹⁴ g/grain or more.

5. The photothermographic material according to claim 1, wherein a volume of the image forming layer divided by a number of the photosensitive silver halide grains cantained in the volume is 0.5 μm³/grain or more.

6. The photothermographic material according to claim 1, wherein a number of the photosensitive silver halide grains per unit of area is 4×10¹³ grains/m² or less.

7. The photothermographic material according to claim 1, wherein, after thermal development, a value obtained by dividing a number of developed silver grains per unit of area in a maximum density part by a number of the photosensitive silver halide grains per unit of area is more than 1.0.

8. The photothermographic material according to claim 1, wherein a coating amount of silver is 2.0 g/m² or less, and a maximum density is 2.5 or higher.

9. The photothermographic material according to claim 1, wherein the photosensitive silver halide has a silver chloride content of less than 60% by mole.

10. The photothermographic material according to claim 9, wherein the photosensitive silver halide has a silver iodide content of 40% by mole or higher.

11. The photothermographic material according to claim 10, wherein the photosensitive silver halide has a silver iodide content of 80% by mole or higher.

12. The photothermographic material according to claim 11, wherein the photosensitive silver halide has a silver iodide content of 90% by mole or higher.

13. The photothermographic material according to claim 1, wherein 10% or more of a number of the photosensitive silver halide grains is tabular grains with an aspect ratio of 2 or more.

14. The photothermographic material according to claim 13, wherein 10% or more of the number of the photosensitive silver halide grains is tabular grains having a silver iodide content of 40% by mole or higher.

15. The photothermographic material according to claim 13, wherein tabular grains have an aspect ratio of 5.0 or more.

16. The photothermographic material according to claim 13, wherein a mean sphere equivalent diameter of the tabular grains is from 0.3 μm to 5.0 μm.

17. The photothermographic material according to claim 13, wherein a mean projection area equivalent diameter of the tabular grains is from 0.4 μm to 8.0 μm.

18. The photothermographic material according to claim 17, wherein a mean thickness of the tabular grains is 0.3 μm or less.

19. The photothermographic material according to claim 2, wherein the nucleator is a compound selected from the group consisting of a hydrazine derivative, a vinyl compound, a quaternary onium compound and an olefin compound.

20. The photothermographic material according to claim 19, wherein the hydrazine derivative is represented by the following formula (V): 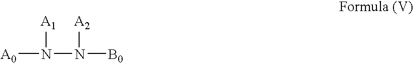
wherein A₀ represents an aliphatic group, an aromatic group, a heterocyclic group or a —G₀—D₀ group, which may each have a substituent; B₀ represents a blocking group; and A₁ and A₂ both represent a hydrogen atom, or one represents a hydrogen atom and the other represents an acyl group, a sulfonyl group, or an oxalyl group; G₀ represents a —CO— group, a —COCO— group, a —CS— group, a —C(═NG₁D₁)— group, a —SO— group, a —SO₂— group or a —P(O) (G₁D₁)— group; G₁ represents a single bond, a —O— group, a —S— group, or a —N(D₁)— group; D₁ represents an aliphatic group, an aromatic group, a heterocyclic group or a hydrogen atom, and in the case where a plurality of D₁s is present in the molecule, they may be the same or different; and D₀ represents a hydrogen atom, an aliphatic group, an aromatic group, a heterocyclic group, an amino group, an alkoxy group, an aryloxy group, an alkylthio group or an arylthio group.

21. The photothermographic material according to claim 19, wherein the vinyl compound is represented by the following formula (VI): 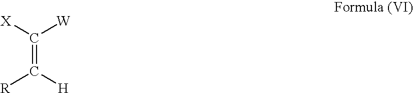
wherein X represents an electron-attracting group, W represents a hydrogen atom or a group that can be substituted to a carbon atom, and R represents a group that can be substituted to a carbon atom.

22. The photothermographic material according to claim 21, wherein in the aforementioned formula (VI), W is a group selected from an alkyl group, an alkenyl group, an alkynyl group, an aryl group, a heterocyclic group, a halogen atom, an acyl group, a thioacyl group, an oxalyl group, an oxyoxalyl group, a thiooxalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfinyl group, a thiosulfinyl group, a sulfinamoyl group, a phosphoryl group, a nitro group, an imino group, an N-carbonylimino group, an N-sulfonylimino group, a dicyanoethylene group, an ammonium group, a sulfonium group, a phosphonium group, a pyrylium group, and an immonium group.

23. The photothermographic material according to claim 21, wherein in the aforementioned formula (VI), R is a group selected from a halogen atom, a hydroxy group, an alkoxy group, an aryloxy group, a heterocyclicoxy group, an alkenyloxy group, an acyloxy group, an alkoxycarbonyloxy group, an aminocarbonyloxy group, a mercapto group, an alkylthio group, an arylthio group, a heterocyclicthio group, an alkenylthio group, an acylthio group, an alkoxycarbonylthio group, an aminocarbonylthio group, organic and inorganic salts of a hydroxy group or a mercapto group, an amino group, an alkylamino group, a cyclic amino group, an acylamino group, an oxycarbonylamino group, a heterocyclic group, an ureido group, and a sulfonamido group.

24. The photothermographic material according to claim 3, wherein the infectious developing reducing agent is a compound represented by the following formula (R1): 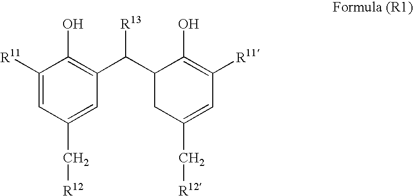
wherein R¹¹ and R¹¹′ each independently represent a secondary or a tertiary alkyl group having 3 to 20 carbon atoms; R¹² and R¹²′ each independently represent a hydrogen atom or a group bonded through a nitrogen atom, an oxygen atom, a phosphorous atom, or a sulfur atom; and R¹³ represents a hydrogen atom, or an alkyl group having 1 to 20 carbon atoms.

25. The photothermographic material according to claim 24, wherein in the aforementioned formula (R1), R¹² and R¹²′ are each independently a hydrogen atom, a hydroxy group, an alkoxy group, a carbonyloxy group, an aryloxy group, an acyloxy group, an alkylthio group, an arylthio group, an amino group, an anilino group, an acylamino group, an ureido group, an urethane group, and a heterocyclic group or a heterocyclicthio group.

26. The photothermographic material according to claim 25, wherein in the aforementioned formula (R1), R¹² and R¹²′ are each independently a hydrogen atom, a hydroxy group, an alkoxy group, an amino group, or an anilino group.

27. The photothermographic material according to claim 26, wherein in the aforementioned formula (R1), R¹² and R¹²′ are each independently a hydrogen atom, a methoxy group, or a benzyloxy group.

28. The photothermographic material according to claim 1, further containing a silver iodide complex forming agent.

29. The photothermographic material according to claim 1, further containing a development accelerator.

30. The photothermographic material according to claim 1, further containing an ultraviolet absorber.

31. The photothermographic material according to claim 1, having the image forming layer on one side of the support.

32. The photothermographic material according to claim 1, having the image forming layers on both sides of the support for an image forming method comprising X-ray exposing the photothermographic material using an X-ray intensifying screen.

33. The photothermographic material according to claim 32, wherein the photothermographic material is exposed with a monochromatic light having the same wavelength as a main emission peak wavelength of the X-ray intensifying screen and having a half band width of 15±5 nm; and, after a thermal developing process, an exposure value required for a density of fog+0.5 for an image obtained by removing the image forming layer that is disposed on the opposite side of an exposure face is 1×10⁻⁶ watt·sec·m⁻² to 1×10⁻³ watt·sec·m⁻².

34. The photothermographic material according to claim 33, wherein the exposure value required for the density of fog+0.5 is 6×10⁻⁶ watt·sec·m⁻² to 6×10⁻⁴ watt·sec·m⁻².

35. An image forming method comprising:
(a) providing an assembly for forming an image by placing the photothermographic material according to claim 1 between a pair of the X-ray intensifying screens,
(b) putting an analyte between the assembly and the X-ray source,
(c) applying an X-ray,
(d) taking the photothermographic material out of the assembly, and
(e) heating the thus taken out photothermographic material in the temperature range of 90° C. to 180° C.

36. The image forming method according to claim 35, wherein the X-ray intensifying screen is a fluorescent intensifying screen including a fluorescent substance, where 50% or more of the emission light of the fluorescent substance is in a wavelength range from 350 nm to 420 nm.
